(19) United States
(12) Patent Application Publication
(10) Pub. No.: US 2008/0266842 A1
(43) Pub. Date: Oct. 30, 2008

(54) Visual Shields With Technology Including Led Ladder, Network Connections and Concertina Effects

(76) Inventors: Marsha Skidmore, Fennville, MI (US); Sheila Kennedy, Boston, MA (US); Robert W. Insalaco, Holland, MI (US); James B. Long, Kentwood, MI (US); W. Daniel Hillis, Encino, CA (US); Russel Howe, Glendale, CA (US)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 11/661,568

(22) PCT Filed: Aug. 31, 2005
(86) PCT No.: PCT/US05/30727

§ 371 Date: Jan. 22, 2008

Related U.S. Application Data
(60) Provisional application No. 60/606,019, filed on Aug. 31, 2004.

(51) Int. Cl. F21S 8/04; H05B 37/02; G05B 11/32; F21V 21/03; G05B 15/02

(52) U.S. Cl. 362/147; 700/83; 315/294; 700/67; 362/388

(57) ABSTRACT

A LED ladder system (650) includes strip units (674) with spaced apart LED elements. Network connection configurations (810, 850, 856, 868) receive AC power and selectively apply DC power to the strip units (674) based on control signals. A concertina visual shield configuration (902) is positioned adjacent the ladder system (650) to affect visual lighting properties.

### CROSS-REFERENCE TO RELATED APPLICATIONS

This application claims priority of U.S. Provisional Patent Application Ser. No. 60/606,019 filed Aug. 31, 2004.

### STATEMENT REGARDING FEDERALLY SPONSORED RESEARCH OR DEVELOPMENT

Not applicable.

### REFERENCE TO A MICROFISHE APPENDIX

Not applicable.

### BACKGROUND OF THE INVENTION

1. Field of the Invention

The invention relates to overhead structures for commercial interiors (i.e., commercial, industrial and office environments) requiring power and, more particularly, to a system of supported shields which permit the use of LED and other lighting elements with selectable materials surrounding the lighting elements in various configurations, and to: a ladder system for conveniently supporting LED or similar lighting elements; a network configuration for control of lighting schemes including color and intensity (as well as network control of other components such as sound, equipment, projection screens and the like); and particular visual shield configurations structured so as to facilitate shipping, installation and use with various applications.

2. Background Art

Building infrastructure continue to evolve in today's commercial, industrial and office environments. For purposes of description in this specification, the term “commercial interiors” shall be used to collectively designate these environments. Such environments may include, but are clearly not limited to, retail facilities, medical and other health care operations, educational, religious and governmental institutions, factories and others. Historically, infrastructure consisted of large rooms with fixed walls and doors. Lighting, heating and cooling (if any) were often centrally controlled. Commercial interiors would often be composed of large, heavy and “stand-alone” equipment and operations, such as in factories (e.g., machinery and assembly lines), offices (desks and files), retail (built-in counters and shelves) and the like. Commercial interiors were frequently constructed with very dedicated purposes in mind. Given the use of stationary walls and heavy equipment, any reconfiguration of a commercial interior was a time-consuming and costly undertaking.

In the latter part of the 20th century, commercial interiors began to change. A major impetus for this change was the need to accommodate the increasing “automation” that was being introduced in the commercial interiors and, with such automation, the need for electrical power to support the same. The automation took many forms, including:

(i) increasingly sophisticated machine tools and powered equipment in factories; (ii) electronic cash registers and security equipment in retail establishments; (iii) electronic monitoring devices in health care institutions; and (iv) copy machines and electric typewriters requiring high voltage power supplies in office environments. In addition, during this period of increased automation, other infrastructure advancements occurred. For example, alternative lighting approaches (e.g., track lighting with dimmer control switches) and improved air ventilation technologies were introduced, thereby placing additional demands on power availability and access.

In recent decades, information technology has become commonplace throughout commercial interiors. Computer and computer-related technologies have become ubiquitous. As an example, computer-numerically-controlled (CNC) production equipment has been applied extensively in factory environments. Point-of-sale electronic registers and scanners are commonplace in retail establishments. Sophisticated computer simulation and examination devices are used throughout medical institutions. Increased sophistication of computers and other electronics associated with the examination devices is particularly increasing rapidly, with regard to the greater use of “noninvasive” procedures. Modular “systems” furniture has evolved to support the computers and related hardware used throughout office environments. The proliferation of computers and information technology has resulted not only in additional demands for power access and availability, but also in a profusion of wires needed to power and connect these devices into communications networks. These factors have added considerably to the complexity of planning and managing commercial interiors.

The foregoing conditions can be characterized as comprising: dedicated interior structures with central control systems; increasing needs for power and ready access for power; and information networks and the need to manage all of the resulting wire and cable. The confluence of these conditions has resulted in commercial interiors being inflexible and difficult and costly to change. Today's world requires businesses and institutions to respond quickly to “fast-changing” commercial interior needs.

Further, known systems typically do not address issues associated with ceiling structures, such as interchangeability, lighting, acoustical properties and the like. With respect to ceiling structures, architects and designers are beginning to look at various types of new designs for purposes of enhancing acoustical properties, lighting efficiency and aesthetics. Numerous types of ceiling structures are known in the prior art which are particularly directed to acoustical properties. One well known ceiling structure is the Armstrong drop ceiling, utilizing opaque ceiling shielding elements modularly supported within a T-bar structure. These ceilings are manufactured by Armstrong World Industries, Inc. Such structures have to accommodate ceiling lighting (if desired), HVAC ducts, fire sprinklers and similar environmental and safety systems. Relatively recently, architects and designers have introduced “open” architecture ceilings that expose structure, even in commercial and office environments. With such exposed ceiling architecture, providing “drop-downs” for HVAC duct work, fire sprinklers, power supplies and the like is not a significant problem. However, open ceiling architecture can present problems with respect to acoustical properties and, for some, may not be aesthetically pleasing.

In addition to the foregoing issues, many known ceiling structures are substantially difficult to reconfigure, once initially assembled and put into place. Accordingly, with this difficulty of reconfiguration, corresponding difficulties arise in the event that modifications are required in lighting, HVAC duct work or sprinkler locations. In addition, reconfiguration of most known ceiling structures may involve substantial expense. Also, as with other elements of known architectural interiors, reconfiguration may require substantial time and involve personnel having technical expertise.

Lighting associated with such structures also has the same problems with respect to potential need for change. Also, when ceiling systems are first designed by the designers, architects and engineers, it may be several years before the building is actually commissioned and tenants occupy the building. At that time, the needs of the tenants may be relatively diverse from the designer's original lighting schema. Further, lighting needs may vary for different functions. However, most known ceiling lighting structures are relatively constant with respect to their light intensity, and the diffusion which may be associated with the lighting. It would be advantageous to have means for varying the light intensity, color, texture and diffusion associated with the lighting.

Other issues also arise with respect to ceiling structures. For example, safety concerns are of primary importance. Fire protection and other building codes may require materials from which ceiling structures are constructed to be treated with fire retardant or fire resistant materials. In addition, the ceiling structure materials themselves may be constructed of fireproof or fire resistant elements.

Other disadvantages exist with respect to current ceiling systems. For example, most known systems do not have the capability of any rapid reconfiguration in “appearance.” It would be advantageous, for example, to modify ceiling appearances for “personal” design, the identity of a particular meeting group or the like. Such changes in appearance could include rearrangement of lighting, modifications in color intensity, texture, translucence and diffusion, and images which may be projected upon or transmitted from ceiling systems. Still further, known ceiling systems do not lend themselves to interchangeability of ceiling system components. In addition, known ceiling systems do not have the capability of modifications in color, configuration and the like based on external environmental characteristics, such as time of day, particular season and other changes. In this regard, for example, health experts have found that lighting has effects on both physical and mental health of individuals.

Still further, many of the architectural interiors in existence today actually result in an “overperformance.” That is, ceilings have weight, bulk and other size parameters which are clearly unnecessary for their desired functionality. Their cost is significant. This cost occurs not only from initial acquisition prices, but also, as a result of their lack of true flexibility, from costs associated with moving or reconfiguring the ceiling systems. Also, in part, additional costs result from the fact that reconfiguration of such ceiling systems often results in waste of component parts. In this same regard, many component parts of known systems are not reusable when disassembled.

Still further, known ceiling systems for many reasons (including those previously stated herein), do not lend themselves to any type of “rapid” reconfiguration. In fact, they may require a significant amount of work to reconfigure. This work often requires use of trained specialists. Also, reconfiguration of known ceiling systems may involve additional physical wiring or substantial rewiring for their lighting. Different trained specialists may be required when the reconfiguration in any manner involves such electrical or data/communications components. Still further, although these ceiling systems may involve lighting controllable by a workspace user, many environmental functions remain centrally controlled, often in locations substantially remote from the architectural interior being controlled.

Even further, however, difficulties can arise in known ceiling systems when environmental characteristic control is provided within a general space of an occupant. For example, lighting associated with an occupant's ceiling may be controlled by a switch which is initially relatively close in proximity and readily accessible. However, if the lighting is moved to different ceiling areas, the switch controlling the lighting may no longer be located in a functionally “correct” position. In this regard, known systems have no capability of providing any relatively rapid reconfiguration of controlling/controlled relationships among functional elements, such as switches, ceiling lights and the like. Also, to the extent these relationships are reconfigured, substantial rewiring by personnel having significant technical expertise will be required.

Another significant disadvantage with known ceiling systems relates to their lack of development in light of advances in technology. However, many of these technological advances have modified today's business, educational and personal work practices. An example of relatively recent technological advances consist of the semiconductor revolution and the corresponding miniaturization of numerous electrical and data/communications components. Today, the work practices of many individuals may involve the need for changing space appearance through LED lighting and digital imagery. However, most of today's ceiling systems do not provide for availability of such features. In addition, known systems do not provide any other features which will facilitate efficiency in today's new work practices, such as digital programming of lighting.

The foregoing is only a brief description of some of the disadvantages associated with current development in architectural interiors and ceiling systems. In part, disadvantages exist because of today's business practices. The following paragraphs briefly describe other aspects of today's activities in the areas of architecture and design, and why the foregoing disadvantages of known ceiling systems are becoming even more important.

In the past, problems associated with difficulty in reconfiguration of architectural interiors, and lack of in situ control of a location's environmental conditions, may not have been of primary concern. However, today's business climate often involves relatively “fast changing” architectural interior needs. Ceiling systems may be structurally designed by designers, architects and engineers, and initially laid out in a desired format with respect to support, lighting fixtures and other functional accessories. However, when these structures, which can be characterized as somewhat “permanent” in most buildings (as described in previous paragraphs herein), are designed, the actual occupants may not move into the building for several years. Designers need to “anticipate” the needs of future occupants of the building being designed. Needless to say, in situations where the building will not be commissioned for several years after the design phase, the ceiling systems of the building may not be appropriately laid out for the actual occupants. That is, the prospective tenants' needs may be substantially different from the designers' anticipated ideas and concepts. However, as previously described herein, most architectural interiors permit little reconfiguration after completion of the initial design. Reconfiguring of ceiling systems in accordance with the needs of a particular tenant can be extremely expensive and time consuming. During structural modifications, the architectural interior is essentially “down.” Accordingly, the space cannot be used during this time. Also, if the space was to be made available to tenants, the space is providing no positive cash flow to the buildings' owners.

It would be advantageous to always have the occupants' activities and needs “drive” the structure and function of the architectural interior layout. To date, however, many relatively “stationary” (in function and structure) interiors essentially operate in reverse. That is, it is not uncommon for prospective tenants to evaluate a building's architectural interiors and determine how to “fit” their needs (workspaces, conference rooms, lighting, heating, ventilation and air conditioning (“HVAC”) requirements and the like) into the existing architectural interiors.

Still further, and again in today's business climate, a prospective occupant may have had an opportunity to be involved in the design of a building's architectural interior, so that the interior is advantageously “set up” for the occupant. However, many business organizations today experience relatively rapid changes in growth, both positively and negatively. When these changes occur, again it may be difficult to appropriately modify the architectural interior so as to permit the occupant to expand beyond its original architectural interior or, alternatively, be reduced in size such that unused space can be occupied by another tenant.

The foregoing paragraphs describe ceiling system reconfiguration as a result of delay time between original design and the time when users actually occupy space, as well as situations where reconfiguration is required as a result of a business organization's growth or other “external” conditions requiring reconfiguration. In addition, it would also be advantageous to reconfigure ceiling systems substantially on a “real time” basis, where the needs of the occupants change almost instantaneously. That is, the time period required for reconfiguration need not be of any substantial length of otherwise involve changes in a business climate for a particular occupant.

As an example, it may be advantageous for the occupant of a particular architectural interior to have a specific ceiling system layout during morning and evening hours, while having a revised layout during mid-day hours. This could occur, for example, in an educational learning center, where usage of the architectural interior by students may change from primarily “individual” usage in the morning and evening hours, to joint projects and meeting activities requiring collaborative usage during mid-day hours. For such usage, it may be particularly advantageous to have the capability of rapidly modifying ceiling system colors, lighting characteristics and the like.

Other problems also exist with respect to the layout and organization of today's architectural interiors. For example, and as earlier described herein, accessories such as switches and lights may be relatively “set” with regard to locations and particular controlling relationships between such switches and lights. That is, one or more particular switches may control one or more particular lights. To modify these control relationships in most architectural interiors requires significant efforts. In this regard, a ceiling system can be characterized as being “delivered” to original occupants in a particular “initial state.” This initial state is defined by not only the physical locations of functional accessories, but also the control relationships among switches, lights and the like. It would be advantageous to provide means for essentially “changing” the relationships in a relatively rapid manner, without requiring physical rewiring or similar activities. In addition, it would also be advantageous to have the capability of modifying physical locations of various functional accessories, without requiring additional electrical wiring, substantial assembly or disassembly of component parts, or the like. Still further, it would be advantageous if users of a particular area could effect control relationships among functional accessories and other utilitarian elements at the location of the ceiling system itself.

In regard to the aforedescribed issues, a number of systems have been developed which are directed to one or more of these issues. For example, Jones et al., U.S. Pat. No. 3,996,458, issued Dec. 7, 1976, is primarily directed to an illuminated ceiling structure and associated components, with the components being adapted to varying requirements of structure and appearance. Jones et al. disclose the concept that the use of inverted T-bar grids for supporting pluralities of pre-formed integral shielding elements in well known. Jones et al. further disclose the use of T-bar runners having a vertical orientation, with T-bar cross members. The runners and cross members are supported by hangers, in a manner so as to provide an open space or plenum thereabove in which lighting fixtures may be provided. An acrylic horizontal sheet is opaque and light transmitting areas are provided within cells, adding a cube-like configuration. Edges of the acrylic sheet are carried by the horizontal portions of the T-bar runners and cross runners.

Balinski, U.S. Pat. No. 4,034,531, issued Jul. 12, 1977 is directed to a suspended ceiling system having a particular support arrangement. The support arrangement is disclosed as overcoming a deficiency in prior art systems, whereby exposure to heat causes T-runners to expand and deform, with ceiling tiles thus falling from the T-runners as a result of the deformation.

The Balinski ceiling system employs support wires attached to its supporting structure. The support wires hold inverted T-runners, which may employ enlarged upper portions for stiffening the runners. An exposed flange provides a decorative surface underneath the T-runners. A particular flange disclosed by Balinski includes a longitudinally extending groove on the underneath portion, so as to create a shadow effect. Ceiling tiles are supported on the inverted T-runners and may include a cut up portion, so as to enable the bottom surface to be flush with the bottom surface of the exposed flange. The inverted T-runners are connected to one another through the use of flanges. The flanges provide for one end of one inverted T-runner to engage a slot in a second T-runner. The inverted T-runners are connected to the decorative flanges through the use of slots within the tops of the decorative flanges, with the slots having a generally triangular cross-section and with the inverted T-runners having their bottom cross members comprising opposing ends formed over the exposed flange. In this matter, the inverted T-runners engage the tops of the exposed flanges in a supporting configuration.

Balinski also shows each decorative exposed flange as being hollow and comprising a U-shaped member, with opposing ends bent outwardly and upwardly, and then inwardly and outwardly of the extreme end portions. In this matter, engagement is provided by the ends of the inverted T-runner cross members. A particular feature of the Balinski arrangement is that when the system is subjected to extreme heat, and the decorative trim drops away due to the heat, the inverted T-configuration separates and helps to hold the ceiling tiles in place. In general, Balinski discloses inverted T-runners supporting ceiling structures.

Balinski et al., U.S. Pat. No. 4,063,391, issued Dec. 20, 1977, shows the use of support runners for suspended grid systems. Each support runner includes a spline member. An inverted T-runner is engaged to the spline, in a manner so that when the ceiling system is exposed to heat, the inverted T-runner continues to hold the ceiling shielding elements even, although the spline loses structural integrity and may disengage from the trim.

Csenky, U.S. Pat. No. 4,074,092, issued Feb. 14, 1978, discloses a power track system for carrying light fixtures and a light source. The system includes a U-shaped supporting rail, with limbs of the same being inwardly bent. An insulating lining fits into the rail, and includes at least one current conductor. A grounding member is connected to the ends of the rail limbs, and a second current conductor is mounted on an externally inaccessible portion of the lining that faces inwardly of the rail.

Botty, U.S. Pat. No. 4,533,190, issued Aug. 6, 1985, describes an electrical power track system having an elongated track with a series of longitudinal slots opening outwardly. The slots provide access to a series of offset electrical conductors or bus bars. The slots are shaped in a manner so as to prevent straight-in access to the conductors carried by the track.

Greenberg, U.S. Pat. No. 4,475,226, issued Oct. 2, 1984, describes a sound and light track system, with each of the sound or light fixtures being independently mounted for movement on the track. A bus bar assembly includes power bus bar conductors.

### SUMMARY OF THE INVENTION

In accordance with the invention, a lighting system is used within a building infrastructure and in a supporting physical structure. The supporting physical structure forms an overhead frame. The lighting system includes a series of lighting elements and a series of strip units, each of the strip units carrying a set of the lighting elements. Frame connection means are provided for connecting each of the strip units to the overhead frame. Power transmission means are provided which are connected to lighting elements for applying electrical power to the lighting elements. When the lighting elements and the strip units are assembled, light intensity can be varied by modifying the spatial density of the strip units. Still further, light intensity can be varied by modifying the number of individual lighting elements carried by each of the strip units.

When the strip units are connected to the overhead frame through the frame connection means, the strip units form a lighting plane. The strip units are connected to the frame connection means with a spatial density so as to provide light intensity when the lighting elements are activated, and so as to permit passage of fixtures through the lighting plane from above and below the lighting plane. Still further, the lighting system includes control means connected to the power transmission means, and operable by a user so as to selectively control the electrical power applied to the lighting elements. The lighting system can also be characterized as including control means operable by a user so as to modify a series of lighting properties associated with the lighting elements.

The series of lighting elements are allocated into lighting element groups, with each group comprising multiple lighting elements. Individual lighting elements of a given one of the lighting element groups are controlled so as to generate colors and/or hues different from other lighting elements within the given lighting element group. The series of lighting elements include LED lights.

In accordance with further aspects of the invention, the electrical power applied to the lighting elements consists of low voltage power. The electrical power may be in the form of DC power. When the strip units are connected to the overhead frame, the units form a lighting plane. The percentage of total planar area taken up by the strip units within the lighting plane is less than or equal to 70 percent. Still further, the control means connected to the power transmission means can be responsive to one or more of a group of environmental sensing devices, for purposes of selectively applying power to the lighting elements. The group of sensing devices may consist of one or more of the following: device for sensing sunlight intensity; device for sensing motion; devise for sensing temperature; device for sensing atmospheric conditions; device for sensing the presence of smoke; and device for sensing time of day. Still further, the control means can be responsive to the environmental sensing device group so as to enable certain of the lighting elements only within selected spatial areas of the lighting system. Still further, the environmental sensing device group can include one or more motion sensing devices. The control means can include means for selectively applying the electrical power in a manner so as to form predetermined spatial lighting configurations within the lighting elements, and so as to provide for directions functions. The lighting elements can include elements of differing colors. When the control means is controlling the spatial lighting configurations for purposes of wayfinding, or “space identifications,” functions, the wayfinding functions can utilize enablement of the lighting configurations with differing color configurations. The control means can also include means for selectively applying the electrical power in a manner so as to sequentially enable the lighting elements, with the spatial lighting configurations forming patterns visually indicating one or more safe exit paths in emergency situations.

The lighting elements can include elements responsive to the electrical power, so that the elements generate light of differing colors. The lighting elements can be responsive to changes in applications of the electrical power by correspondingly changing, in degrees, one or more of the following powered properties: translucence; light intensity; texture; and diffusion.

The lighting elements and the strip units form an overhead lighting plane. The lighting elements can include elements which generate variations in light intensity in response to variations in the applied electrical power. These lighting elements generate differing colors. When the lighting elements in the strip units are assembled as the lighting plane, the lighting elements and the strip units are of a sufficient spatial density so that the changes in lighting properties provide a place making function. Further, the tone of a spatial interior formed under the lighting plane can be varied through variations in the lighting colors and the light intensities.

The lighting system can include means for supporting the lighting elements in the strip units in a manner so as to vary the spatial density of the lighting elements and the strip units within the overhead lighting plane. The spatial density is configured so that the strip units include a spatial area of the overhead lighting plane which is a relatively small percentage of the entirety of the spatial area of the overhead lighting plane. The lighting elements in the strip units are spaced so as to further provide for a relatively continuous ceiling plane of light, while reducing shadow effects.

Still further, the system includes means for applying electrical power so as to generate variations in lighting properties across the overhead lighting plane. The variations in the lighting properties can include means for generating image projections through the use of the lighting elements. Still further, the system can include means for generating visual configurations of the lighting elements which vary with respect to color pixilation intensity.

In accordance with another aspect of the invention, the system can include network connection means connected to the power transmission means. This connection provides for controlling the application of electrical power to the lighting elements. The network connection means can include means for lighting control of a set of the strip units as an entire group. Also, the network connection means can include means for lighting control of sets of lighting elements on the basis of selective control of individual strip units. Still further, the network connection means can include means for selective lighting control of individual ones of the lighting elements.

Still further, the lighting system includes user control means connected to the network connection means. This connection provides a user with selective control of the application of the electrical power to the lighting elements. The user control means is located at any of a number of desired locations, with the locations being nearby or otherwise adjacent to the lighting system. Still further, the network connection means can include means for reconfiguration of controlled and controlling relationships between the user control means and the lighting elements, in the absence of any physical rewiring or other structural modifications of the lighting system.

In accordance with further aspects of the invention, the lighting system can include at least one light panel, with the light panel adapted to be supported by the overhead frame. The light panel includes a series of spaced apart lights positioned at various locations on the light panel. The light panel can be interconnected at opposing ends to a pair of spaced apart support rails. The support rails can form part of the overhead frame. Further, each of the support rails can be interconnected at its opposing ends to a pair of structural channel rails.

Still further, each of the lighting elements can include an LED. The light panel can comprise a light ladder panel having a series of spaced apart LED strip units. Each of the strip units can include a series of the lights positioned on an elongated length of each of the strip units. The light panel can include at least one LED ladder panel, with the LED ladder panel having a series of spaced apart LED strip units. Each of the LED strip units can include a series of lights, and each of the lights can include a LED light positioned on an elongated length of one of the strip units.

Each of the LED strip units can be interconnected at opposing ends to a pair of the spaced apart support rails. The support rails can form a part of the overhead frame. The lighting system can include a series of LED strip connectors, for connecting each of the LED strip units to the pair of support rails. Each of the support rails can be interconnected at each of its opposing ends to one of a pair of structural channel rails through a series of support rail mounting brackets.

With the overhead frame including a series of spaced apart structural channel rails, the channel rails can be adapted to carry power and communication signals for purposes of applying power to the lights. Also, the signals are carried for purposes of providing the capability of programming and controlling of the light elements. The system can further include conductive means for transmitting appropriate levels of DC power to the LED lights associated with individual ones of the strip units. The conductive means can include at least one bonded wire ribbon conductively connected to the strip units through the LED strip connectors.

The system also includes means for a user to vary the density of the light by varying the number of strip units associated with the LED ladder panel, and also varying lateral distances between adjacent ones of the strip units. The system can include frame connection means for connecting each of the strip units to the overhead frame. When the lighting elements in the strip units are assembled, light intensity can be varied by modifying the number of individual lighting elements carried by each of the strip units. The strip units can be connected to the frame connection means with a spatial density so as to provide light intensity when the lighting elements are activated, and so as to also permit passage of fixtures through the lighting plane from above and below the lighting plane.

Still further, the lighting system can include a series of lighting elements and a series of elongated mounting units, with each of the mounting units carrying a set of the lighting elements. Frame connection means are provided for connecting each of the mounting units to the overhead frame. Control means are connected to the power transmission means and are operable by a user so as to selectively control the electrical power applied to the lighting elements. The control means can also be connected to the power transmission means and operable by a user so as to selectively control and modify a series of lighting properties associated with the lighting elements.

The lighting system can include at least one electronics unit connected to the power transmission means, with the unit having means responsive to communication signals for selectively controlling the application of electrical power to the lighting elements. The unit can include processing means responsive to the communication signals for controlling application of electrical power to the elements. Means can also be provided for controlling when the electrical power is applied to the lighting elements, and amplitudes of the applied electrical power. The electronics unit can also include transformer means for converting an incoming portion of the electrical power to low voltage power, prior to being applied to the lighting elements. The electronics unit can include means for varying amplitudes of the low voltage power so as to provide a dimmer function for the lighting elements.

The system can include a series of the electronics units, and the lighting elements can be assembled so as to form a series of ladder panels. Each of the electronics units can operate so as to control application of power to lighting elements associated with corresponding ones of the ladder panels. At least one of the electronics unit includes an incoming power conduit for receiving incoming AC power, with the power being applied to an incoming side of a transformer located within the electronics unit. The transformer converts the incoming AC power to low voltage power. Dimmer circuit means are provided which are responsive to the low voltage power and to control signals so as to modify actual levels of power applied as output power from the electronics unit.

Each of the electronics units can include circuitry responsive to the communication signals, and responsive to DC power generated by the transformer means so as to apply dimmer functions to the DC power as it is applied as output power to the lighting elements. Each of the units can separately receive electrical power from an incoming power conduit. Each of the electronics units can include a number of dimmer control circuits, with the dimmer control circuits corresponding in number to the number of different colors associated with the differently colored LED's of the lighting elements. Each of the lighting elements associated with a given one of the mounting units can be electrically connected with all other ones of the lighting elements mounted on the given mounting unit.

The system can also include a series of connector modules, with each module electrically connected to user control means for controlling application of power to the lighting elements, and for connecting communication signals to the electronics units. The connector modules can also include means for distributing AC power carried along the structural channel rails to the electronics units. The system further includes user control means connected to the lighting elements through the electronics units for providing a user with selective control of enablement and disablement of the lighting elements. The user control means can include a multiple-channel dimmer switch assembly.

Each of the electronics units can be connected to and control an associated one of the ladder panels, with incoming electrical power being directly applied to each unit. Also, each unit can be connected to and control an associated one of the ladder panels, and each unit can receive incoming electrical power from means for distributing electrical power from the connector modules. At least one of the units can receive incoming AC power and include means for distributing the power directly to another of the electronics units. Still further, at least one of the electronics units receiving incoming AC power from at least one electronics unit directly receiving the incoming AC power includes means for further distributing the power to another of the electronics units. Power conduits can be provided to electrically connect at least one set of the electronics units in a daisy chain configuration. The lighting system can also include a series of IR receivers, with each receiver being associated with a given one of the electronics units.

Still further, one of the electronics units receiving communication signals from a connector module can include means for directly transmitting the communication signals to one or more of others of the electronics units. The system can also include other IR receivers, with each receiver being associated with a corresponding one of the mounting units.

In accordance with further aspects of the invention, a network connection system can be provided for distributing power among a series of application devices, and/or selectively controlling enablement and disablement of the devices. The connection system can include communication signals having information relating to control of the devices by the network connection system. Processor means can be responsive to certain of the communication signals for generating application signals. The application signals can include power and/or control signals. Means are provided for applying the application signals as input signals to the application devices. Receiver means are responsive to the programming signals for generating further programming signals and applying the further programming signals to the processor means. The processor means are responsive to the further programming signals so as to determine which of the communication signals comprise certain of the communication signals for generating the communication signals. The system can include user control means capable of manual use for generating the communication signals. The application devices can include one or more of the following: LED lights; sound equipment; motion sensing devices; projection screens; skylights; television monitors and cameras.

In accordance with further aspects of the invention, a visual shield configuration is used within a building infrastructure, and is also used with a physical supporting structure. The configuration includes support means for supporting the configuration from the supporting structure, and a series of segments, with each segment having flexible properties. The segments are arranged and interconnected so as to form a visual shield having a concertina-like configuration. Each of the segments can be constructed of a flexible Mylar® material, polyester film, or other flexible translucent material. The flexible properties of the segments are sufficient so as to permit manual manipulation of the visual shield into various shapes. Also, the segments can be manipulated into a collapsed state. At least a subset of the segments are arranged into segment pairs. Each of the segments within a subset is connected to at least one adjacent segment through at least one segment coupling.

Each of the segments within a subset can also be connected to a first one of the adjacent segments through a pair of segment couplings. Each of the segments of the subset can also be connected to a second one of adjacent segments through three segment couplings. The segments within the subset can be interconnected so that various shapes may be formed by varying the locations where the segment couplings are made between adjacent segments.

The segment couplings can be located so that the configuration forms a double wave configuration. The segments can be formed in a multiple wave configuration, with “x” representative of the number of waves formed within each of the segments of the subset, and each of the segments of the subset being interconnected with a first adjacent segment through “x+1” segment couplings. Each segment of the subset is also interconnected with a second adjacent segment through “x” segment couplings. The segment couplings can be formed through the use of rivets. Also, heat stakes can be used for the segment couplings. Still further, the segment couplings can be formed between adjacent ones of the segments, with the adjacent segments being partially folded outwardly on themselves, so as to form 4-ply segment couplings.

The support means can include means releasably coupling at least a subset of the series of segments to a support rail. The support means can also include means for releasably coupling segment pairs to two of the support rails. The support means can also include a series of end clips for releasably coupling the segment pairs to both support rails. Each of the end clips can be formed by a pair of end tabs, with each of the tabs being formed at an opposing end of each of the segments of the segment pairs. Each of the end tabs can include a substantially resilient and flexible configuration having an aperture positioned therein. Each of the apertures can be sized and configured so as to be received on one of the support rails. Still further, each end tab can be formed so as to be turned perpendicular to a general plane of an associated one of the segments of the segment pairs. The end clips can include means for permanently coupling together the two of the end tabs located on each end of the segments of each segment pair.

The visual shield configuration can be positioned below the plane of a lighting configuration, so as to affect the angle, intensity and color transmission of the light projected from the lighting configuration below the plane of the visual shield. The segments can be formed into a partially expanded state. Each of the segments can include a top edge, pair of sides and a bottom edge. The bottom edges of at least a subset of the segments can be cut in non-straight line configurations, with certain of the subset of the series of segments having a cut configuration differing from a configuration of others of the subset of the plurality of segments. The segments can be arranged so as to form a configuration having substantially open areas from below the visual shield configuration to above the configuration. The segments can be interconnected and be of a sufficiently flexible material so as to be collapsible for purposes of shipment and storage when disconnected from the physical supporting structure.

In accordance with a still further aspect of the invention, a visual shield configuration can include a sheet of flexible material, appropriately cut so as to have a width corresponding to a desired width between supporting elements of a physical supporting structure. The sheet can include a series of lateral rows of a series of cut first shapes, with the rows including a series of the cut first shapes extending horizontally across the cut first sheet. When external forces are applied to a first lateral row of the cut first shapes in a direction opposing the location of an adjacent row, the sheet will form itself into non-planar configurations, where planes of adjacent lateral rows are non-parallel. Still further, the sheet can be cut into a configuration including lateral rows of cut rectangles, with the lateral rows comprising first and second rows, adjacent to each other, and with each of the rows comprising a series of the cut rectangles extending horizontally across the sheet. Each of the rectangles can include a lower edge extending horizontally across the sheet, with a center slot cut within each of the rectangles extending upwardly from a corresponding one of the lower edges, the slot extending upwardly in the range of one quarter to three quarters of a vertical length of an associated one of the rectangles.

Each of the rectangles can include an upper edge and opposing lateral sides, with a side slot extending downwardly from the upper edge on each of the lateral sides of the rectangles. Each length of each side slot is in the range of one quarter to three quarters of a vertical length of the rectangles. The lower edge of the first lateral row and the upper edge of the adjacent second lateral row are formed by cutting a channel between the first and second adjacent rows.

In accordance with further aspects of the invention, the LED strip connectors can each include LED clip bus assemblies having one end mechanically and electrically coupled to a corresponding LED strip unit, and another outwardly extending end of the clip bus assembly terminating in a resilient rail connector. Each strip connector can include a bus channel having an area for electrically connecting one end of a set of buses to a bonded wire ribbon, and with the area further providing for electrically connecting other ends of the buses with a connector block for applying power to LED's associated with a corresponding one of the strip units. A connector bus group having a series of buses is secured within the channel, in an isolated manner. Means are provided for securing the connector buses within the bus channel, and when the buses are positioned in the channel, bus ends are positioned within a ribbon interconnection cavity positioned outwardly from the channel. Ribbon connector forks are formed at the bus ends and turned upwardly, and are staggered within the cavity as a result of individual ones of the buses having differing lengths. When the buses are secured within the channel and the ribbon interconnection cavity, the bonded wire ribbon can be electrically secured to the buses.

### BRIEF DESCRIPTION OF THE SEVERAL VIEWS OF THE DRAWING

The invention will now be described with reference to the drawings, in which:

FIG. 1 is a perspective, diagrammatic illustration of a ceiling system located above a particular spatial area having various functions;

FIG. 2 is a perspective view of a series of shielding elements suspended from a rail system;

FIG. 3 is a perspective view of shielding elements similar to FIG. 2, but with the shielding elements being suspended from cables;

FIG. 4 is a section view of FIG. 2, illustrating certain aspects of the LED lighting and ceiling, with the concept that single or a plurality of LED's may be utilized for possible color changing or the like;

FIG. 5 is a section view of FIG. 2, showing the cable suspensions and further showing aspects of the LED lighting and ceiling;

FIG. 6 is a perspective view of ceiling components and comprising what is characterized as an LED or member having a linear LED lighting module associated therewith;

FIG. 7 is a perspective view similar in scope to FIG. 6, but showing the use of a pair of linear LED lighting modules with the LED member;

FIG. 8 is a perspective view similar in scope to FIGS. 6 and 7, but showing the use of the LED member with three linear LED lighting modules;

FIG. 9 is an underside view of the LED member of FIG. 8;

FIG. 10 illustrates a generally elevational view of a linear LED lighting module, detached from the LED member;

FIG. 11 is a side elevation cross section similar in scope to FIG. 4, but showing the use of a power transformer;

FIG. 11A is a sectional end view of the LED lighting module and connector elements associated therewith, taken along section lines 11A-11A of FIG. 11;

FIG. 12 is a perspective view of a first embodiment of a ceiling configuration in accordance with the invention, showing the combination of the actual shields and the LED lighting modules;

FIG. 13 is a cross sectional view of the first embodiment illustrated in FIG. 12;

FIG. 14 is a perspective view of a second embodiment of a ceiling configuration;

FIG. 15 is a cross sectional view of the ceiling embodiment illustrated in FIG. 14;

FIG. 16 is a perspective view of a third embodiment of a ceiling configuration;

FIG. 17 is a cross sectional view of the ceiling configuration illustrated in FIG. 16;

FIG. 18 is a perspective view of a fourth embodiment of a ceiling configuration;

FIG. 19 is a cross sectional view of the ceiling configuration illustrated in FIG. 18;

FIG. 20 is a perspective view of a fifth embodiment of a ceiling configuration;

FIG. 21 is a cross sectional view of the ceiling configuration illustrated in FIG. 20;

FIG. 22 is a perspective view of a sixth embodiment of a ceiling configuration;

FIG. 23 is a cross sectional view of the ceiling configuration illustrated in FIG. 22;

FIG. 23A is an enlarged portion of the cross sectional view illustrated in FIG. 23;

FIG. 24 is a perspective view of a seventh alternative embodiment of a ceiling configuration;

FIG. 25 is a cross sectional view of the ceiling configuration illustrated in FIG. 24, with marker lights being shown;

FIG. 25A is an enlarged portion of the cross sectional view illustrated in FIG. 24;

FIG. 26 is a perspective view of an eighth alternative embodiment of a ceiling configuration;

FIG. 27 is a cross sectional view of the ceiling configuration illustrated in FIG. 26;

FIG. 27A is an enlarged view of the cross section illustrated in FIG. 27;

FIG. 28 is a perspective view of a ninth alternative embodiment of a ceiling configuration;

FIG. 29 is an underside view of the ceiling configuration illustrated in FIG. 28, and showing details of the fabric;

FIG. 30 is a cross sectional view of the ceiling configuration of FIG. 28, illustrating the support structure for the same;

FIG. 31 is a perspective view of a specific orientation of shielding elements;

FIG. 32 is an perspective view of an alternative embodiment of an orientation of shielding elements which may be utilized in accordance with the invention;

FIG. 33 illustrates the use of one of the embodiments of the ceiling configuration, utilized in combination with a dimmer control switch;

FIG. 33A is an elevation view of an example dimmer control switch;

FIG. 34 is a perspective view of a user exhibiting manual manipulation of a control wand for purposes of controlling the LED lighting modules of a ceiling configuration;

FIG. 35 is a perspective view of a user exhibiting manual manipulation of the control wand, for purposes of controlling functional relationships between a dimmer control switch and a ceiling configuration;

FIG. 36 is a perspective view of a control wand which may be utilized for the purposes illustrated in FIGS. 34 and 35;

FIG. 37 is an elevation view of the control wand illustrated in FIG. 36;

FIG. 38 is an end view of one end of the wand illustrated in FIGS. 36 and 37;

FIG. 39 is a bottom plan view of an LED ladder system in accordance with the invention;

FIG. 40 is a perspective view of a portion of the LED ladder system illustrated in FIG. 39, and further illustrating certain elements relating to attachment of the LED ladder system to main perforated structural channel rails, and still further illustrating, in part, means for suspension of the main perforated structural channel rails to a building structure, and with FIG. 40 illustrating a 3-dimensional perspective view from above the LED ladder system;

FIG. 41 is an enlarged view of a portion of the LED ladder system illustrated in FIGS. 39 and 40, and further showing relatively greater detail with respect to the support rail brackets, used for interconnecting the support rails to the main structural channel rails;

FIG. 42 is a perspective view of a portion of a support rail, and an interconnection of the support rail to an LED strip unit;

FIG. 43A is a sectional, end view of the support rail illustrated in FIG. 42, taken along section lines 43A-43A of FIG. 42;

FIG. 43B is a further sectional, end view of the support rail illustrated in FIG. 42, taken along section lines 43B-43B of FIG. 42;

FIG. 43C is a still further sectional, end view of the support rail illustrated in FIG. 42, taken along section lines 43C-43C of FIG. 42;

FIG. 44A is a perspective and exploded view, illustrating detail associated with the connection of the support rail to a support rail bracket;

FIG. 44B is a side, elevation view of the portion of the support rail and support rail bracket illustrated in FIG. 44A, but showing the same in an assembled state;

FIG. 45A is a partial, top plan view of a portion of an LED strip unit interconnected to a support rail, and showing detail relating to the LED strip connectors, and their attachment to the support rail;

FIG. 45B is an enlarged view of a portion of the illustration of FIG. 45A, showing the flexibility or resiliency of the LED strip connector, for purposes of circuit engagement;

FIG. 46 is a sectional, end view of the interconnection of the LED strip unit to the support rail, as illustrated in FIG. 45A;

FIG. 47 is a perspective and partially exploded view of additional detail relating to the LED strip connector, illustrating wiring associated with the LED strip connector and also illustrating the interconnection of an LED strip connector to a support rail and to an LED strip unit;

FIG. 48 is a sectional, side view of the interconnection between an LED strip connector and a modular LED strip, taken along section lines 48-48 of FIG. 45A;

FIG. 49 is a perspective, three-dimensional and partially diagrammatic view of a network configuration with an LED ladder system in accordance with the invention, and showing means for supplying power and communication signals for the LED ladder system, with a switch configuration for modification of light color and intensity with respect to the LED ladder panels, and further shows the concept of the utilization of one IR receiver for each LED ladder panel, and the concept of utilizing building power applied as input power for separate ones of the ladder electronics units;

FIG. 49A is a perspective, three-dimensional and partially diagrammatic view similar to that of FIG. 49, but showing AC input power as being received through receptacle connector modules electrically and mechanically connected to main perforated structural channel rails;

FIG. 49B is a perspective, three-dimensional and partially diagrammatic view similar to FIG. 49A, but showing incoming building power as being received within only one ladder electronics unit within a section of three LED ladder panels, and with this power being applied to ladder electronics units associated with other LED ladder panels, utilizing a “daisy chain” configuration, and further showing communications being applied from a single connector module associated with a main structural channel rail to only a single one of the lateral electronics units, and further with a daisy chaining of communications between the one lateral electronics unit and a series of additional lateral electronics units associated with additional LED ladder panels;

FIG. 49C is a perspective, three-dimensional and partially diagrammatic view similar to FIG. 49, but showing communications, for a set of adjacent LED ladder panels, being applied from a single connector module associated with a main perforated structural channel rail being applied to only a single one of the ladder electronics units, and further with a daisy chaining of communications between the one ladder electronics unit and a series of additional ladder electronics units associated with additional LED ladder panels;

FIG. 50 is a perspective, three-dimensional and partially diagrammatic view similar to FIG. 49, but showing the use of separate IR receivers for each of the LED strip units;

FIG. 51A illustrates a sectional view of a support rail, and illustrating a clip attachment for attaching an IR receiver adjacent an LED strip unit;

FIG. 51B is a perspective view, with a support rail being shown in a partial format, and illustrating the attachment of both an IR receiver and an LED strip connector to the support rail;

FIG. 52 is a plan view of a series of LED strip units associated with an LED ladder panel, and further showing the relative position of a DC conductor cable for supplying power to the individual strip units, and also showing the opposing ends of the LED strip units being in a “free” configuration;

FIG. 53 is a plan view similar to FIG. 52, but further showing a spacer wire attached to the LED strip connectors on one end of each of a set of the LED strip units;

FIG. 54 is a bottom plan view of a visual shield in accordance with the invention, as attached to a pair of opposing support rails, with the particular visual shield referred to herein as a “concertina” visual shield;

FIG. 55A is a bottom perspective view of the concertina visual shield illustrated in FIG. 54;

FIG. 55B is a perspective view similar to FIG. 55A, but showing the concertina visual shield in an exploded view, relative to LED ladder panels;

FIG. 56 is a perspective and “stand-alone” view of the concertina visual shield illustrated in FIG. 55A;

FIG. 57A is a partial side, elevation view of the concertina visual shield illustrated in FIG. 56, taken along lines 57-57 of FIG. 56, and showing the interconnection of visual shield segments through the use of short rivets;

FIG. 57B is a partial side, elevation view similar to FIG. 57A, taken along lines 57-57 of FIG. 56, and illustrating the coupling interconnection between visual shield segments through the use of a heat weld or heat stake;

FIG. 57C is a partial side, elevation view similar to FIGS. 57A and 57B, taken along lines 57-57 of FIG. 56, and showing the coupling interconnection between adjacent visual shield segments through the use of a relatively long plastic rivet;

FIG. 58 is a partial, perspective view of one of the support rails, showing the relative position of a pair of visual shield segment pairs when removably coupled to the support rail;

FIG. 59 is a cross-sectional, end view of the support rail shown in FIG. 58, taken along section lines 59-59 of FIG. 58 and showing one of the visual shield segment pairs as installed and removably coupled to the support rail;

FIG. 60 illustrates two particular contours which may be utilized as optional contours for the concertina visual shield;

FIG. 61 is similar to FIG. 60, but shows still further optional contours for usage of the concertina visual shield;

FIG. 62A illustrates the “accordion” effect of the concertina visual shield, and expressly shows the concertina visual shield in a collapsed state, suitable for shipping;

FIG. 62B is similar to FIG. 62A, but shows the concertina visual shield as it is being expanded from its collapsed state as shown in FIG. 62A;

FIG. 62C is similar to FIGS. 62A and 62B, but shows the concertina visual shield in a substantially expanded state;

FIG. 63 is a plan view of an alternative embodiment of a visual shield, showing the visual shield as a sheet having a laser cut configuration;

FIG. 64 illustrates a configuration of a portion of the laser cut visual shield shown in FIG. 63, and showing a configuration when the sheet is positioned in on expanded configuration;

FIG. 65 is a perspective view illustrating a portion of the laser cut concertina visual shield as shown in FIG. 64, and further showing its position when being installed on a support rail;

FIG. 66 is a top plan view of an LED clip assembly in accordance with the invention;

FIG. 67 is a side, elevation view of the clip assembly illustrated in FIG. 66;

FIG. 68 is a perspective and partially exploded view of the clip assembly illustrated in FIG. 66;

FIG. 69 is a cross sectional, end view of the assembly shown in FIG. 66, taken along section lines 69-69 of FIG. 67;

FIG. 70 is a side, elevation view of one embodiment of a connector bus;

FIG. 71 is an enlarged view of one end of the connection bus shown in FIG. 70, as illustrated within circle 71 of FIG. 70, and showing an enlarged view of a ribbon connecting fork;

FIG. 72 is an end view of one embodiment of a bonded wire ribbon which may be utilized in accordance with the invention; and

FIG. 73 is a bottom plan view similar to FIG. 54, but showing a visual shield configuration as supported below a series of fluorescent lighting assemblies.

### DETAILED DESCRIPTION OF THE INVENTION

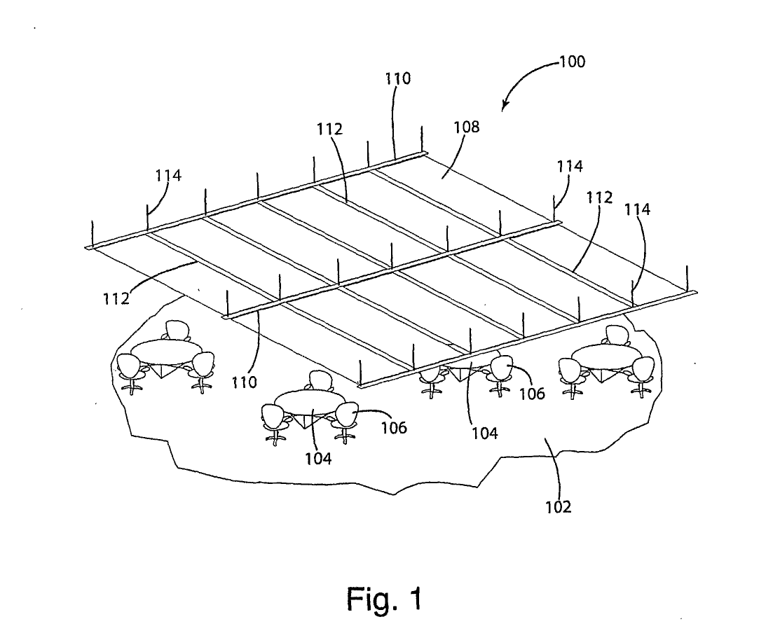

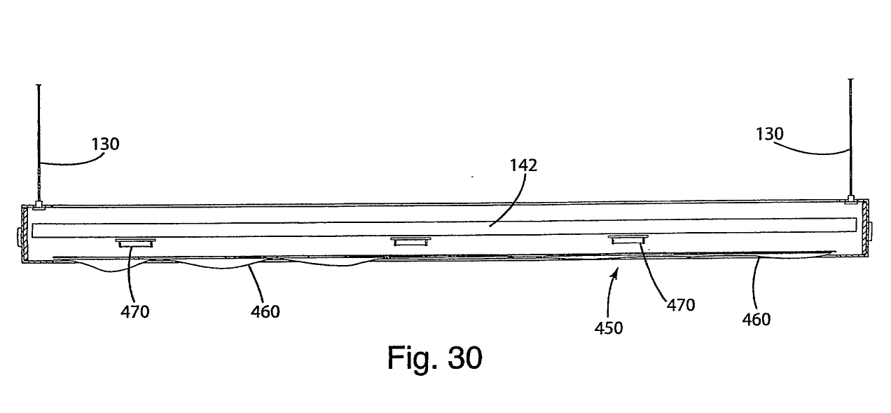

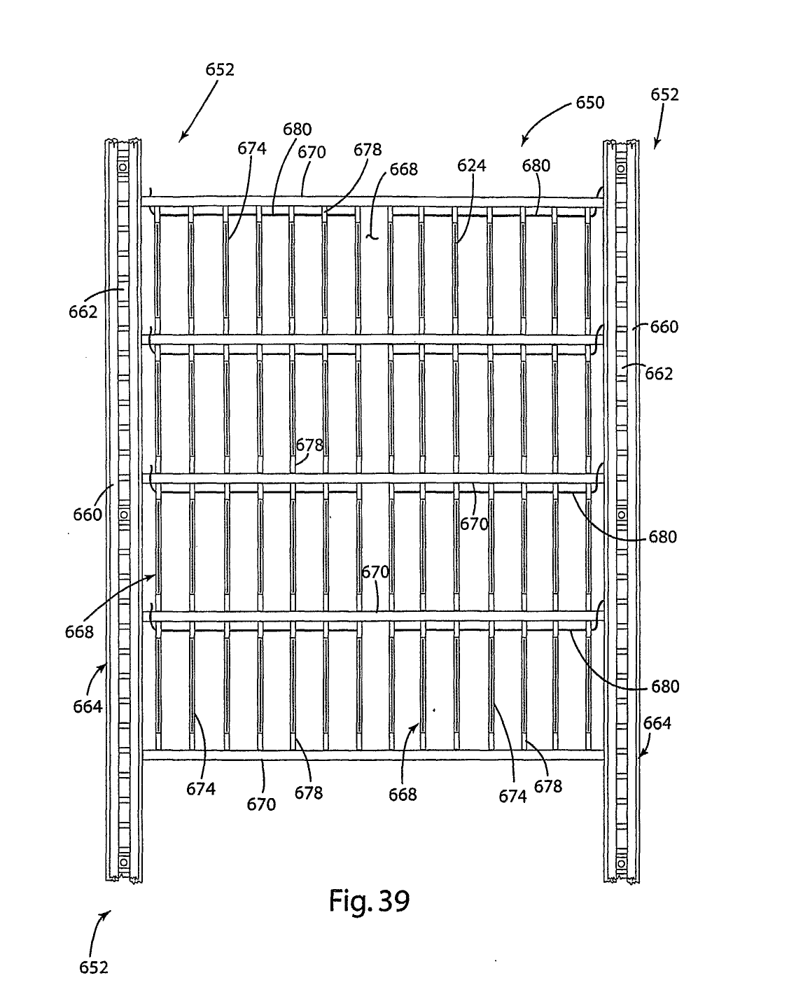

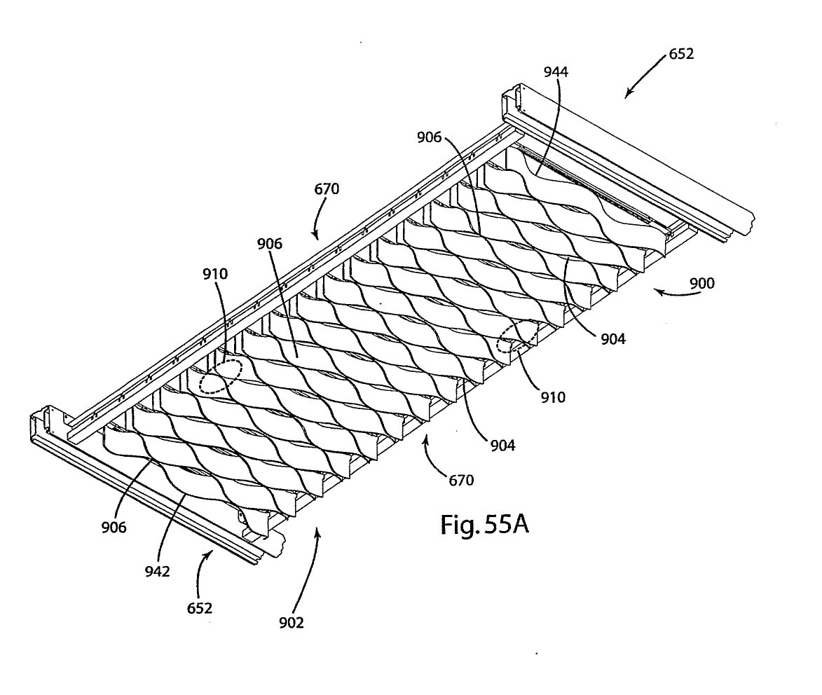

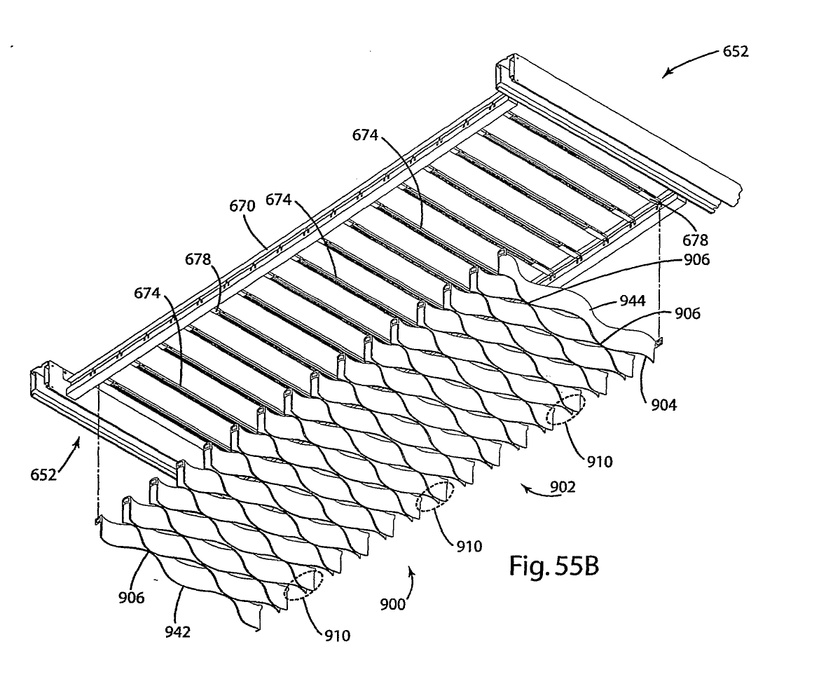

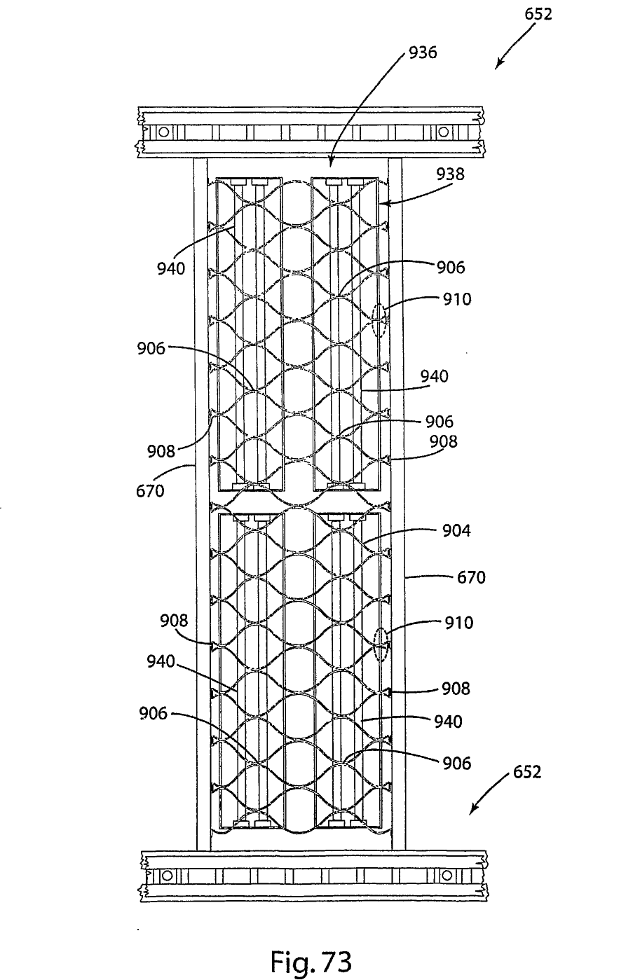

The principles of the invention are disclosed, by way of example, within a ceiling system 100 initially shown in FIG. 1 and illustrated in various embodiments in FIGS. 1-73. In particular, the invention is directed to an LED ladder system 650, network connection configuration 810 and a visual shield configuration 900 having a configuration 902 with concertina effects. These concepts and structures associated with the invention are described herein and primarily illustrated in FIGS. 39-73. Structures in accordance with the invention may be utilized in various overhead configurations and commercial interiors. For purposes of providing a background and an example embodiment where the structures in accordance with the invention may be utilized, a ceiling system 100 is initially shown in FIG. 1 and illustrated in various embodiments in FIGS. 1-38. The ceiling system 100 was previously disclosed in copending International Patent Application No. PCT/US03/27828, titled “Ceiling System with Technology” and filed Sep. 4, 2003. The ceiling system 100 is being disclosed and illustrated herein so as to clearly show an overhead structure within which structures in accordance with the invention may be utilized. The example ceiling system 100 will first be described, and then a description of structures in accordance with the invention will follow, with reference to FIGS. 39-73.

FIG. 1 illustrates a general layout of the ceiling system 100 as it may be utilized above a workplace 102. The ceiling system 100 provides for an open system to physically change a family of products, including the capability of relocation. In addition, digital control and digital programming is also provided for the ceiling system 100. This control is utilized to undertake activities such as to change the ceiling system appearance for purposes such as personal design, identity of a particular group, personalization by color change, digital imaging, and projection of images. As described in subsequent paragraphs herein, the ceiling system 100 may be linked to a digital programming network.

Still further, ceiling system 100 may provide for interchangeable shielding elements and interchangeability of other parts, which what could be characterized as a “mass customization.” Unique visuals can be provided within the system. The system can also be fabricated in a relatively efficient manner, with support being provided by frames for the shielding elements. Because of the configuration, relatively larger shielding elements can be utilized. In this regard, the shielding elements can be constructed, for example, of compressed polyester fiber material.

In the same regard, changes can be made to occur based on external environmental characteristics, such as the color of the sky, light intensity and time of day. Changes in light may also be provided by the ceiling system during different seasons and the like. It is well known that lighting changes can be beneficial for the health and well being of individuals working under certain lighting structures.

Still further, ceiling system 100 may take advantage of advancements in semiconductors and miniaturization of electronic components. That is, ceiling system 100 may provide for a harnessing of solid state technology to architectural activities. These advancements in technologies have resulted in changes in the way we work, and it is advantageous for ceiling systems to take advantage of such new work habits.

As illustrated in FIG. 1, the workplace 102 may include a series of conference tables 104 and chairs 106. However, the ceiling system 100 may be utilized in any of variously configured commercial interiors. As illustrated in FIG. 1, the ceiling system 100 may include a series of shielding elements 108 supported in any convenient manner through the use of frames 110 and cross frames 112. The ceiling system 100 may be suspended from a building roof or similar overhead structure (not shown) through the use of suspension cables 114 or comparable elements.

As described in subsequent paragraphs herein, the ceiling system 100, and its various embodiments, may employ LED (and other) lighting elements, with selectable materials surrounding lighting elements so as to provide varying degrees of translucence. The materials may be constructed and configured so as to accommodate additional utilities (e.g. sprinklers and the like) below a ceiling plane. More specifically, the ceiling system 100 may provide a ceiling plane, with lighting elements and materials that are moveably mountable to the ceiling plane. The materials have varying degrees of translucence so as to adjust intensity and diffusion of light projected from the ceiling plane.

Still further, the ceiling system 100 may employ lighting elements other than LED elements. For example, where LED lighting elements are described in subsequent paragraphs herein, lighting elements such as fluorescent lighting, metal halide lighting and various other types of lighting may be employed. Still further, as referenced herein, the materials of the ceiling system 100 may be constructed so as to accommodate additional utilities below a ceiling plane, with the utilities including sprinklers and the like. In addition to accommodating the utilities below the ceiling plane, the materials of which the ceiling system 100 is constructed may have sufficient openings or porosity so as to permit utilities such as sprinklers and the like to be maintained above a ceiling plane formed by these materials of the ceiling system 100. In this regard, many building codes provide that sprinklers and the like may be accommodated above the ceiling plane, if the plane exhibits total porosity openings of 70% or more.

Permeating throughout the concepts of the ceiling system 100 are the issues associated with what may be characterized as “anticipatory design” or flexibility. That is, at the time that a designer may complete a structural and functional design for a commercial interior (including not only wall structures, but also locations of ceiling shielding elements, electrical fixtures, data nodes, communication outlets and the like), it may be several years before particular tenants occupy the structure. Between the time of the design completion and the time the particular tenants wish to occupy the structure, the prospective tenants' needs may be substantially different from the designers' anticipatory ideas. However, most commercial interior structures permit little reconfiguration of architectural elements and structure, after completion of an initial design. Reconfiguring a structure for the needs of a particular tenant can be extremely expensive and time consuming. During the structural modifications, the commercial interior is essentially “down.” Accordingly, the space cannot be used during this time. Also, if it was intended that the space was to be made available to tenants, the space is providing no positive cash flow to the buildings' owners at this time.

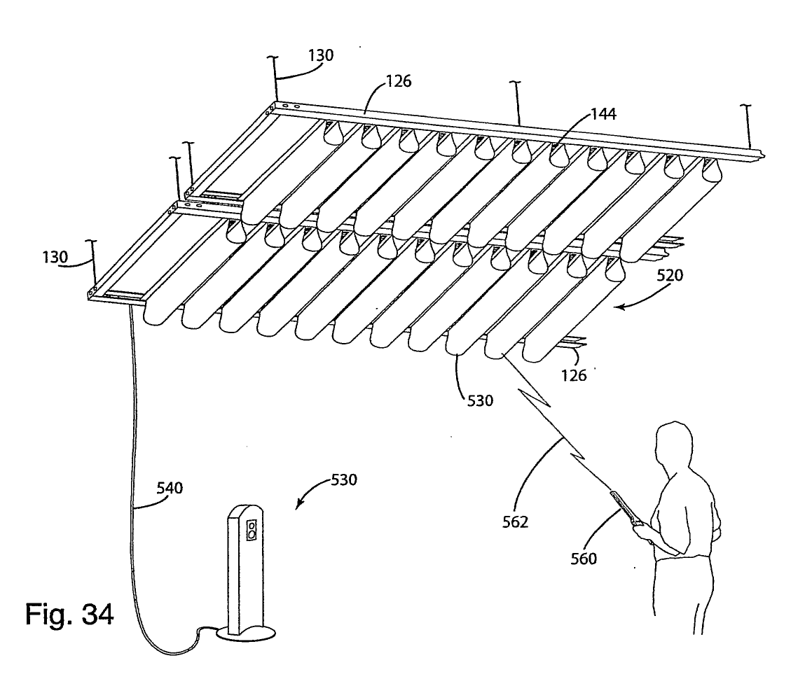

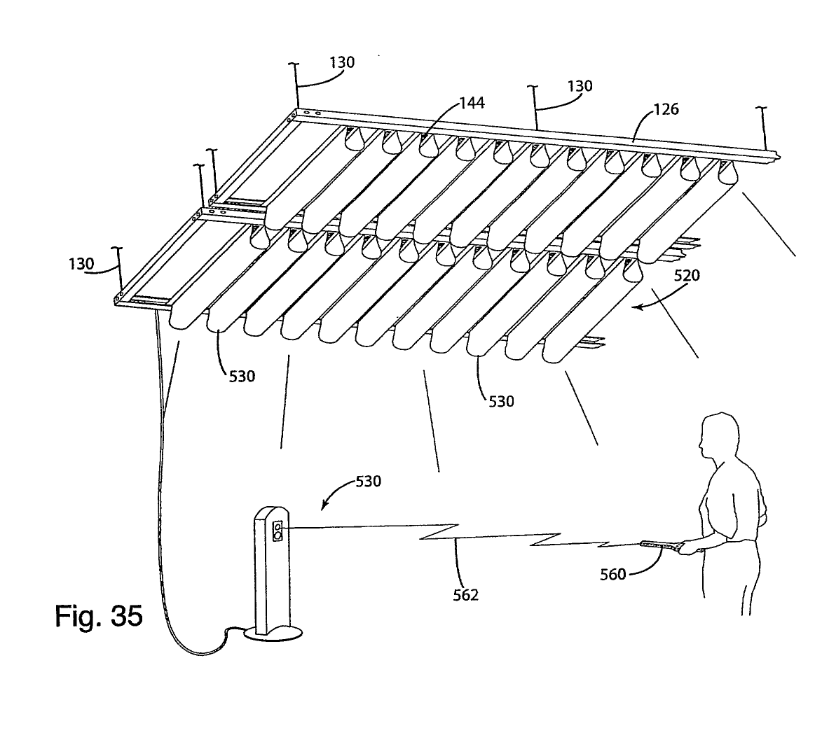

However, with the ceiling system 100, reconfiguration is facilitated, both with respect to expense and time. Essentially, the architectural interior can be reconfigured in “real time.” In this regard, not only can various functional components be quickly relocated from a “physical” sense, but also “functional relationships” among components can be altered. As a relatively simple example, and as described in subsequent paragraphs herein with respect to FIGS. 34 and 35, functional or “control” relationships can be readily modified among various switch and lighting components. With respect to the relationships, alteration can occur with respect to aesthetic appearance. As earlier mentioned, it can be beneficial (from both a physical and mental health view point) to an individual to have certain types of lighting available. These capabilities of changes in appearance aesthetics occur both with respect to the capability of changing shielding planes, and from changing lighting.

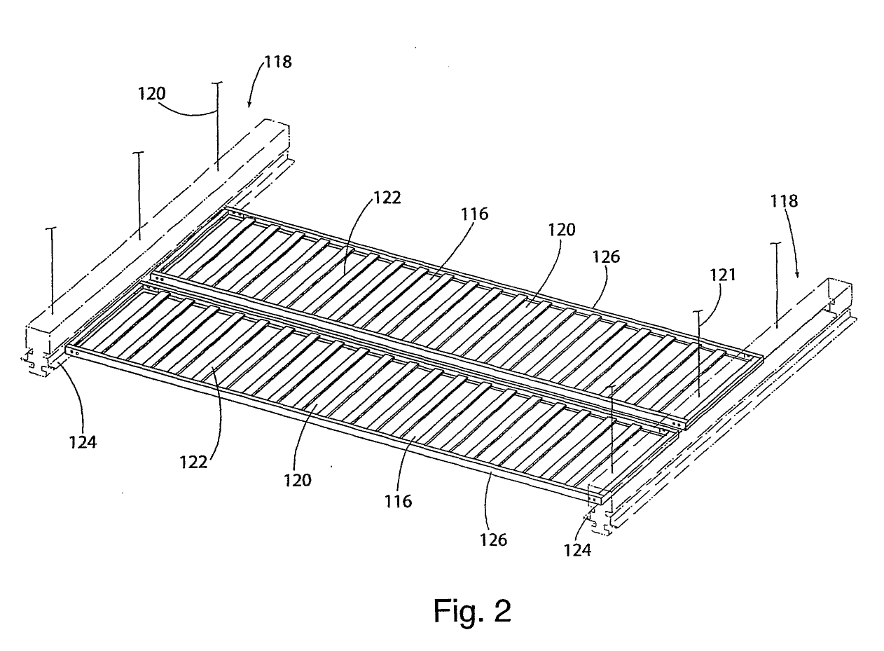

More specifically, and with reference to FIG. 2, a perspective view is shown of a pair of shielding elements 116 which are supported through the use of a rail system which may comprise a pair of parallel and spaced apart rails 118. An exemplary embodiment of a rail system having rails such as rails 118 which may be employed with the shielding elements 116 is described in copending International Patent Application No. PCT/US03/27584, titled “Rail System” and filed on Sep. 4, 2003. The rails 118 themselves may be suspended through the use of suspension cables or support rods 121 to overhead building supports (not shown). As further illustrated in FIG. 2, the shielding elements 116 may include coverings 120, examples of which are described in subsequent paragraphs herein. The coverings 120 may provide various translucence for a series of LED lighting module strips 122 and other types of lighting elements. Such LED lighting module strips 122 will also be described in subsequent paragraphs herein. The shielding elements 116 are supported on the sides of each of the adjacent rails 118 on a pair of opposing L-shaped brackets 124. Preferably, the shielding elements 116 may be releasably secured to the L-shaped brackets 124 through appropriate securing means such as connecting screws and the like.

In addition to the shielding elements 116 having translucent material coverings 120 and LED lighting modules 122, the shielding elements 116 may also comprise other components and characteristics. For example, the shielding elements 116 may comprise air-filled cellular structures. In addition, such shielding elements may comprise 3D fabric. Still further, these shielding elements 116 may comprise rigid fins or, alternatively, heliofon fabric fins. Further, the shielding elements 116 may be supported on their sides through the use of a frame 126 which may, for example, consist of various materials, including extruded aluminum.

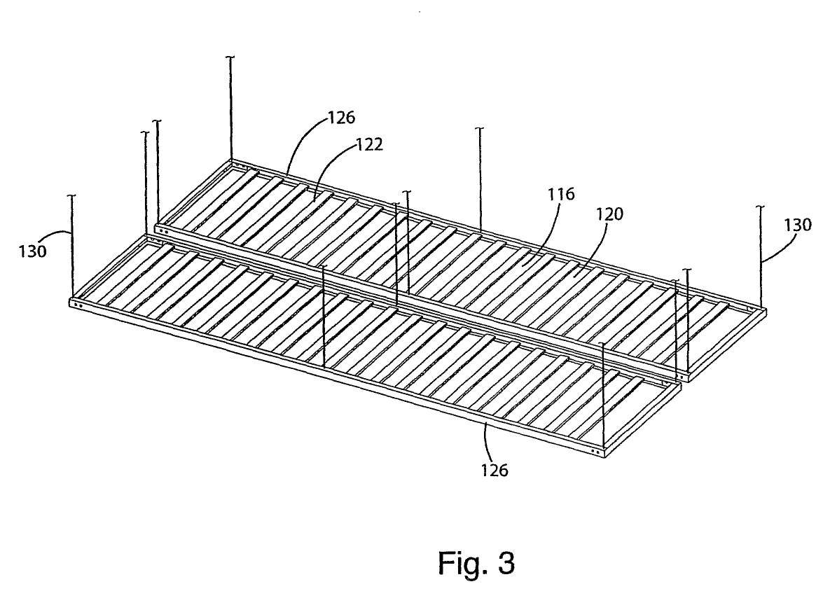

FIG. 3 is similar in scope to FIG. 2, in that it illustrates a pair of shielding elements 116. However, in place of the use of rails 118 and support rods 121, the shielding elements 116 are supported from overhead building supports through the use of suspension cables 130 interconnected directly to the shielding elements 116 rather than through the use of rails 118. Preferably, the suspension cables 130 are adjustable in length. With adjustability of the length of the suspension cables, the supporting infrastructure and/or the shielding elements 116 themselves may be adjustable in distance from overhead building supports. Still further, interconnection between the shielding elements 116 and the rails 118 and support rods 121 may be constructed so that the shielding elements 116 are adjustable in vertical distance relative to the rails 118 and support rods 121.

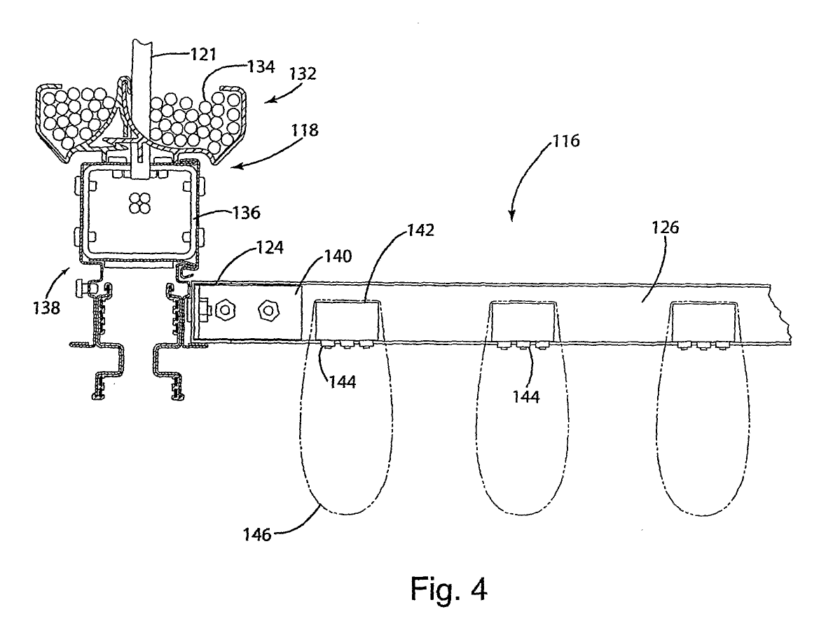

FIG. 4 is a side elevation cross sectional view of the system shown in FIG. 2.

FIG. 4 illustrates the support rod 121 and rail 118. The rail 118 will not be described in great detail herein. In general, the rail 118 may include cable trays 132 carrying communication cables 134 or the like. Support brackets 136 may be interconnected to a main track 138 at spaced apart intervals. The L-shaped brackets 124 may be interconnected to the main track 138 by any number of conventional securing means, such as bolt-nut combinations, connecting screws and the like. As earlier stated, a rail system having rails 118 is described in greater detail in the commonly assigned U.S. Provisional Patent Application Ser. No. 60/408,149, entitled “Rail System” and filed on Sep. 4, 2002.

FIG. 4 also illustrates the cross frames 126, interconnected to other components through the use of brackets 140. FIG. 4 further illustrates the positioning of the members 142 in a spaced apart and parallel configuration along the shielding elements 116. Mounted below the members 142 are LED lighting modules 144, which are mounted in any convenient manner on the underside of the members 142. Surrounding the LED lighting modules 144 are a series of “light bags” 146, which may have various degrees of translucency. It is these light bags 146 and other embodiments as set forth in subsequent paragraphs herein which provide modifications to light intensity and varying degrees of translucency and diffusion with respect to the LED lighting modules.

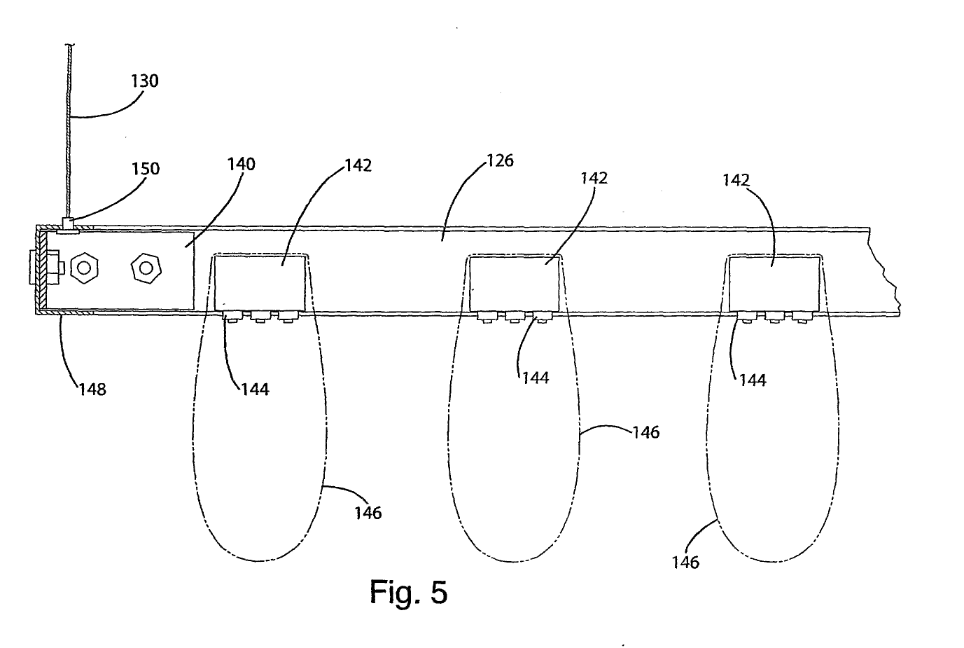

FIG. 5 is a side elevation cross-sectional view of the configuration illustrated in FIG. 3. That is, FIG. 5 illustrates the use of suspension cables 130. The suspension cables 130 depend downwardly and are received within apertures in the cross bracket 140 and in an L-shaped bracket 148. An end cap 150 is utilized to secure the suspension cable 130 to the brackets 140, 148.

FIG. 6 is a perspective view (looking from underneath) of one of the elongated LED members 142 which may be employed with the shielding elements 116. As illustrated in FIG. 6, the member 142 is elongated in length and will laterally extend across a shielding elements 116. Mounted to the lower portion of the LED member 142 is a linear LED lighting module 144. The linear LED lighting module 144 is also elongated in length and secured by any of a number of conventional securing means (such as adhesives, connecting screws or the like) to the underside of the member 142. The linear LED lighting module 144 is positioned so that it extends longitudinally along the length of the member 142. The linear LED lighting module 144 includes a series of LED's 152 spaced apart along the length of the linear LED lighting module 144.

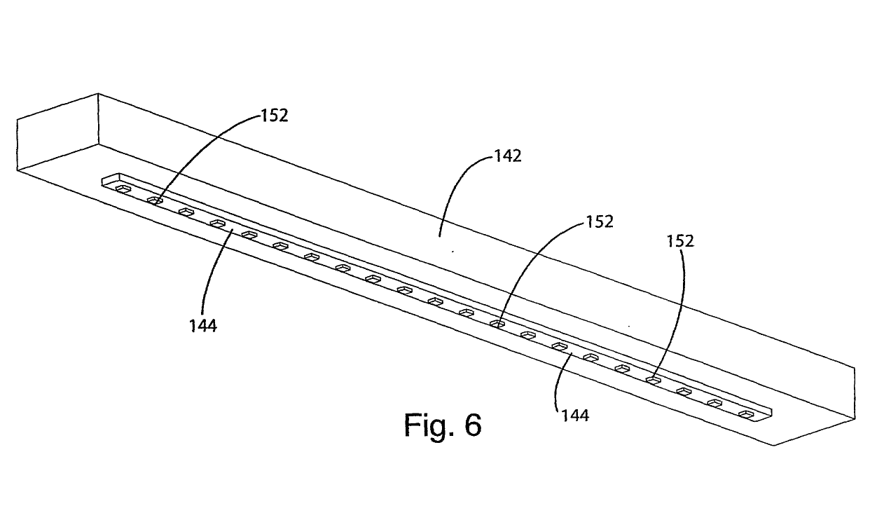

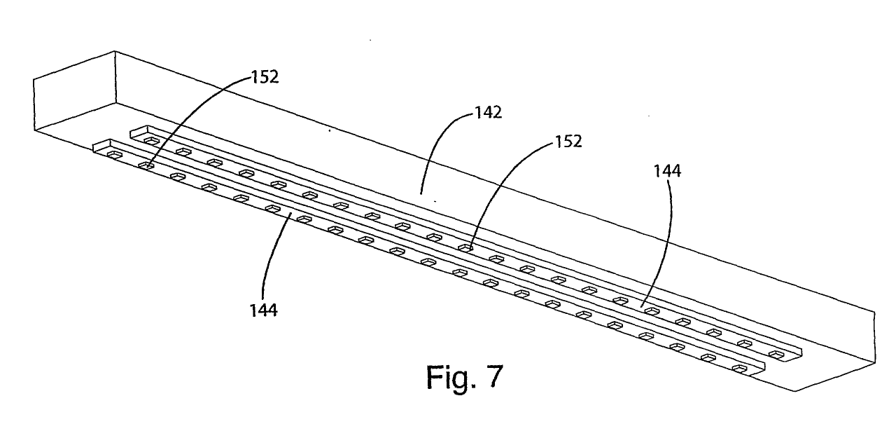

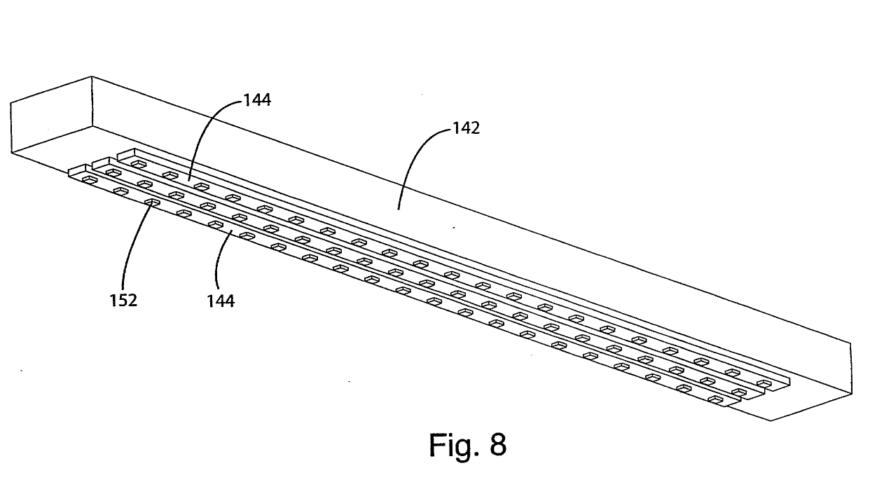

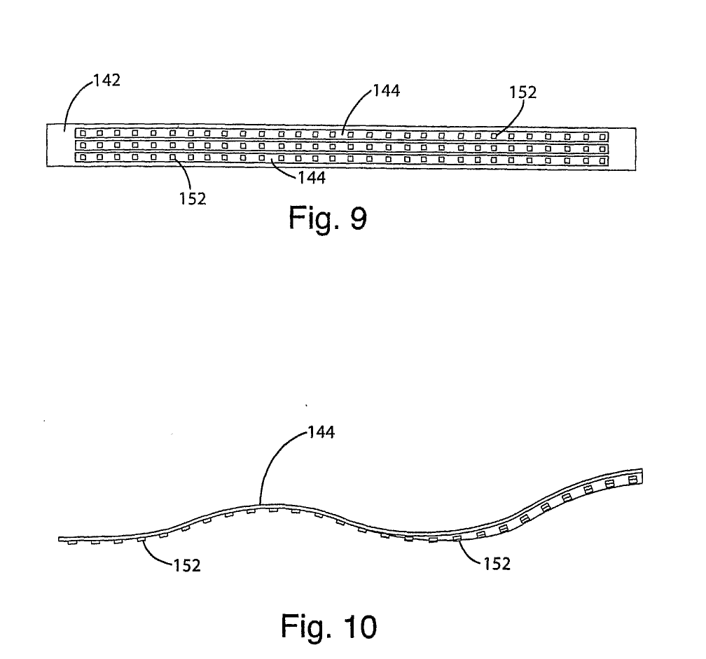

FIG. 7 is an illustration similar to FIG. 6, but illustrates the use of two linear LED lighting modules 144. Correspondingly, FIG. 8 is similar to FIGS. 6 and 7, but illustrates the use of three linear LED lighting modules 144 along the length of the member 142. FIG. 9 is an underside elevation view of the member 142 and three linear LED lighting modules 144 as illustrated in FIG. 8. FIG. 10 is an illustration of a linear LED lighting module 144, separate and apart from any member 142. FIG. 10 illustrates that the linear LED lighting module 144 may be flexible in construction, and may be constructed of any of a number of suitable materials. Also, although not expressly shown in the drawings, low voltage DC power may be applied to the LED's 152 of the LED lighting module through wires or other conductors embedded within the length of the linear LED lighting module 144.

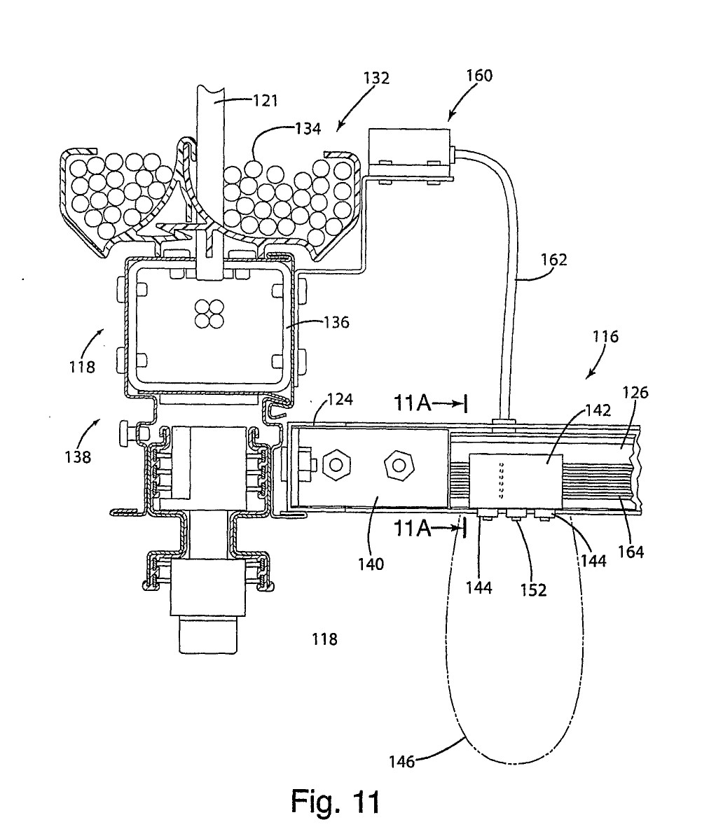

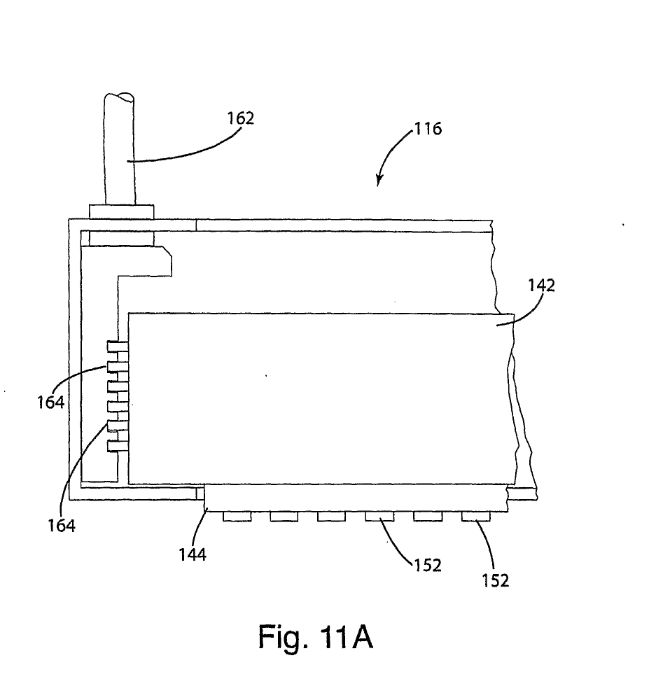

FIG. 11 is substantially similar in scope to FIG. 4. That is, FIG. 11 illustrates a rail 118 having cable trays 132 carrying communication cables 134. FIG. 11 also illustrates the use of the support rod 121, which is interconnected to the main track 138. Support brackets 136 are utilize to interconnect sections of the main track 138.

In addition, FIG. 11, like FIG. 4, illustrates the use of an L-shaped bracket 124 and cross bracket 140 for interconnection of the shielding elements 116 to the rail 118. However, unlike FIG. 4, the configuration illustrated in FIG. 11 also includes a power transformer 160 which may be interconnected to electrical components in any suitable manner which are either associated with the rail 118 or otherwise configured around the rail 118 and shielding elements 116. The power transformer 160 may be utilized to supply low voltage DC power through power cord 162 to the linear LED lighting modules 144. FIG. 11 illustrates the use of bus bars 164 to supply low voltage DC power to the linear LED lighting modules 144 and LED's 152. However, it may be preferable to employ a series of cables and wires (not expressly shown in FIG. 1) for purposes of providing electrical power to each of the linear LED lighting modules. The interconnection between the power cord 162 and the bus bars 164 or appropriate wiring can be made in any conventional manner. Correspondingly, the electrical interconnection between the bus bars 164 or wiring and the LED's 152 of the linear LED lighting modules 144 may also be made in a conventional manner. FIG. 11A illustrates greater detail with regard to the configuration of FIG. 1, and comprises a sectional end view of certain components of FIG. 11, taken along section lines 11A-11A of FIG. 11.

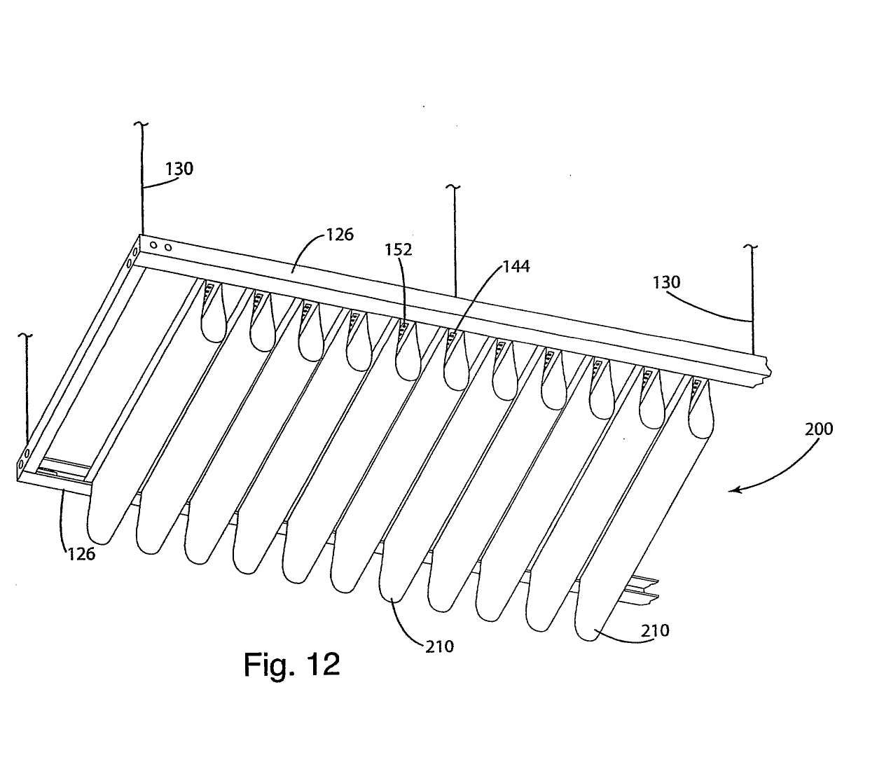

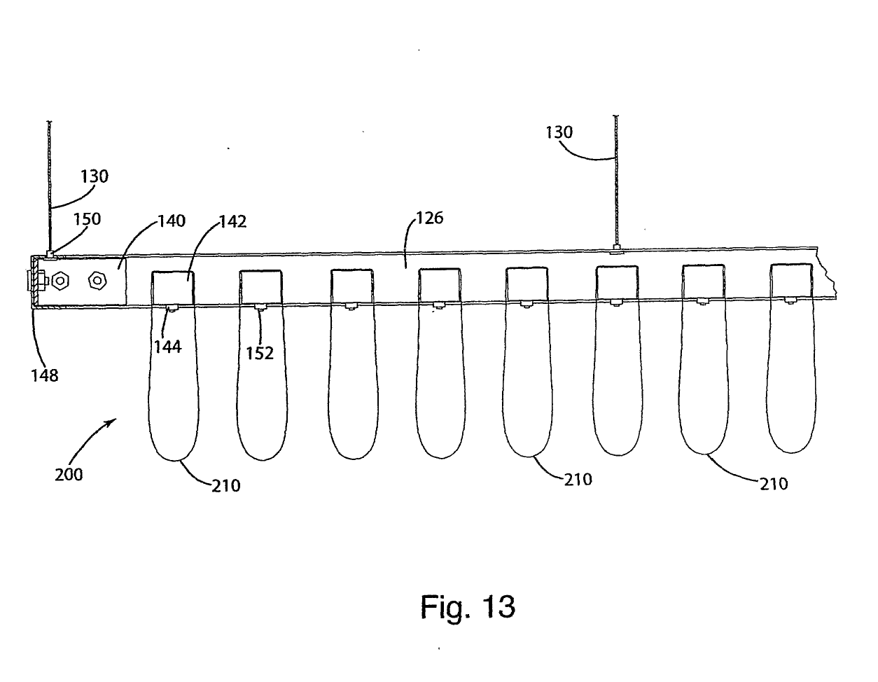

As earlier stated, ceiling systems in accordance with the invention may utilize LED and other lighting elements, along with selectable materials which will surround the lighting elements so as to provide varying degrees of translucence. The selectable materials may be digitally cut for purposes of forming the same. The selectable materials will also be utilized to modify the intensity and the diffusion of light projected from the LED or other lighting elements. FIGS. 12-30 illustrate various configurations in accordance with the invention. Turning to these drawings, FIGS. 12 and 13 illustrate a ceiling configuration 200. The ceiling configuration 200 may be characterized as employing light diffusing fabric fins, with light bags. More specifically, the configuration 200 includes a series of members 142, each having a linear LED lighting module 144 secured to the underside thereof. Each of the linear LED lighting modules 144 includes a series of spaced apart LED lights 152. Suspended in any appropriate manner from the members 142 are a series of light bags 210. The light bags 210 serve to provide light diffusion and a particular level of translucence. In accordance with one aspect of the invention, the light bags 210 may comprise light diffusion heliofon fabric. Such fabric is commercially available.

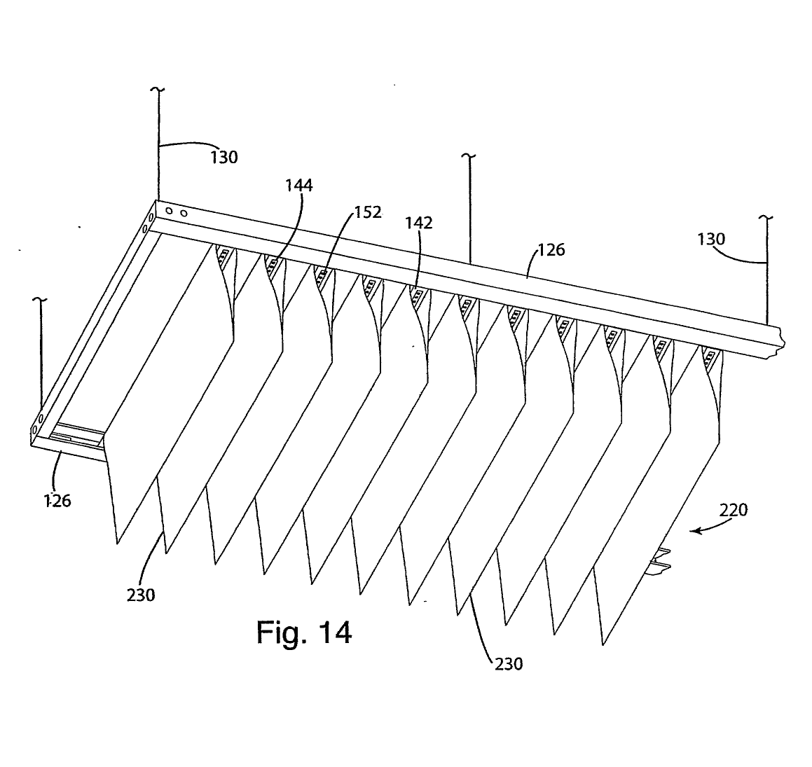

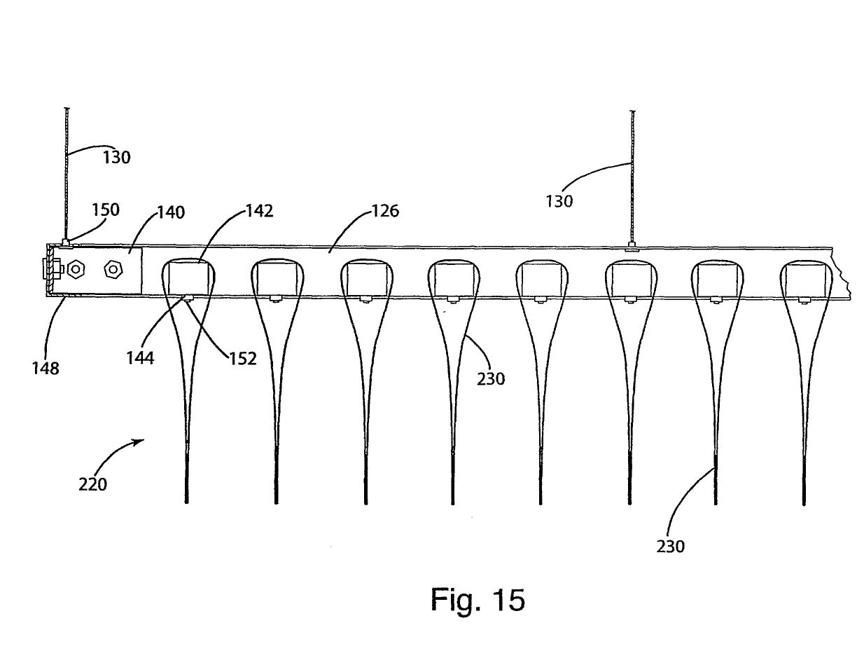

FIGS. 14 and 15 illustrate a second ceiling configuration 220. In this particular configuration, light diffusing fabric fins again are employed. However, in this case, the fins are in the form of a singular light sheet 230 which may be “wrapped” around the light members 142. Ends of the light sheets 230 may be secured together by any suitable means. In this case, the light sheets 230 may also comprise light diffusing heliofon fabric. Again, such fabric is commercially available. However, in addition, the fabric dimensions may be customized through the use of digital cutting by the end user.

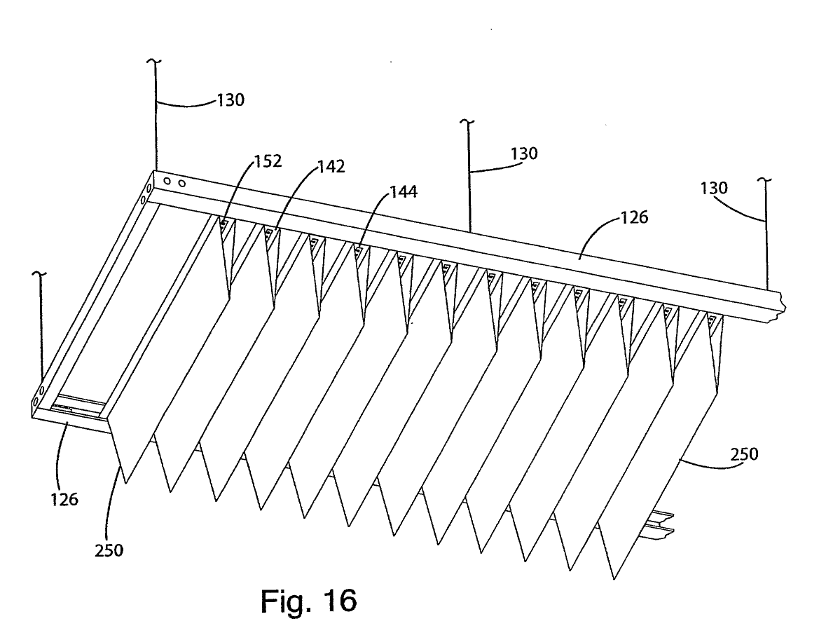

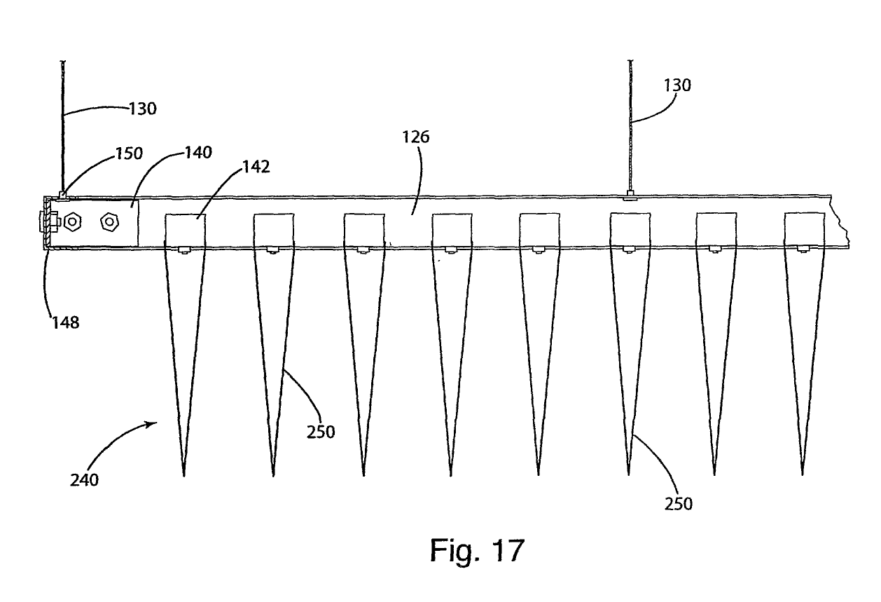

FIGS. 16 and 17 illustrate another alternative embodiment of a ceiling configuration in accordance with the invention, identified as ceiling configuration 240. In this particular configuration, ceilings are utilized which are in the form of rigid fins 250. The fins 250 may be secured in any appropriate manner to the lower portions of the LED members 142. In this case, the rigid fins 250 form, as illustrated in FIG. 17, what would be characterized as “deep triangles.” In this particular instance, the rigid fins 250 in accordance with the invention may be composed of a translucent Lexan® material.

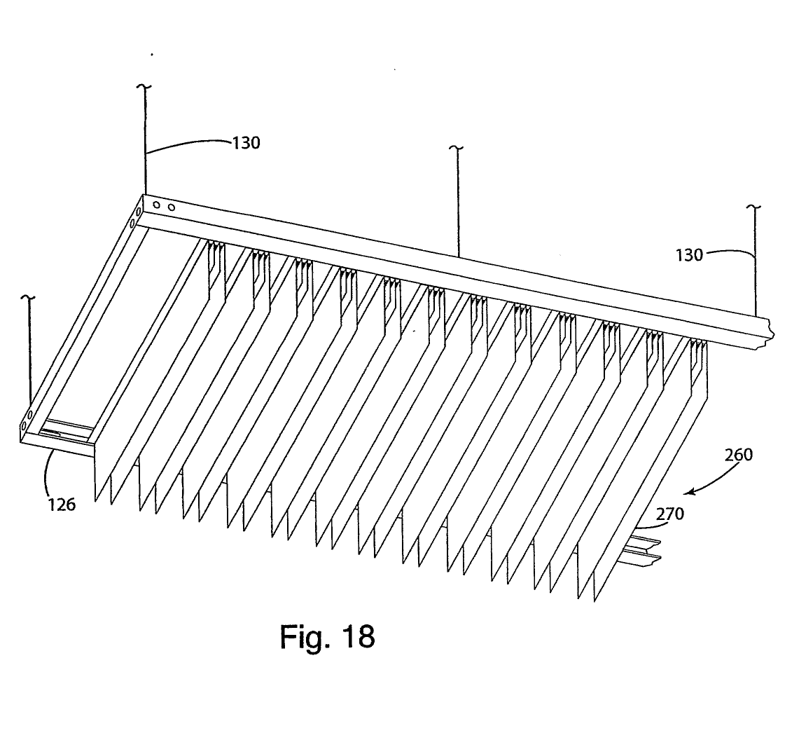

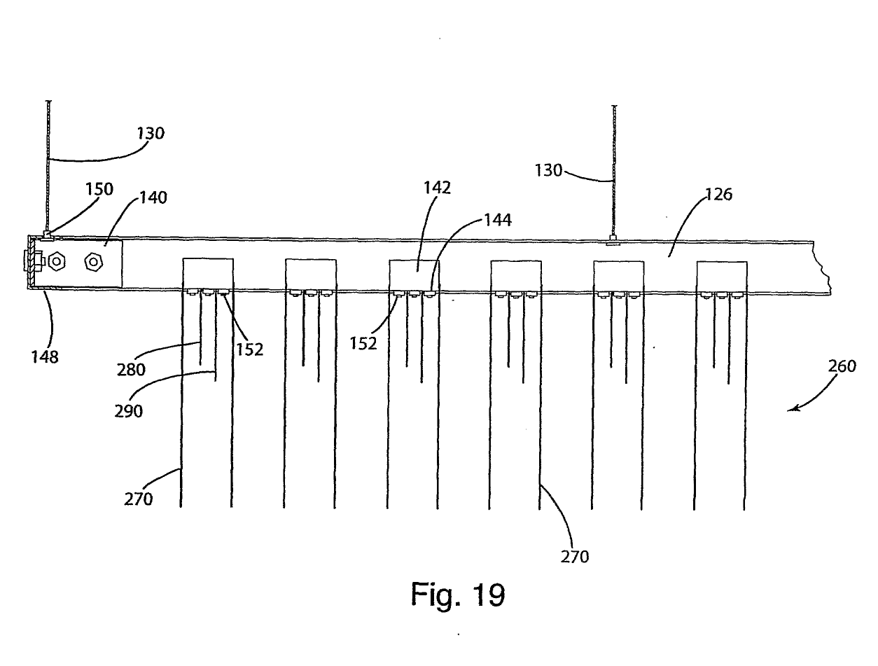

FIGS. 18 and 19 illustrate a further ceiling embodiment comprising the ceiling configuration 260. As shown in FIGS. 18 and 19, the ceiling configuration 260 includes a pair of relatively long rigid fins 270, which essentially form a rectangular configuration. Intermediate the two rigid fins 270 associated with each member 142 is a rigid fin 290 of intermediate length, and a rigid fin 280 of relatively shorter length. The fins 280 and 290 separate a series of three linear LED lighting modules 144 from each other. Again, the rigid fins 270, 280 and 290 may consist of a translucent Lexan® material.

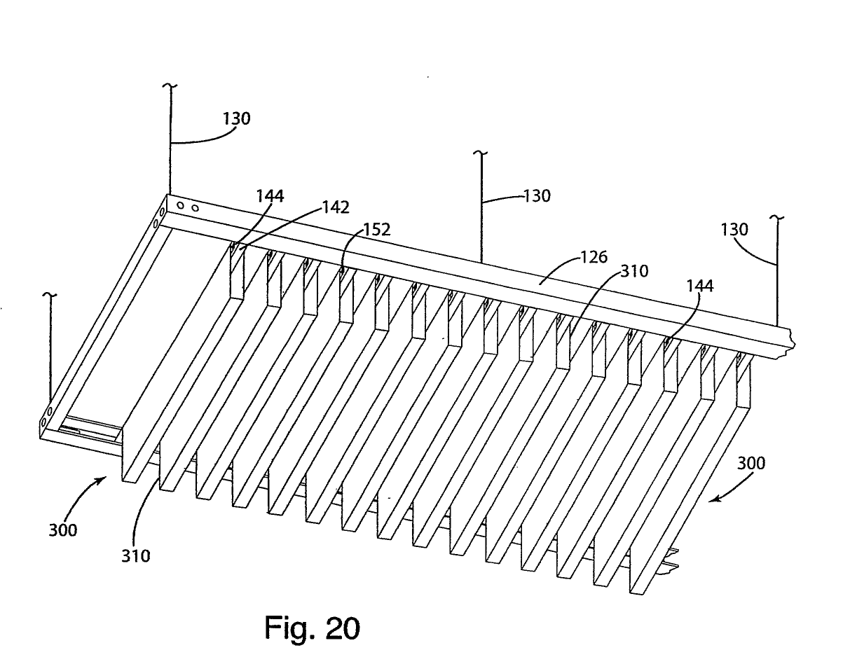

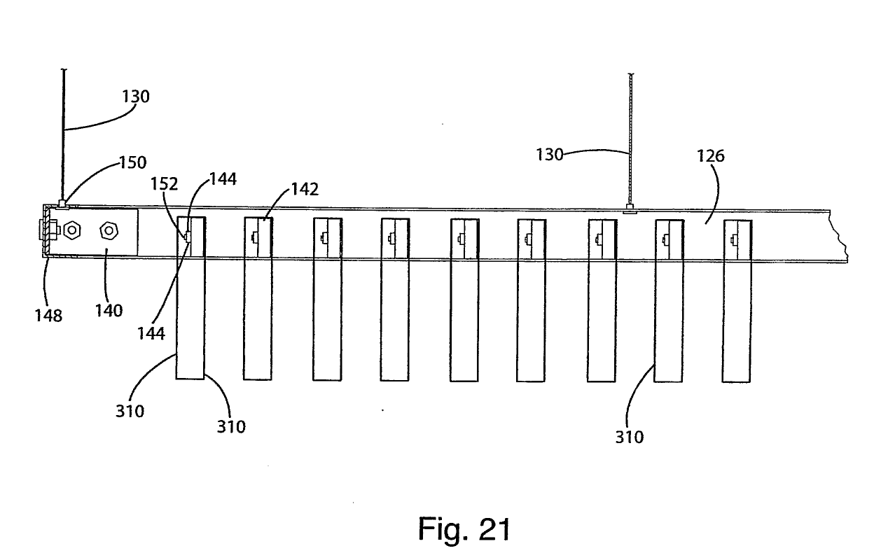

FIGS. 20 and 21 illustrate another embodiment of a ceiling configuration, identified as ceiling configuration 300. In this particular instance, a series of rigid fins 310 form a rectangular configuration around individual ones of the linear LED lighting modules 144. However, unlike certain of the other ceiling embodiments described herein, embodiment 300 is configured so that each linear LED lighting module 144 is turned on its side, with the strips of LED's 152 have a different directional configuration. In this case, the ceiling configuration 300 includes the rigid fins 310 in a rectangular configuration, with the fins 310 also being constructed of a translucent Lexan® material.

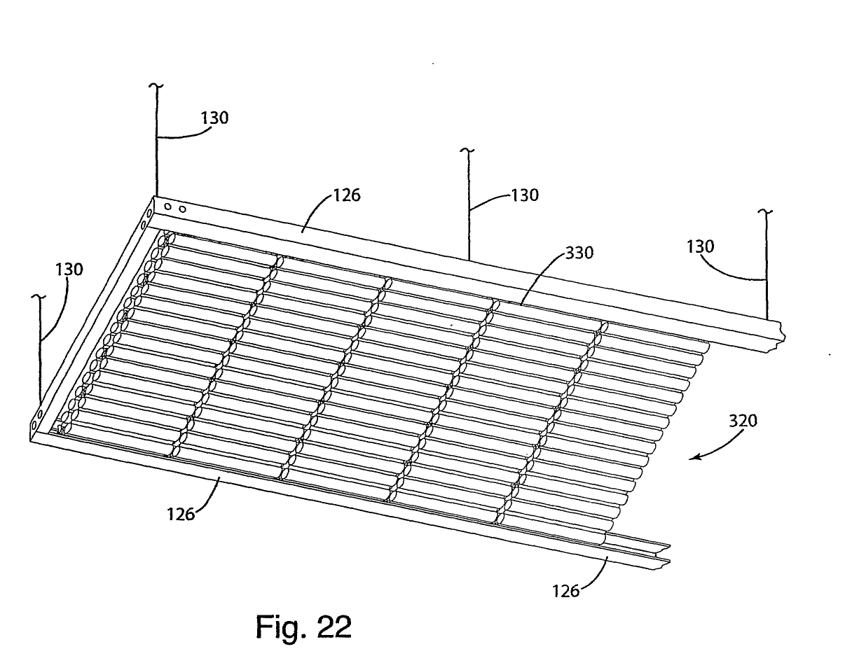

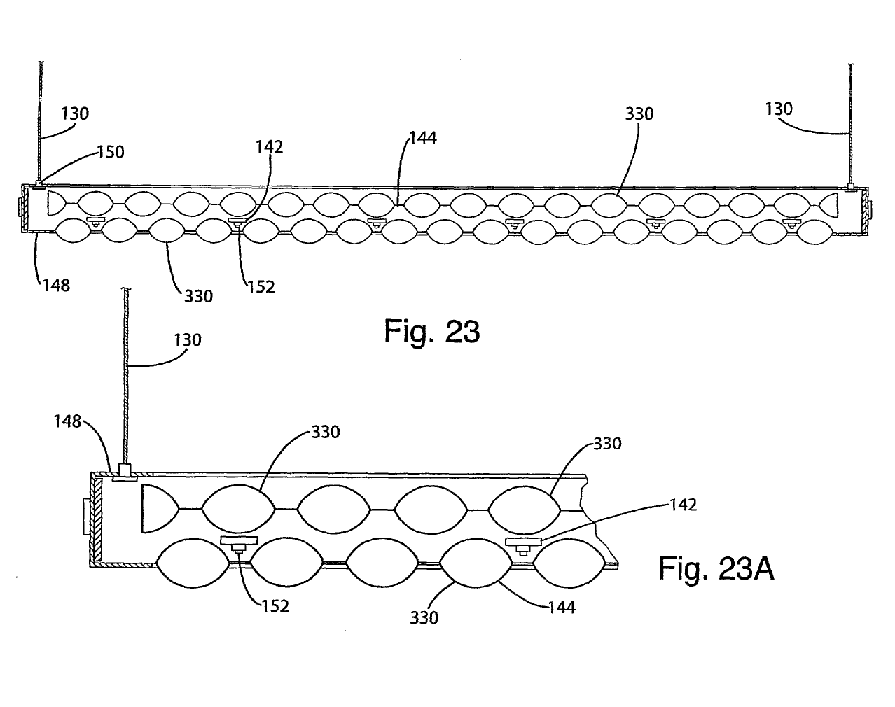

FIGS. 22, 23 and 23A illustrate a further ceiling configuration 320 which may be utilized in accordance with the invention. As illustrated in these drawings, the ceiling configuration 320 includes a series of parallel and spaced apart linear air tubes 330. The linear air tubes 330 are mounted so that a series of members 142 and attached linear LED lighting modules 144 are spaced intermediate the linear air tubes 330. Although not expressly shown in the drawings, the LED members 142 may be mounted in any appropriate means to the frame 126. For purposes of providing the linear air tubes 330, polyethylene air tubes may be utilized. Such air tubes are commercially available.

With respect to each of the ceiling embodiments described herein, it should be emphasized that the specific embodiments do not show details relating to powering of the linear LED lighting modules. However, power can be supplied to the lighting modules as described with respect to previous drawings herein. Further, a number of different arrangements for providing power to the linear LED lighting modules may be utilized.

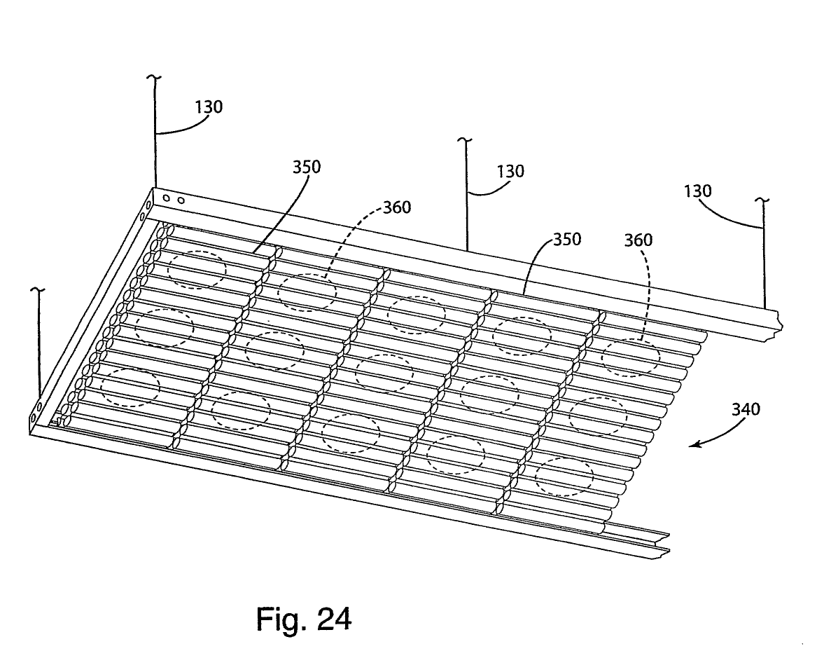

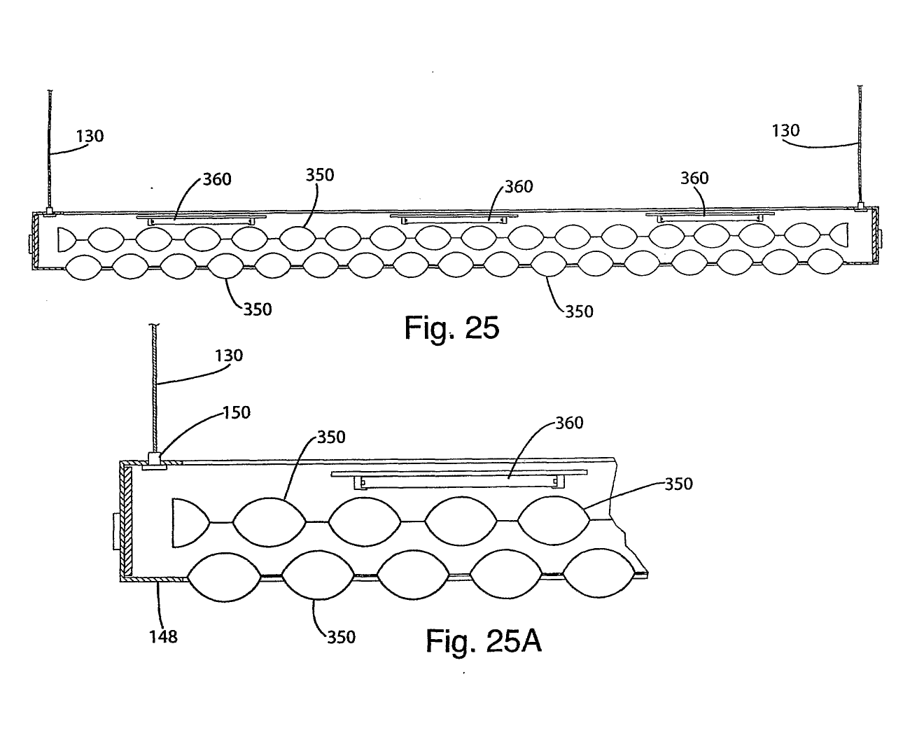

FIGS. 24, 25 and 25A illustrate a further ceiling configuration 340. The configuration 340 is somewhat similar to that illustrated in FIG. 22, in that the configuration 340 utilizes linear air tubes 350 for purposes of providing the ceilings. However, unlike FIG. 22, the ceiling embodiment 340 also utilizes what are referred to as round marker LED lighting modules 360. Such lighting modules 360 have a structural configuration as primarily illustrated in FIGS. 25 and 25A. Again, the linear air tubes 350 may be constructed of polyethylene air tubes.

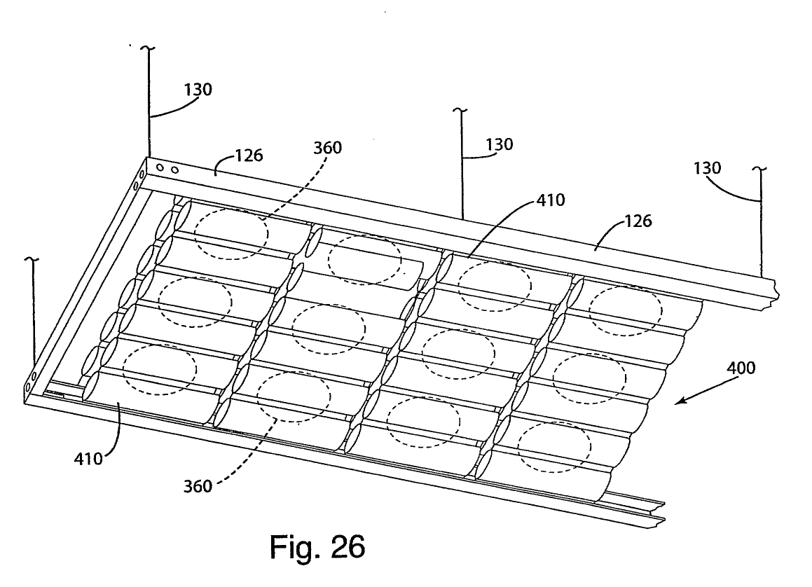

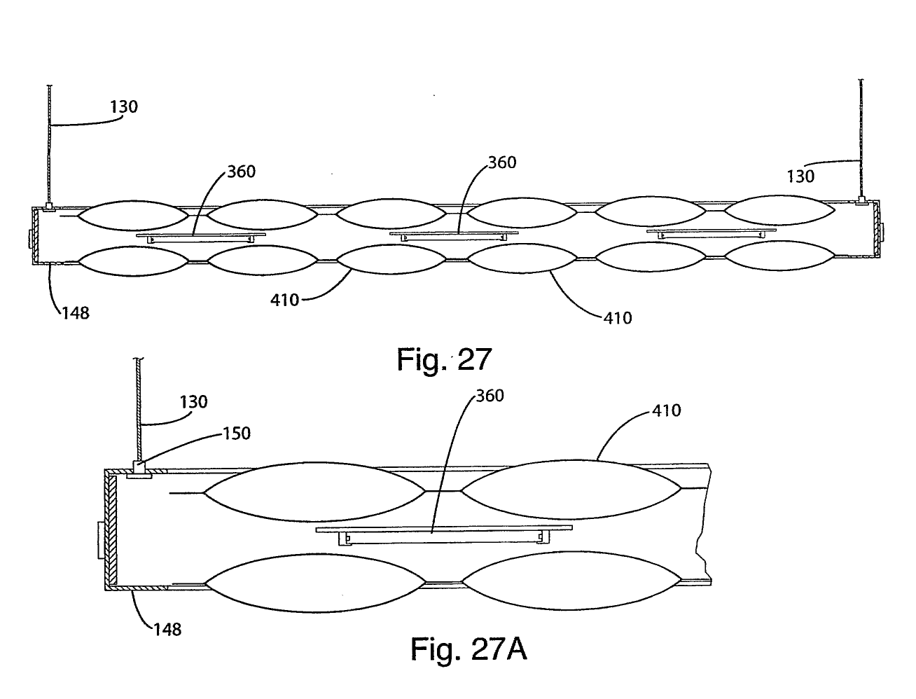

FIGS. 26, 27 and 27A illustrate a further embodiment of a ceiling configuration in accordance with the invention, identified as ceiling configuration 400. In this particular instance, the ceiling configuration 400 employs round marker LED lighting modules 360, corresponding to the round marker LED lighting modules 360 previously described with respect to FIGS. 24, 25 and 25A. However, unlike the ceiling embodiment 340 illustrated in FIG. 24, the ceiling embodiment 400 employs ceilings which may be characterized as air pillows 410. Both the round marker LED lighting modules 360 and the air pillows 410 are commercially available. Preferably, the air pillows 410 may be constructed of a polyethylene material. The air pillows 410 and the round marker LED lighting modules 360 provide a still different translucency and light diffusion.

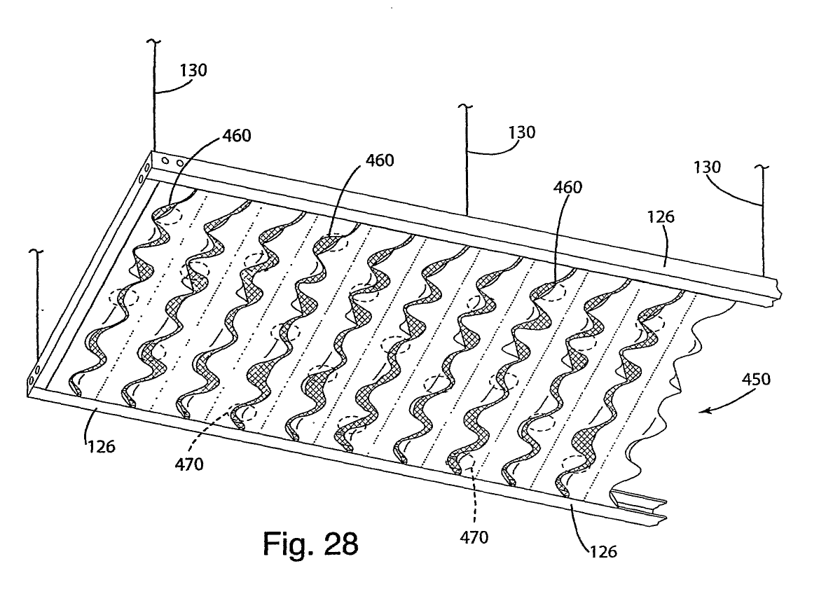

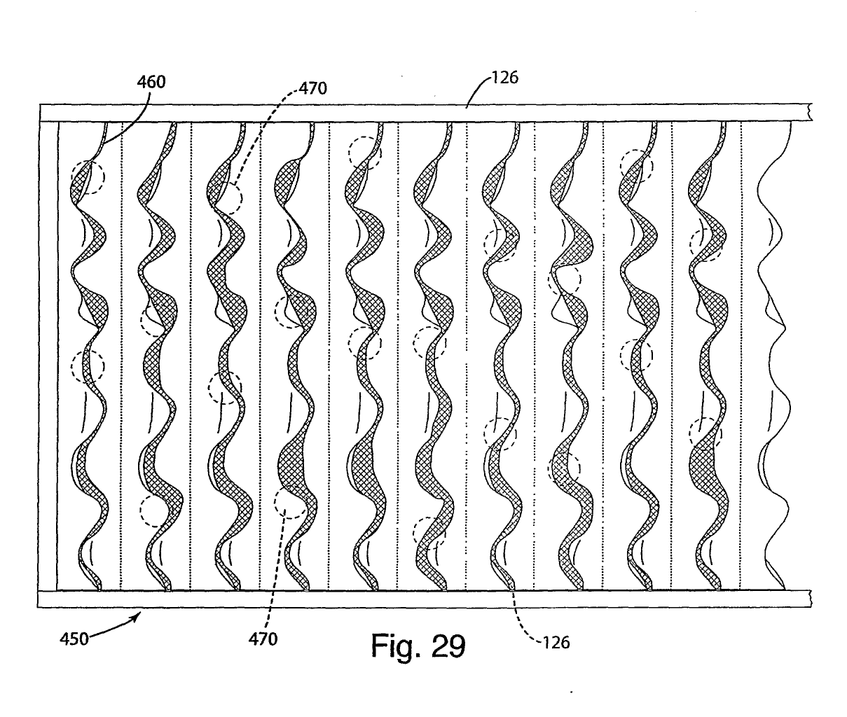

FIGS. 28, 29 and 30 illustrate a further embodiment of a ceiling configuration in accordance with the invention. More specifically, FIGS. 28, 29 and 30 illustrate a ceiling configuration 450 which utilizes a series of woven fabric materials 460. These woven fabric materials 460 may be of any of a number of different fabrics, and may be suspended in a manner so as to provide a “wave” pattern as illustrated in FIGS. 28 and 29. In addition, for purposes of aesthetics, forced air may be circulated around the fabrics 460, and the same may be suspended or otherwise hung so as to generate “pulsing” curvatures as a result of the airflow. Positioned above the fabrics 460 are members 142 having any of a number of different types of LED lighting modules 470 associated therewith. For example, the LED lighting modules 470 could be in the form of linear LED lighting modules or, alternatively, round marker LED lighting modules, each as previously described herein.

FIGS. 31 and 32 illustrate the concept that the ceiling configurations do not necessarily have to be located in horizontal planes. FIGS. 31 and 32 each show a horizontal plane A, for purposes of orientation. Each of these drawings also shows a series of shielding elements 116 (which may incorporate any of the embodiments previously described herein), suspended from suspension cables 130. As illustrated in FIG. 32, the shielding elements 116 may be of varied angular orientation, with the shielding elements interconnected through flexible or hinged frames 500.

As earlier referenced herein, the ceiling configurations may be provided with means for facilitating control and reconfiguration of controlled relationships among various functional components which may be utilized with the ceiling configuration. For purposes of describing the concept of establishing controlling relationships among various controlled and controlling components which may be associated with the ceiling configurations, reference is made to the commonly assigned U.S. Provisional Patent Application Ser. No. 60/374,012 entitled “Switching/Lighting Correlation System” and filed Apr. 19, 2002. The contents of the aforedescribed patent application are hereby incorporated by reference herein.

With respect to the ceiling configurations described herein, most of these configurations made reference to LED lighting elements. That is, the ceiling configurations may be categorized as being available in an “unlit” format and a “lit” format. As earlier described herein, various other types of lighting elements may be utilized, such as fluorescent, metal halide and similar elements. Further, various types of acoustical control or absorption concepts may be employed with ceiling systems in accordance with the invention. Still further, with respect to security and safety, the shielding elements may be constructed of fire resistant or fire proof materials. Still further, the LED lighting elements and other lighting elements which may be utilized in accordance with the invention can comprise various colors. In addition, the colors of the lighting elements can be physically and/or electrically controlled.

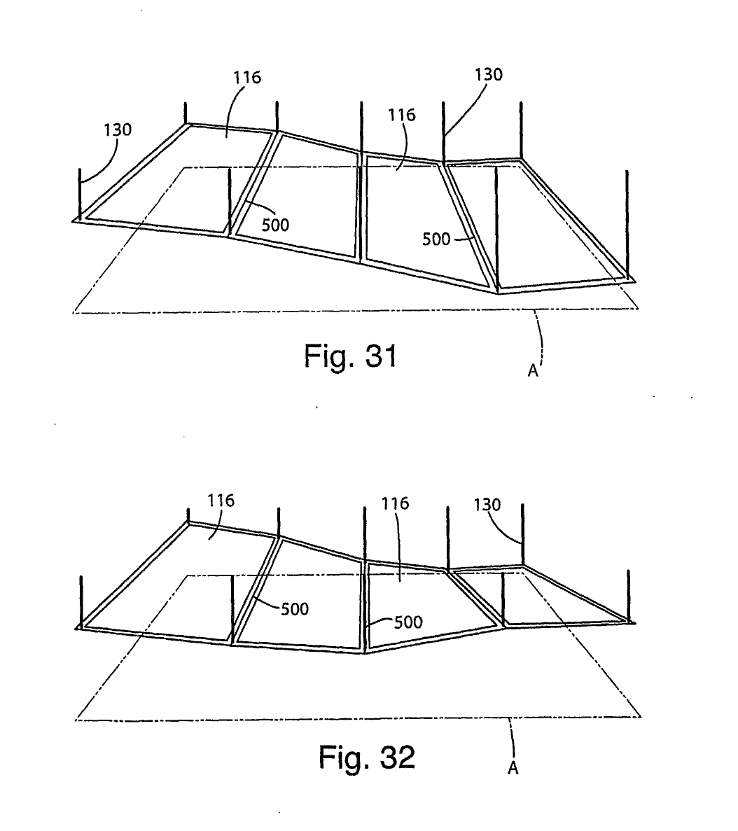

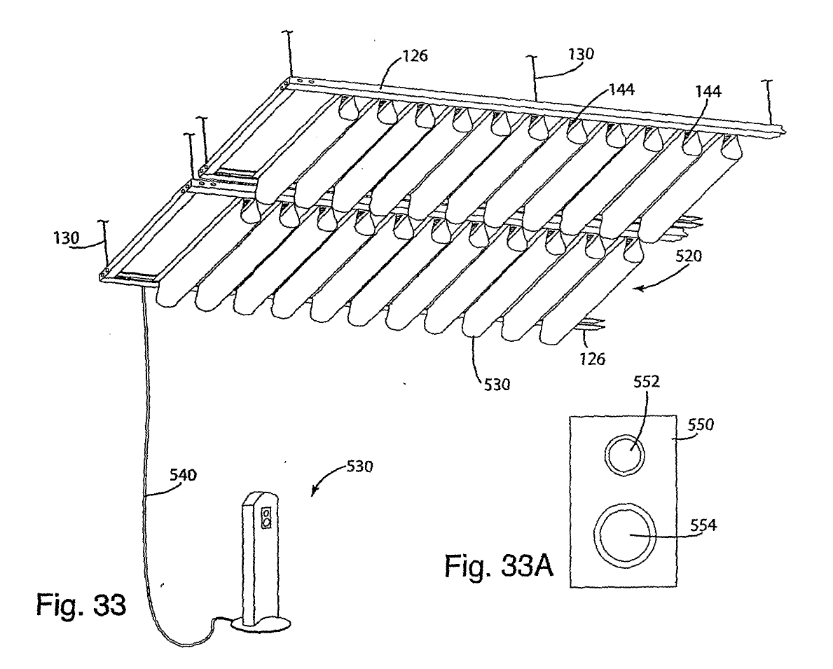

In this regard, it would be favorable to establish control relationships among switches and lights, and have the capability of reconfiguring the same. Other control relationships may also be worthwhile. For example, FIGS. 33 and 33A illustrate a ceiling configuration 520 utilizing light bag elements 530 similar to those previously described herein. As also shown in FIG. 33, the linear LED lighting modules 144 may be coupled to a power cord 530 which, in turn, is coupled to a switch stand 530. As with other ceiling configurations previously described herein, the ceiling configuration 520 may employ other types of lighting elements, such as fluorescent, metal halide and similar elements. The switch stand 530 includes a dimmer configuration 550, having an enabling switch 552 and a dimmer control 554. With respect to this configuration, FIG. 34 illustrates a user employing a control wand 560 (to be described in subsequent paragraphs herein) for purposes of establishing control of the linear LED lighting modules 144 associated with the ceiling configuration 520. In this case, the control wand 560 may be pointing to an IR receiver (not shown) for executing certain control functions.

FIG. 35 illustrates the user projecting the control wand 560 toward the dimmer configuration 550. The dimmer configuration 550 may have an IR receiver, for purposes of receiving IR signals 562 from the control wand 560. In this case, and as described in U.S. Provisional Patent Application Ser. No. 60/374,012, entitled “Switching/Lighting Correlation System” and filed Apr. 19, 2002, the user may be employing the control wand 560 so as to establish that the dimmer configuration 550 will be controlling the linear LED lighting modules 144 of the ceiling configuration 520. Further, the control wand 560 may be used to reconfigure various shielding elements themselves. That is, with the ceiling configuration 520 utilizing elements such as light bag elements 530 as previously described herein, the configuration 520 may be equipped with electromechanical devices (not shown) which could cause the light bag elements 530 to physically move, so as to form various structural configurations. These movements could be under the control of controlling elements which, in turn, are controlled through signals received from the control wand 560.

With respect to concepts associated with control, it is also possible to utilize ceiling systems in accordance with the invention with systems which employ vertically disposed space dividers and the like. An example of such a system is disclosed in U.S. Provisional Patent Application Ser. No. 60/408,011, entitled “Partition System with Technology” and filed Sep. 4, 2002.

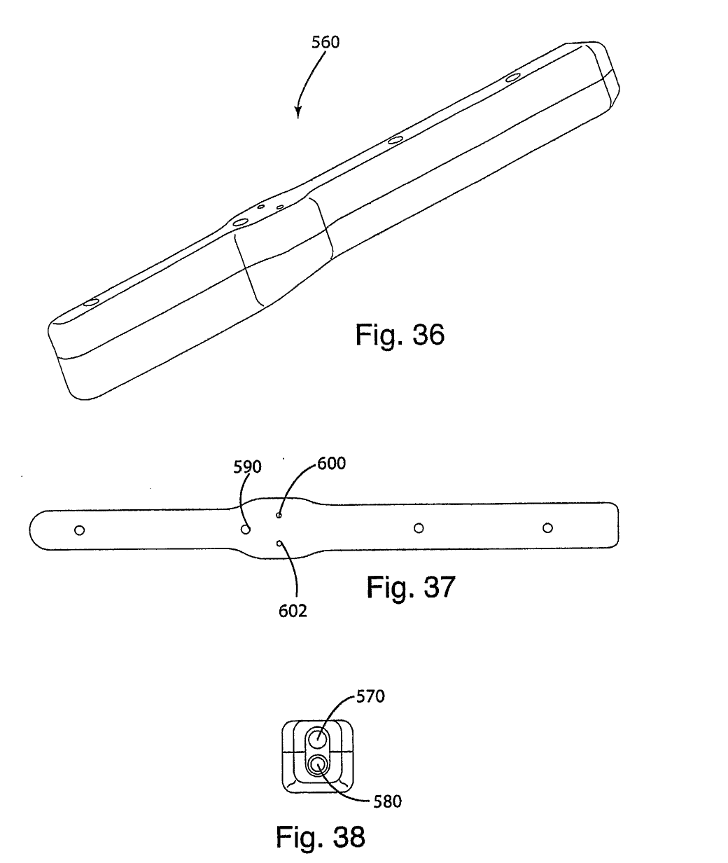

An example of the control wand 560 is illustrated in FIGS. 36, 37 and 38. With reference thereto, the control wand 560 may be of an elongated configuration. At one end of the control wand 560 is a light source 570 which, preferably, would generate a substantially collimated beam of light. In addition to the light source 570, the control wand 560 may also include an infrared (IR) emitter 580, for transmitting infrared transmission signals to corresponding IR receivers associated with the ceiling configuration 520 and the dimmer configuration 550, in addition to other elements which may be utilized with other functional accessories.

The control wand 560 may also include a trigger 590, for purposes of initiating transmission of IR signals. Still further, the wand 560 may include mode select switches, such as mode select switch 600 and mode select switch 602. These mode select switches 600, 602 may be utilized to allow manual selection of particular commands which may be generated using the wand 560. The control wand 560 may also use controllers (not shown) or similar computerized devices, for purposes of providing electronics within the wand 560 for use with the trigger 590, mode select switches 600, 602, light source 570 and the IR emitter 580. As earlier mentioned, an example of use of such a wand, with the control commands which may be generated using the same, is described in commonly assigned U.S. Provisional Patent Application Ser. No. 60/374,012, entitled “Switching/Lighting Correlation System” and filed Apr. 19, 2002.

Referring back to FIGS. 34 and 35, the user may employ the wand 560 to transmit signals to a controller (not shown) associated with the dimmer configuration 550 and the ceiling configuration 520. The capability of essentially “programming” controlled relationships among the various accessories associated with the ceiling configurations requires a capability of transmitting and receiving communication signals among the various functional accessories. In this regard, infrastructure systems may be employed. An example of such an infrastructure system which may be employed with the ceiling configurations in accordance with the invention is described in detail in the commonly assigned U.S. Provisional Patent Application Ser. No. 60/408,149, entitled “Rail System” and filed Sep. 4, 2002.

The foregoing has described a number of concepts associated with ceiling systems for use with a supporting infrastructure. As also described, the supporting infrastructure has the capability of distribution of electrical power and communications, utilizing a series of frames and cross frames. Shielding elements are supported with the frames and cross frames, and a series of lighting elements are electrically coupled and energized through the electrical power distribution. In addition to these concepts, additional concepts which may be characterized as being refinements and enhancements to those previously described herein are set forth in the following paragraphs. With respect to concepts described in the foregoing, a number of those components are disclosed and claimed in International Patent Application No. PCT/US03/27535, entitled “CEILING SYSTEM WITH TECHNOLOGY,” filed Sep. 4, 2003.

For purposes of disclosure, the concept of “shielding elements” as used in the foregoing description will more often be referenced in subsequent paragraphs herein as “visual shields.” These visual shields, as also previously described herein, can be utilized with lighting systems, including such elements as the LED lighting modules 144, previously illustrated and described with respect to the use of a series of spaced apart LED lights 152. When considering the use of LED or similar lighting systems in an overhead structure, a number of issues become important. For example, when installing LED lighting systems, it would be beneficial if the installation is relatively simple. In fact, if the installation procedures can be reduced sufficiently with respect to complexity, it may be possible for laypersons to install the same, without requiring electricians or others having technical expertise (and cost). In the same regard, for facilitating installation, it is advantageous if the LED lighting elements are of a relatively light weight.

In addition to weight, if the lighting elements can be manufactured and assembled off-site so that when they are received at the installation site, the number of individual “parts” of the lighting configurations can be minimized. These and similar properties not only facilitate initial installation, but also replacement. Still further, in terms of structure of lighting configurations, governmental and other institutional codes and regulations may require such configurations to maintain access to the fixtures which may be mounted above the general plane of the lighting configurations (such as sprinkler systems and the like). Similarly, the light configurations should be configured so as to permit fixtures above the general plane of lighting configurations to be brought downward “through” the light configurations and below the configuration planes. In the same regard, it is advantageous if the lighting configurations can provide sufficient light intensity, while still being of a size which permits selective placement and relocation of fixtures. That is, it is advantageous if the lighting configurations do not occupy a substantial amount of square footage relative to the area of an overall ceiling plane.

Other advantageous features of lighting configurations in accordance with the invention relate to actual performance. Safety considerations are always important with respect to lighting configurations. Accordingly, it may be advantageous for the lighting configurations to operate with relatively low voltages. With the use of lighting configurations under control of a communications network as previously described herein, such configurations could be made to respond to various types of environmental sensing devices. For example, light intensity generated by the lighting configurations could be made to vary dependent upon the level of sunlight intensity then within the overall environment. Such sensors can also include motion sensing devices. The lighting configurations could be made to enable lights only within certain spatial areas, in response to communication signals representative of sensed motion. In this same regard, variations in spatial lighting configurations can be utilized for purposes of “wayfinding,” as described in previous paragraphs herein. Again, such wayfinding can be utilized with the lighting configurations by generation of different colors (representing, for example, emergency situations) and variations in spatial lighting. Emergency situations may also result in sequential enablement of various lights within the configuration, thereby representing a safe exit path.

Still further, changes in degrees of translucence, light intensity, texture, diffusion and color can be utilized to change the overall aesthetics of a commercial interior. It is known, for example, that changes in lighting properties have the capability of psychologically influencing an occupant's mood. These changes in lighting properties can also provide a “placemaking” function. That is, the “tone” of the commercial interior can be varied through variations in lighting colors, intensity and the like.

As earlier described, it is advantageous if the area of the ceiling plane taken up by the lighting configurations is maintained relatively small (thereby allowing access to fixtures, fixture placement and relocation). However, it is also advantageous if the lighting configurations can require relatively small spatial areas, while still providing, if desired, for a “continuous” ceiling plane of light. Such continuums in light intensity are known to enhance space lighting, reduce shadows and provide other advantages. Having somewhat of a “continuous” ceiling plane of light and the capability of variations in lighting properties across the plane provide for other advantages. For example, the concept of “pixels” is relatively well known in the areas of image processing, pattern recognition, computer graphics and other display technologies. A pixel is often referred to as the smallest element of a display surface that can be given independent characteristics. With the use of lighting configurations as described herein in accordance with the invention, functions such as image displays on ceiling surfaces and the like can be facilitated. That is, the lighting configurations can be made to vary with respect to what is characterized as “color pixilation intensity.”

As earlier stated, it may be advantageous for lighting configurations in accordance with the invention to utilize relatively low voltages. The use of low voltages, and particularly the use of DC voltages, provides economic advantages, as well as facilitating safety. With low voltage lighting configurations, and particularly LEDs, these configurations have a relatively long life, given the low energy consumption. Also, these lighting configurations do not result in the generation of any substantial heat within the commercial interior, in view of relatively reduced AC power consumption.

As also described in subsequent paragraphs herein, one particular visual shield configuration falling within the scope of the invention and having relatively preferable structure and function is characterized herein as a “concertina visual shield.” As will be described, the concertina visual shield is relatively lightweight, thereby facilitating installation and replacement. Also, the concertina visual shield is sufficiently porous, so as to permit ceiling entry for utilities such as sprinklers, air conditioning components and others. In addition, when used with a structural overhead system which is considered to be a preferred implementation, the concertina visual shield can be releasably secured to structural elements, thereby facilitating installation, replacement and general user access. With the particular structural support and means described herein for releasably securing the concertina visual shield to the structure, various lighting structures of the LED lighting configurations can be readily placed in desired positions on the structure, without any substantial interference from the concertina visual shield.

The concertina visual shield also provides for various aesthetics. For example, the visual shield can be “customized” to particular types of configurations, through the use of custom contour cuts. Also, the concertina visual shield can utilize various types of components (such as light bags). The overall construction of at least one embodiment of the concertina visual shield in accordance with the invention not only facilitates installation or replacement, but also is economically advantageous. The concertina visual shield in accordance with the invention may be constructed as a continuum, thereby facilitating installation. However, such a construction also assists in shipment, in that the concertina visual shield can, for example, be “collapsed” so as to require relatively minimal shipping space. The concertina visual shields can also be characterized as being “dematerialized,” thereby resulting in less waste and more rapid reconstruction.

The lighting configurations and the concertina visual shields (as well as other visual shields which may be utilized) can be advantageously implemented within a power and communications distribution system which facilitates lighting control. As will be described herein, the user will have the capability of control of lighting anywhere from a relatively “broad” selection to a set of specific components associated with the lighting configurations. The interconnections of the lighting configurations to the communications network also permit relatively broad color spectrums, whereby the user can enable specific color and lighting schemes. With the communications network having a distributed configuration, the user can locate the user's control components at any of a number of various desired locations. Still further, the embodiments of network connection configurations as described herein for the use of lighting elements can be applied to include other types of applications, such as sound devices, motion control, projection screens and others.

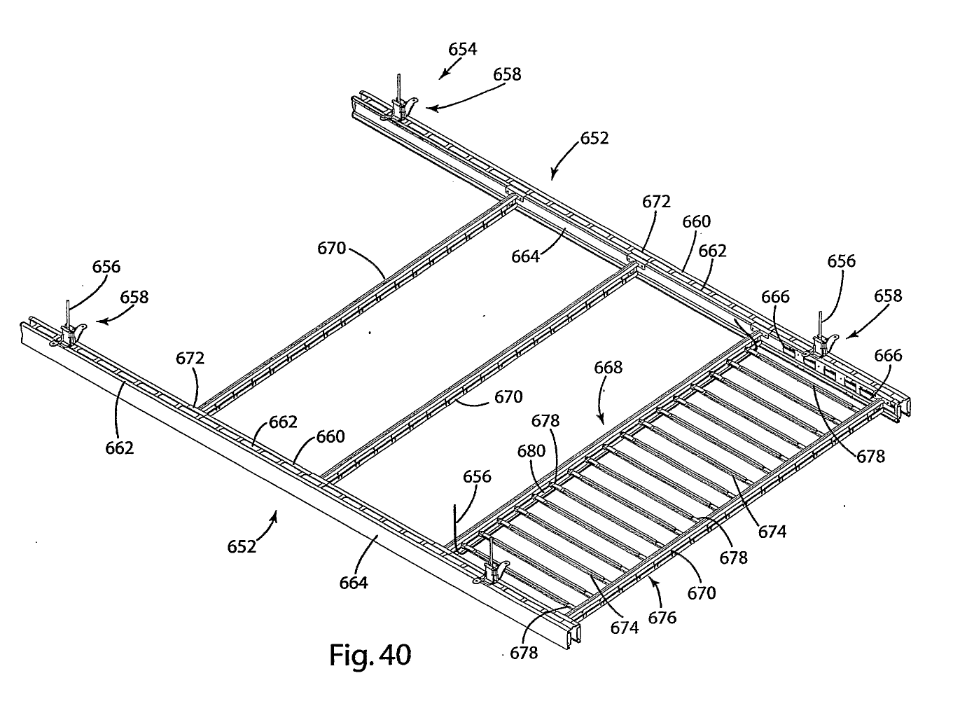

Turning more specifically to the lighting configurations and visual shields described in subsequent paragraphs herein, reference is made to FIGS. 39-73. With reference first to FIG. 39, an LED ladder system 650 is illustrated. The LED ladder system 650 will be described primarily with respect to FIGS. 39-48. In FIGS. 39, 40 and 41, the system 650 is shown as comprising a ladder system adapted to be interconnected between spaced apart and parallel main perforated structural channel rails 652. The main perforated structural channel rails 652 may, in one embodiment, comprise structural channel rails associated with a structural channel system, partially shown within the drawings and referenced as structural channel system 654 in FIG. 40. The structural channel system 654 is adapted to provide a structural system for a distributed power and communications network. The main perforated structural channel rails 652 substantially correspond in structure and function to the previously described structural channel rails 118 with respect to the ceiling system configuration 100 described herein. Although the ladder system 650 is illustrated herein as being used with the structural channel rails 652 and the structural channel system 654, it is apparent that other types of structural support systems may be utilized with the ladder system 650 in accordance with the invention, without departing from the novel concepts of the spirit and scope of the invention. For example, the ladder system 650 could be utilized with various types of supporting T-bar structures, using angle irons or the like. That is, the ladder system 650 can essentially be “decoupled” from requisite use with a particular structural supporting configuration. Still further, although the ladder system 650 is described herein as being utilized with a distributed network, the ladder system 650 can also be utilized independent of a particular electrical and/or communications network. For example, power for the ladder system 650 may be provided through separate power sources independent of any distributed or other type of network.

With reference to FIG. 40, the structural channel system 654 includes a series of spaced apart and parallel main perforated structural channel rails 652. The structural channel rails 652 may be adapted to carry AC power and communication signals for purposes of providing power to various components associated with the LED ladder system 650, and for providing the capability of programming and controlling various functional components associated with the LED ladder system 650. With continued reference to FIG. 40, each of the channel rails 652 may be supported by a series of support rods 656. Each of these support rods 656 is shown only with respect to its lower part in FIG. 40. The support rods 656 may be secured at upper ends (not shown) to a ceiling or upper supports (not shown) associated with a building's infrastructure. For example, the threaded support rods 656 could be secured at their upper ends to L-beams (not shown) of the commercial interior, in a manner which provides for rigidity, and also provides for adjustability with respect to vertical positioning of the channel rails 652. The L-beams may be rigidly secured to the building's base structure, such as an upper ceiling (not shown) of the commercial interior. For purposes of vertical adjustability of the support rods 656 relative to the suspension brackets 658, the support rods 656 may, for example, be threadably received within the brackets 658. In turn, the suspension brackets 658 may be releasably or otherwise secured in a rigid fashion to the structural channel rails 652. Preferably, support rods 656 and suspension brackets 658 are positioned at spaced apart locations along the longitudinal length of each of the structural channel rails 652.

Turning more specifically to the structure of each of the main perforated structural channel rails 652, each rail 652 may have a longitudinally extending upper portion 660 formed in a single plane, which would be commonly positioned in a horizontal configuration. Extending through the upper portion 660 are a series of spaced apart upper rectangular apertures 662. The apertures 662 can be characterized as surface perforations, which may be utilized to permit passage of cables or the like above and below a ceiling plane formed by the structural channel rails 652. Predrilled mounting holes (not shown) may also be positioned as necessary within the upper portion 660. These mounting holes can be utilized for purposes of securing the suspension brackets 658 to the structural rails 652.

Integral with the upper portion 660 and extending downwardly from opposing lateral sides thereof are a pair of side panels 664. Extending along the sides of both side panels 664 of an individual structural channel rail 652 are a series of apertures 666. For purposes of clarity in the drawings, the apertures 666 are illustrated in FIG. 40 only along an inner side panel 664 of one portion of one of the structural channel rails 652.

The main perforated structural channel rails 652 can also include a number of other components, such as covers and the like. Also, although not specifically shown in the drawings, power and communications can be distributed along the lengths of the structural channel rails 652 through the use of devices such as modular plug assemblies (not shown). These modular plug assemblies may include buses, cables or other types of electrical structure for interconnecting, for example, to incoming building sources of AC power. These plug assemblies may have elongated lengths with the electrical wiring carrying AC building power being distributed through the entirety of the lengths of the structural channel rails 652. Correspondingly, such modular plug assemblies may also carry communication signals for purposes of providing for a programmable communications network throughout the entirety of LED ladder system 650 and other components which may be associated with the structural channel system 654. These communication signals may be distributed not only along the lengths of each of the individual structural channel rails 652, but electrical interconnections may be made between and among various structural channel rails 652 so as to provide for a complete distribution of a communications or “intelligence” network. The LED ladder system 650 may utilize interconnections of the modular plug assemblies for purposes of obtaining low voltage DC power. The modular plug assemblies may also provide access to AC building power. However, other devices (such as the electronics units 814 subsequently described herein) may be used to directly access AC building power and convert the same to DC power for powering the LED ladder system 650. Further, the electronics units 814 may be responsive to signals received from the communication network so as to selectively control the application of DC power (including amplitude variation of applied voltages for purposes of variation in light intensities).

Various types of devices (including the wand 560) may be controlled by the user for purposes of appropriately generating communication signals so as to program functional operation of the lighting or other components associated with the LED ladder system 650. With respect to the structural channel system 654, including the use of structural channel rails, support rods, suspension brackets, modular plug assemblies and other electronic components, these concepts are disclosed in copending U.S. Provisional Patent Application Ser. No. 60/599,447 entitled “POWER AND COMMUNICATIONS DISTRIBUTION USING A STRUCTURAL CHANNEL SYSTEM” and filed Aug. 5, 2004. The disclosure of the aforedescribed patent application is incorporated by reference herein. Because of the importance of the aforedescribed provisional patent application, the application will be referred to herein as the “channel system application.” The structural channel system 654 disclosed herein may correspond to the structural channel system 100 disclosed in the channel system application. Correspondingly, the main perforated structural channel rails 652 disclosed herein may correspond to structural channel rails 102. Threaded support rods 656 disclosed herein may correspond to support rods 114. Suspension brackets 658 may correspond to suspension brackets 110. The modular plug assemblies referenced herein may correspond to modular plug assemblies 130.

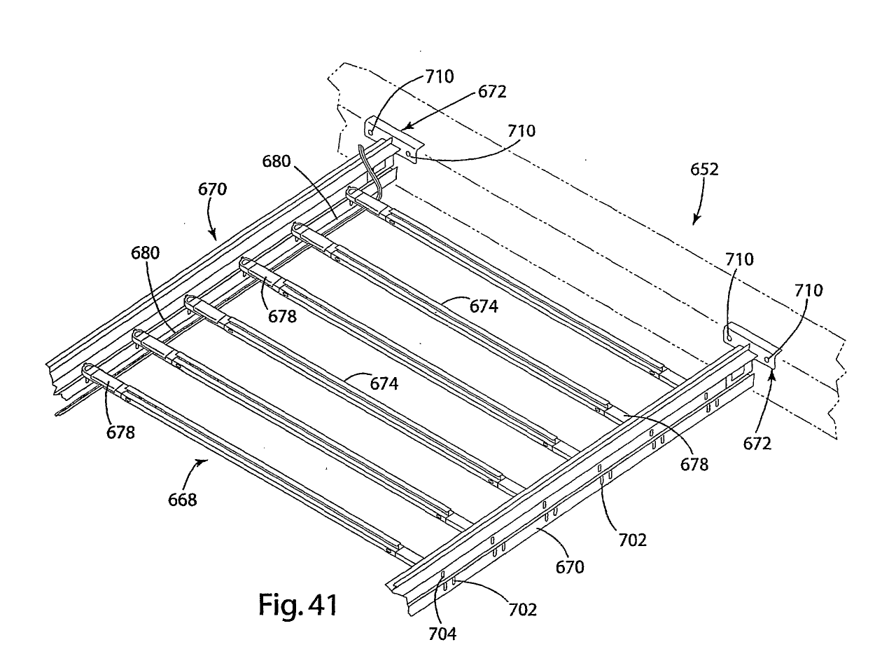

With reference to FIG. 39, the LED ladder system 650 includes a series of LED ladder panels 668. The LED ladder panels 668 comprise means for incorporating a series of LED lights within a particular spatial area, and with a density as desired by the user. Each of the LED ladder panels 668 comprises a series of spaced apart and parallel LED strip units 674. The LED strip units 674 comprise a series of spaced apart LED lights positioned on an elongated length of each of the strip units 674. Each of the LED strip units 674 is interconnected at opposing ends to one of a pair of spaced apart and parallel positioned support rails 670. Connection of each of the LED strip units 674 to the parallel support rails 670 is achieved through the use of LED strip connectors 678. In turn, each of the support rails 670 is interconnected at its opposing ends to one of a pair of structural channel rails 652 through the use of support rail mounting brackets 672 (FIGS. 40, 41).

The LED ladder system 650 also includes a series of conductors characterized herein as bonded wire ribbons 680. The bonded wire ribbons 680 comprise means for transmitting appropriate levels of DC power to the LED lights associated with the individual LED strip units 674. The bonded wire ribbons 680 are conductively connected to the LED strip units 674 within the LED strip connectors 678.

One of the advantages of the LED ladder system 650 in accordance with the invention is that the user can vary the density of the lights by varying the number of LED strip units 674 associated with each of the LED ladder panels 668, and also vary the distance between adjacent LED strip units 674. In addition, although FIGS. 39, 40 and 41 show one particular structural configuration for interconnection of the various mechanical components associated with the LED ladder system 650, variations can occur with respect to size and general configurations. Further, it is noted that FIG. 39 illustrates a set of eight LED ladder panels 668. For purposes of clarity and understanding, FIG. 40 only illustrates two of the LED ladder panels 668, while FIG. 41 illustrates only a partial one of the panels 668. As previously described herein, the ceiling configurations 100 comprise “open” systems, in that they can readily be expanded or reduced in size. Correspondingly, although FIG. 39 illustrates only a series of eight LED ladder panels 668, any number of ladder panels 668 may be utilized in accordance with the invention. Further, any of a number of various sizes may also be utilized.

In addition, the number of LED strip units 674 associated with any given LED ladder panel 668 may vary in number, not only based on sizing considerations, but also on power requirements (both with respect to wattage and density) and programmable resolution with respect to the lights associated with the LED strip units 674. That is, in a particular configuration as illustrated in FIG. 39, the specific levels of DC power applied through the bonded wire ribbon 680 associated with a given set of LED strip units 674 of one LED ladder panel 668 will be the same for each individual strip unit 674. If it is desired to have light intensities, colors, textures or other lighting properties for one of the LED strip units 674 to differ from those of another LED strip unit 674, the configuration shown in FIG. 39 would require that the two LED strip units 674 be associated with different LED ladder panels 668, so that differing power signals can be applied to the separate strip units 674. However, it can be contemplated in accordance with the invention that means can be provided for applying different levels of DC power to differing individual strip units 674 associated with a single LED ladder panel 668. For example, this could potentially be achieved by utilizing a plurality of wire ribbons 680, with voltage levels differing among the various wire ribbons 680. The various wire ribbons 680 could then be selectively attached to different ones of the strip units 674 associated with a single LED ladder panel 668. Other variations of this embodiment may also be contemplated, without departing from the spirit and scope of the novel concepts of the invention.

With respect to relative sizes, and as earlier described, various sizes and spacing among the structural components of the LED ladder system 650 may be used. For example, the main perforated structural channel rails 652 illustrated in FIG. 39 may be spaced apart a distance of 10 feet. Correspondingly, the distance between adjacent support rails 670 may, for example, be five feet. Accordingly, each of the LED panels 668 shown in FIG. 39 may then be characterized as having a planar area of two feet by five feet. However, as earlier described, the number of LED strip units 674 associated with any given LED ladder panel 668 may be varied. Accordingly, for example, a ladder panel 668 could have planar dimensions of two feet by ten feet, if that sizing still provided the required density of the LED strip units 674 and conformed with power requirements, as well as governmental and institutional codes and regulations. In a physically realizable implementation of an LED ladder system 650 in accordance with the invention, it has been found that ten LED strip units 674 can be utilized for a given LED ladder panel 668. This is a configuration which may be utilized with two LED ladder panels 668 extending between adjacent support rails 670 in each section of the ladder system 650 (the “sections” being defined by the planar area existing between two adjacent support rails 670). However, other numbers of LED strip units 674 may readily be utilized. For example, FIG. 40 illustrates the use of seventeen strip units 674.

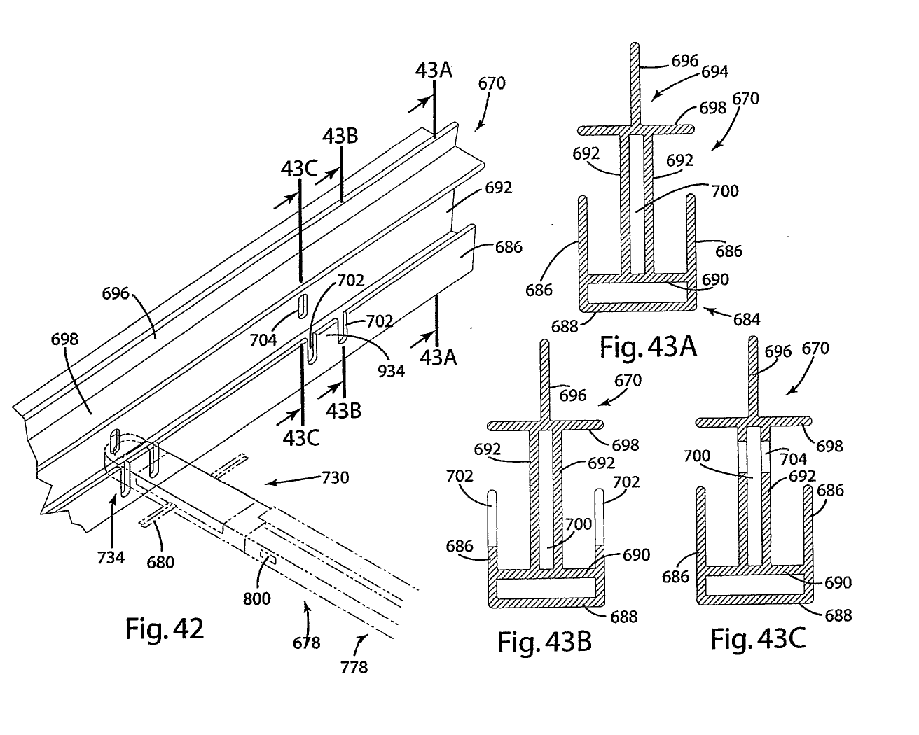

The configuration of each of the support rails 670 will now be described, primarily with respect to FIGS. 42, 43A, 43B and 43C. Each support rail 670 has an elongated configuration. As shown in the cross sectional view of FIG. 43A, the support rail 670 includes a lower U-shaped portion 684 having an inverted U-shaped configuration. The U-shaped portion 684 includes a pair of upwardly extending opposing legs or sides 686, extending a partial distance upwardly, relative to the total height of the support rail 670. A lower base 688 is integral with the lower portion of each of the legs 686 and extends therebetween. A cross beam 690 is parallel to the base 688 and extends between the legs 686 above the base 688. The cross beam 690 is integral with the legs 686. Extending upwardly from the inner portion of the cross beam 690 are a pair of parallel and vertically disposed inner members 692. Positioned at the top of the inner members 692 is an inverted T-mount 694. The inverted T-mount 694 has a central upright 696, with a shelf 698 formed therebelow. All of the elements described herein with respect to the support rail 670 are preferably formed as an integral configuration.

As shown in FIG. 43A, the cross beam 690, vertically disposed member 692 and shelf 698 form a slot 700 extending the length of the support rail 670. Also, as primarily shown in FIGS. 42 and 43B, pairs of upwardly opening visual shield connecting slots 702 are formed in the upper portions of the upwardly extending legs or sides 686. As will be described in subsequent paragraphs herein, the connecting slots 702 will be utilized for purposes of releasably securing visual shields to the support rails 670. Still further, as illustrated primarily in FIGS. 42 and 43C, each of the vertically disposed inner members 692 includes strip connector slots 704. Each of the strip connector slots 704 may be utilized for purposes of assisting in securing an LED strip connector 678 to the corresponding support rail 670.

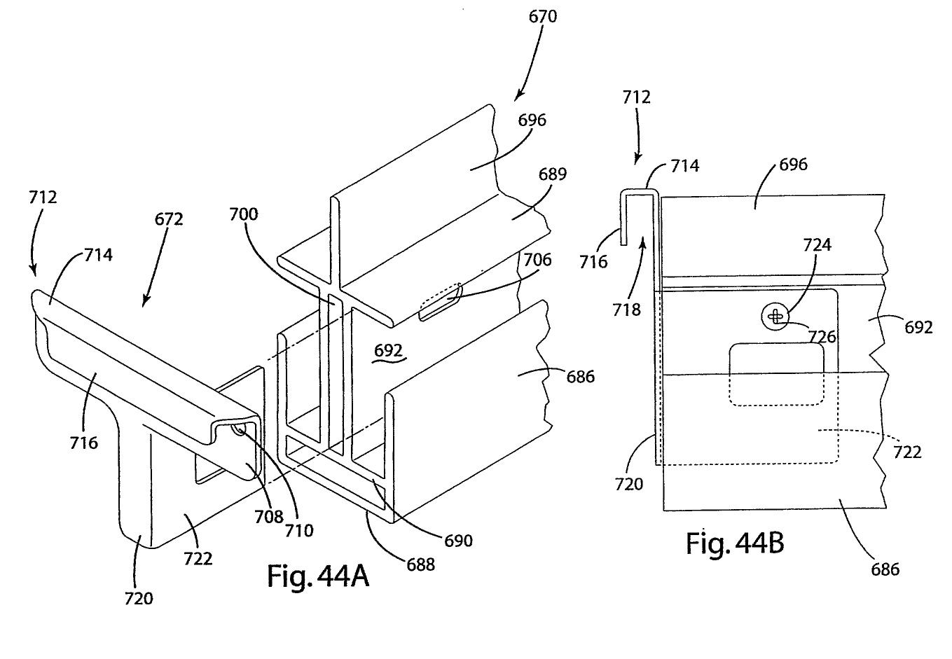

As earlier stated, the LED ladder system 650 in accordance with the invention includes the support rails 670, adapted to interconnect to the main perforated structural channel rails 652. For this interconnection purpose, the LED ladder system 650 includes support rail mounting brackets 672. The mounting brackets 672 will now be described primarily with respect to FIGS. 41, 44A and 44B. In FIGS. 44A and 44B, one end of a support rail 670 is illustrated. Located at the support rail end is a connector slot 706 having a horizontal and elongated configuration. A connector slot 706 will be located at each end of each support rail 670. The connector slot 706 provides a means of adjustably coupling the support rail mounting bracket 672 to the support rail 670, with respect to relative positioning of the bracket 672 to the rail 670. This is for purposes of allowing for tolerances in the actual lengths of the support rail 670 and the distances between spaced apart structural channel rails 652 to which the support rail 670 is to be connected.

The support rail mounting bracket 672 includes an upper vertically disposed central member 708 having a substantially elongated configuration. Through holes 710 project through the upper central member 708 adjacent each end thereof (see FIG. 41). Screws or similar connection means (not shown) may be received within the through holes 710 and within corresponding through holes in a side panel 664 of a main structural channel rail 652. For providing a further securing connection of the support rail 672 of structural channel rails 652, and for purposes of ensuring that shearing loads which may applied to connecting means received through the through holes 710 are minimized, the mounting bracket 672 further comprises a hook-shaped section 712 integral with and located above the central member 708. As shown in FIG. 44B, the hook-shaped section 712 includes an upper horizontal member 714 integral with the central member 708, and further with a downwardly projecting member 716. The members 714 and 716 form a seat 718 opening downwardly. The seat 718 is sized and configured so that it can be secured over the top edge of a side panel 664 of the corresponding structural channel rail 652. With these connections, the mounting bracket 672 is rigidly secured to the structural channel rail 652.

The support rail mounting bracket 672 also includes a downwardly projecting and lower member 720, as primarily shown in FIGS. 44A and 44B. Extending rearwardly from the lower member 720 is a connector flange 722. As shown primarily in FIG. 44B, the connector flange 722 will be positioned at an end of a support rail 670 so that the connector flange 722 is received adjacent the side of one of the vertically disposed inner members 692. The connector flange 722 includes a through hole 724, and is sized and configured so that the through hole 724 can be appropriately positioned relative to the slot 706. Connecting means such as screws 726 may be utilized to then secure the connector flange 722 to the support rail 670. In accordance with the foregoing, the support rail mounting brackets 672 provide a means for securing the support rails 670 to the main perforated structural channel rails 652.

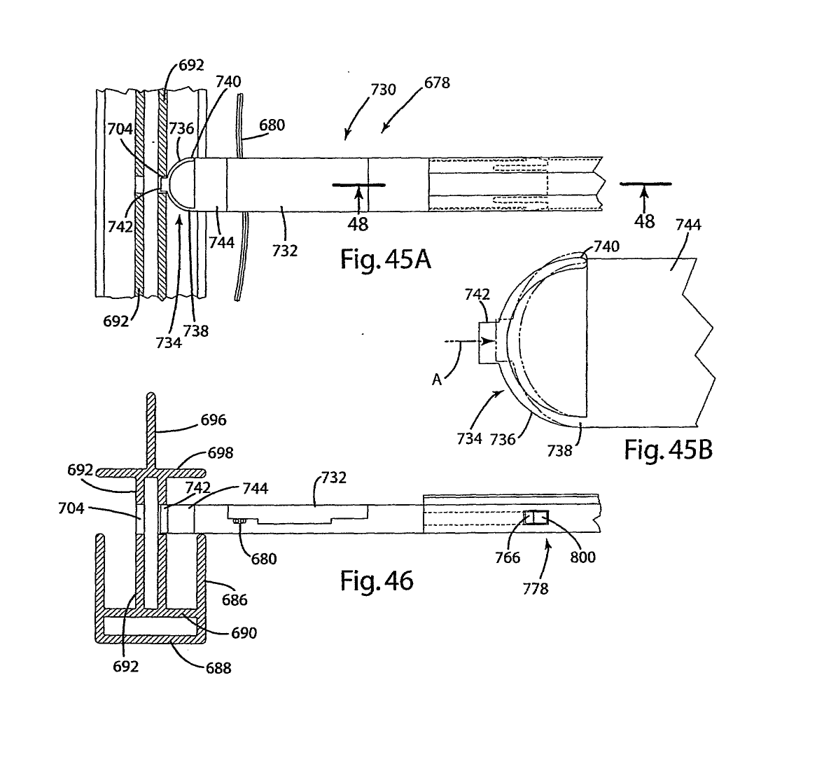

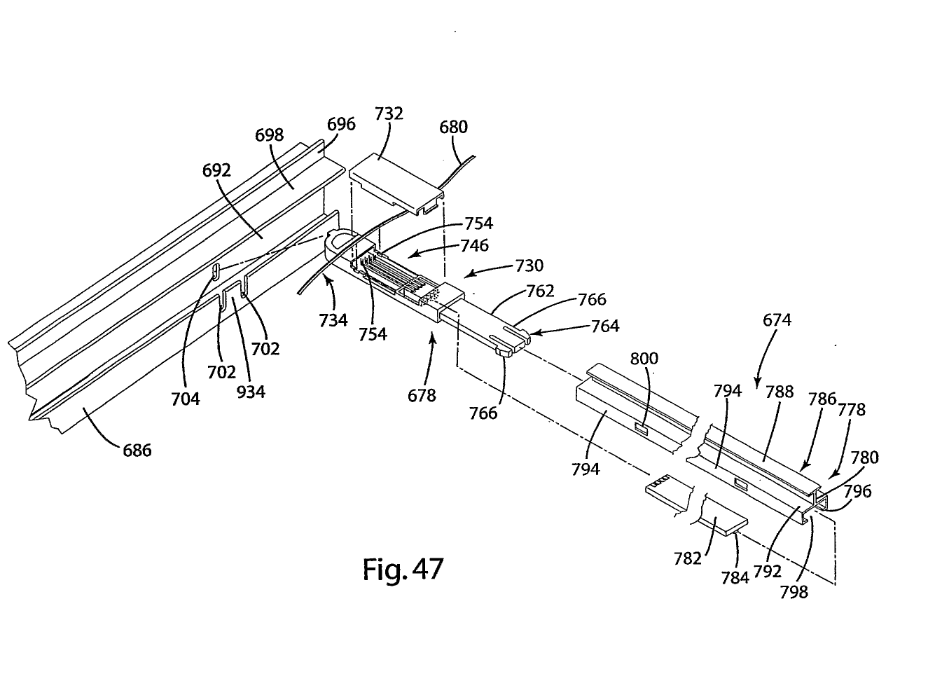

As earlier described, the LED ladder system 650 includes a series of LED strip connectors 678. The LED strip connectors 678 comprise means for releasably securing the LED strip units 674 to spaced apart support rails 670. The LED strip connectors 678 will now be described with respect to FIGS. 42, 45A, 45B, 46, 47, 48 and 66-69. With reference to these drawings, each of the LED strip connectors 678 has an elongated configuration and is formed by an LED clip bus assembly 730 and a clip cap 732 (see FIG. 47). The LED clip bus assembly 730 has one end mechanically and electrically coupled to a corresponding LED strip unit 674. The other or outwardly extending end of the clip bus assembly 730 terminates in what is referred to herein as a resilient rail connector 734. The configuration of the resilient rail connector 734 is illustrated in several of the drawings, including FIGS. 45A and 45B. The resilient rail connector 734 includes an arcuate-shaped head 736, having a plan view configuration as shown in FIGS. 45A and 45B. The arcuate-shaped head 736 forms a substantially semispherical configuration. One end 738 of the head 736 is attached to (and is preferably integral therewith) the body of the resilient rail connector 734. The head 736 further forms a terminal end 740, which is free to move relative to the body 744 of the resilient rail connector 734. As further shown in FIGS. 45A and 45B, an outwardly projecting stud 742 is formed integral with the head 736 and positioned at the central portion thereof. As shown primarily in FIGS. 42, 45A, 45B, 46 and 47, the stud 742 is adapted to be releasably secured within a connector slot 704 of a support rail 670 when the LED strip connector 678 is secured to the support rail 670. The stud 742 should be sized and configured so as to provide for a relatively “snug pressure fit” of the stud 742 in the slot 704. Also, the resilient rail connector 734 will have a resiliency of sufficient force and appropriate direction so as to exert forces on the stud 742 to maintain its securing relationship with the slot 704.

For purposes of releasing the LED strip connector 678 from its secured relationship with the support rail 670, and as specifically shown in FIG. 45B, forces can be directed inwardly (i.e. toward the interconnected LED strip unit 674) on the stud 742 through the slot 704. This is illustrated in FIG. 45B, with the solid line format of the resilient rail connector 734 representing its position when the stud 742 is secured within a slot 704. The arrow A in FIG. 45B shows the direction in which forces may be exerted on the stud 742. With these manually exerted forces, the arcuate-shaped head 736 will essentially “flex,” so that the free terminal end 740 moves outwardly and the stud 742 retracts from its originally secured position within the slot 704. This structure of the head 736 and the corresponding movement of the stud 742 is shown in phantom line format in FIG. 45B. It is in this manner that the LED strip connector 678 and the associated LED strip unit 674 may be removed from the “pressure fit” secured connections to the support rail 670. In accordance with the foregoing, this embodiment in accordance with the invention provides for selective removal of the strip connector 678 and associated strip unit 674 from the support rail 670. In this manner, any requirement for hard-wiring is avoided.

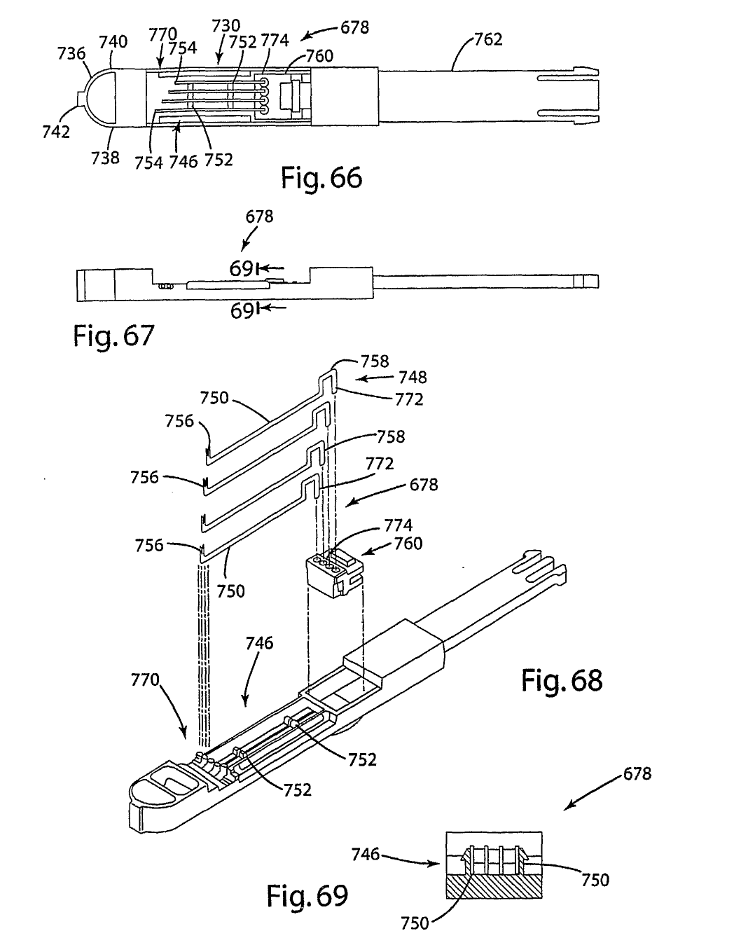

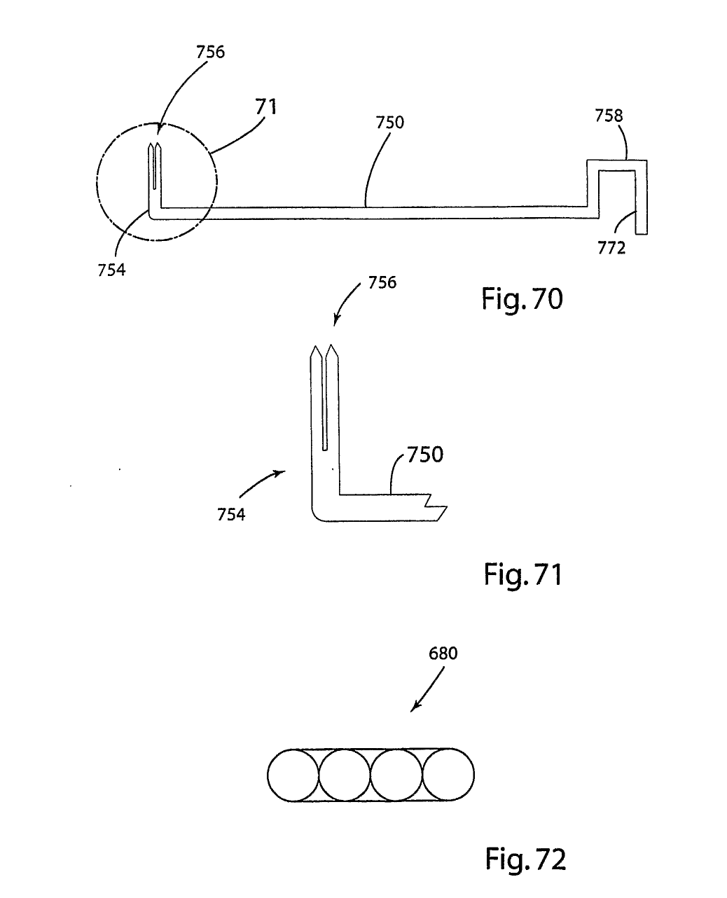

As shown primarily in FIGS. 47, 66 and 68, the LED strip connector 678 further includes a centrally positioned bus channel 746. The bus channel 746 provides an area for electrically connecting one end of a set of buses to the bonded wire ribbon 680, and to further electrically connect other ends of the buses within a connector block for applying power to the LED's associated with the LED strip units 674. As shown in the drawings, a connector bus group 748 comprising a series of four connector buses 750 (see, in particular, FIG. 68) is secured within the bus channel 746, in a manner so that the buses are isolated one from another. For example, the connector buses 750 may be secured within the bus channel 746 through the use of heat stakes 752 or similar known connecting elements. When the connector buses 750 are positioned within the corresponding bus channel 746, the bus ends 754 are positioned within a ribbon interconnection cavity 770 positioned outwardly from the bus channel 746. When the ends 754 are seated within the ribbon interconnection cavity 770, ribbon connector forks 756 formed at the ends 754 are turned upwardly, as primarily shown in FIGS. 70 and 71. Also, the ribbon connector forks 756, as a result of individual ones of the connector buses 750 having slightly different lengths, are longitudinally “staggered” within the cavity 770. This staggered relationship is shown specifically in FIG. 66. With the connector buses 750 appropriately secured within the bus channel 756 and the ribbon interconnection cavity 770, the bonded wire ribbon 680 can be electrically secured to the connector buses 750.

More specifically, the bonded wire ribbon 680 comprises an elongated set of four insulated wires, having a cross section as illustrated in FIG. 72. In this particular embodiment of an LED ladder system 650 in accordance with the invention, a series of four wires is utilized for the bonded wire ribbon 680. However, various numbers of wires (and various wire gauges) may be utilized in other embodiments in accordance with the invention. The bonded wire ribbon 680 provides a means for applying DC power from other components of the LED ladder system 650 to the connector buses 750 and the LED strip units 674. With this configuration, each of the insulated wires of the bonded wire ribbon 680 is slightly separated from the others of the wire conductors and secured to an appropriate one of the ribbon connector forks 756. The fork configuration causes the connector bus 750 to “cut” insulation around a wire conductor, thereby providing for an appropriate conductive connection.

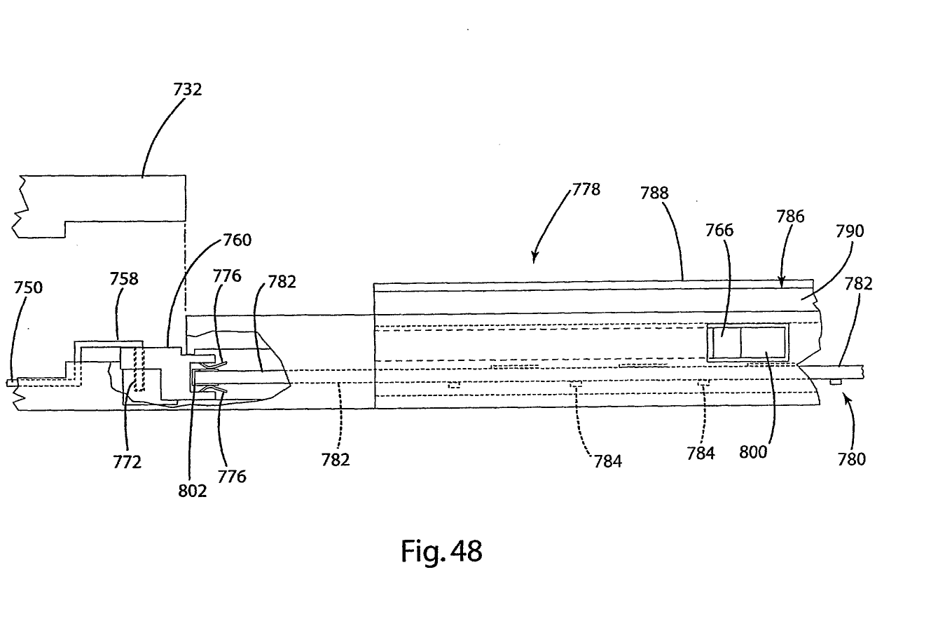

As shown particularly in FIGS. 48, 68 and 70, the opposing ends of the connector buses 750, referred to herein as the bus terminal ends 758, include downwardly projecting legs 772. Each of the downwardly projecting legs 772 is received within a separate one of a set of sockets 774 (see FIGS. 66, 68). The sockets 774 are located within a bus block 760. The bus block 760 is a commercially available component and provides a means for conductive interconnection between the connector buses 750 and terminal clips adapted to be conductively interconnected to an LED strip unit 674. The bus block 760 may, for example, be a part manufactured and sold by Stocko (member of the Wieland Group) of Burgaw, N.C., and identified as Part No. MFMP7238-004-060-450-000-00. Although not specifically shown in the drawings, the bus block 760 includes structure (such as plug pins and the like) which provide for a coupling interconnection between the individual ones of the connector buses 750 and sets of conductive terminals 776, one of which is illustrated in the sectional view of FIG. 48. The conductive terminals 776 are adapted to electrically interconnect two conductors of the LED strip units 674.

As primarily shown in FIGS. 47, 66 and 68, extending outwardly from an end of the LED strip connectors 678 in a direction opposing the resilient rail connector 734 is a structural extension 762. The structural extension 762 provides a means for structurally interconnecting the LED strip connectors 678 to the corresponding LED strip unit 674. As shown in FIG. 47 and other drawings, the structural extension 762 may be secured in any suitable means to (or be integral with) other components of the strip connectors 678. The structural extension 762 terminates in a relatively conventional and resilient connector 764. The connector 764 has a pair of resilient mounting ears 766 extending laterally outwardly on opposing sides of the connector 764. The mounting ears 766 are adapted to be received within slots of an LED strip housing 778 forming part of the LED strip unit 674. The LED strip units 674 further include modular LED strips 780. The modular LED strips 780 are structurally mounted to mounting sticks 782. The modular LED strips 780 each includes a series of spaced apart LED groups 784. The modular LED strips 780 can be any of a number of commercially available LED strips. For example, one type of strip which may be utilized in accordance with the invention is manufactured by Osram and identified as Part No. OS LM01M-RGB.

With reference primarily to FIGS. 41, 47 and 48, the LED strip housing 778 has an elongated configuration. In cross section, the housing 778 includes a T-shaped beam 786, formed of an upper horizontal member 788 and a downwardly projecting center member 790. At the bottom of the center member 790 is a lower horizontal beam 792. The lower horizontal beam 792 extends outwardly from opposing sides of the center member 790. At the edges of the lower horizontal beam 792, a pair of opposing side members 794 depend downwardly therefrom. At the bottom portion of the side members 794, a pair of inwardly directed flanges 796 extend toward each other. The lower horizontal beam 792, side members 794 and flanges 796 form a channel 798, as primarily shown in FIG. 47. The side members 794 also include sets of mounting slots 800 which may be positioned at various locations along the lengths of the side members 794. When the LED strip connector 678 is structurally coupled to the corresponding LED strip unit 674, the resilient ears 766 of the connector 764 flex inwardly when received within the channel 798. This flexion continues to occur until the ears 766 reach a pair of opposing mounting slots 800. The ears 766 then flex outwardly so as to be received within and engage the mounting slots 800. With the particular shape and configuration of the ears 766, it will not be possible to move an LED strip connector 678 relative to the LED strip housing 778, unless the ears 766 extending outwardly from the mounting slots 800 are flexed or depressed inwardly. With an inward flexure, the structural extension 762 can be removed from the channel 798 of the housing 778.

Although not shown in significant detail, FIG. 48 illustrates, in part, the modular LED strips 780. The strips 780 comprises a series of spaced apart LED groups 784. The LED groups 784 may comprise only one LED per group or, alternatively, a series of LEDs. For example, for purposes of providing for variations in color, texture and other properties, each of the LED groups 784 may comprise a series of three LEDs, with the primary colors emanating from the individual LEDs when powered representing color substantially separated across the frequency spectrum. The modular LED strip 780, comprising the LED group 784, may be mounted to the LED mounting stick 782, also shown in FIGS. 47 and 48. In this particular embodiment, as shown in FIG. 48, the modular LED strip 780 is mounted to the bottom of the LED mounting stick 782. Although not specifically shown in the drawings, the LED groups 784 are electrically connected together so as to form the modular LED strip 780, and are also conductively connected to metallic conductors 802 positioned at least one end of the mounting stick 782, as expressly shown in FIG. 48. In turn, the metallic conductors 802 are conductively connected to the previously described conductive terminals 776. With the previously described conductive interconnections of other components to the conductive terminal 776, the LED groups 784 of the modular LED strip 780 are electrically connected to the wire conductors associated with the bonded wire ribbon 680. Accordingly, DC power can be applied from the insulated wires 804 to the individual LED groups 784 of the modular LED strip 780.

In addition to the foregoing description, other components may be relevant to use of the LED ladder system 650. For example, as will be described subsequently herein, dimmer components can be utilized with the LED ladder system 650, so as to apply various voltage amplitudes to the LEDs associated with the LED groups 784. In this manner, light intensity can readily be varied. Also, the “spatial density” of the LED group 784 may also be varied, dependent upon the spacing of the LED groups along the modular LED strip 784. Correspondingly, with respect to each of the LED ladder panels 668, the spacing between adjacent LED strip units 674 can also be varied. In addition, the number of LED strip units 674 associated with each LED ladder panel 668 can be modified.

With the coupling of the bonded wire ribbon 680 to the LED strip connectors 678 for purposes of applying power to the strip units 674, only one ribbon 680 need be utilized for any given LED ladder panel 668. That is, and as primarily shown in FIG. 39, the bonded wire ribbon 680 may be connected to those LED strip connectors 678 only on one side of a ladder panel 668.

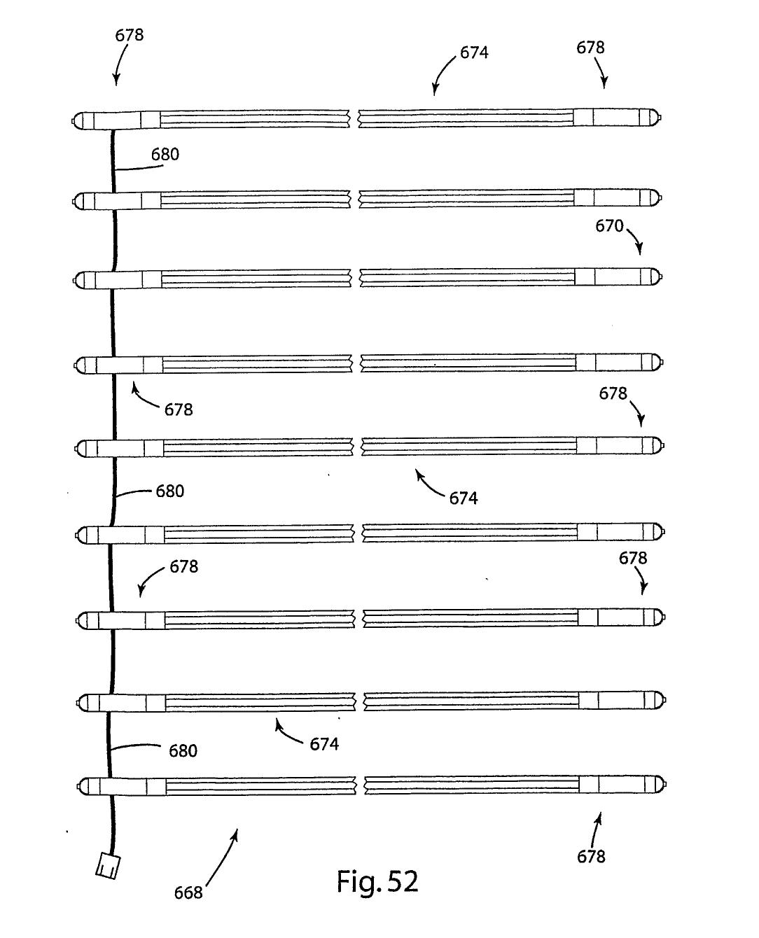

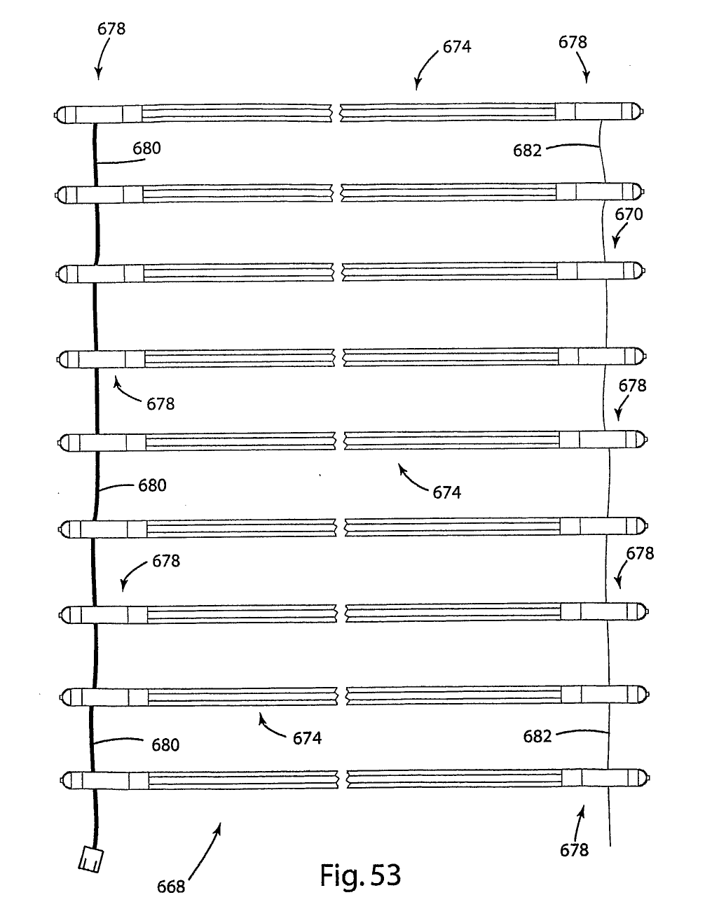

On the other hand, however, when the LED ladder panels 668 are being installed on the support rail 670, one end of each of the LED strip units 674 will be free to move independently of any of the other strip units 674. This concept of having one end of each of the LED strip units 674 being free is illustrated in FIG. 52. However, for purposes of facilitating installation (and possibly packaging and shipping), it may be worthwhile to couple together the free ends of the LED strip units 674. In this regard, a “tether”, “dummy” bonded wire ribbon or similar elongated connected element could be utilized to couple free ends of adjacent ones of the LED strip units 674. For example, FIG. 53 illustrates an LED ladder panel 668, similar to the configuration shown in FIG. 52, but with a “spacer wire” 682 coupled to the ends on one side of the LED strip units 674. The spacer wire 682 may be secured within the LED clip bus assemblies 730 of the LED strip connectors 678 associated with the free ends of the strip unit 674.

Also, for purposes of maintaining rigidity and tolerances, it may be worthwhile to consider using other structural elements. For example, if it is desired that the spaced apart distances between adjacent ones of the support rails 670 are maintained within relatively small tolerances, it would be possible to secure elements such as “cross wires” (not shown) between adjacent ones of the support rails 672, at spaced apart distances along the lengths of the support rails 672. Such cross wires could, for example be relatively rigid in structure and be releasably secured at opposing ends within, for example, the visual shield connecting slots 702 along the support rails 670.

The foregoing discussion was primarily directed to structural concepts associated with the LED ladder system 650. The concept of utilizing multiple LEDs within LED groups 784 was also discussed. In this regard, the individual LEDs of any given LED group 784 may advantageously generate colors or hues substantially separated across the frequency spectrum. The subsequent description herein is directed to means for control of the LED groups 780, not only with respect to enablement and disablement, but also with respect to variations in voltage inputs so as to provide for dimming functions.

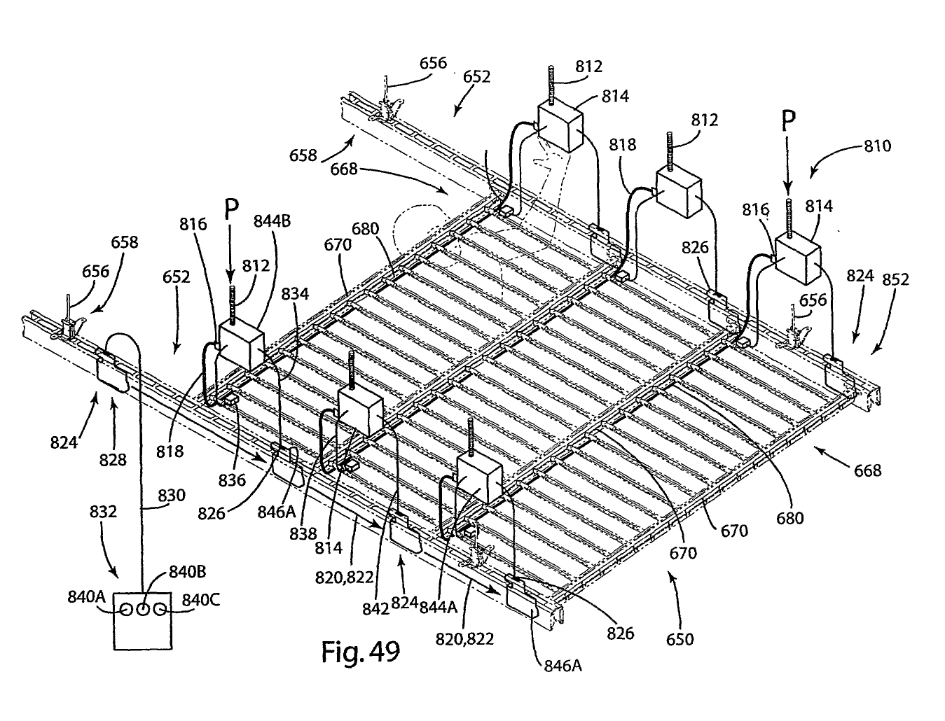

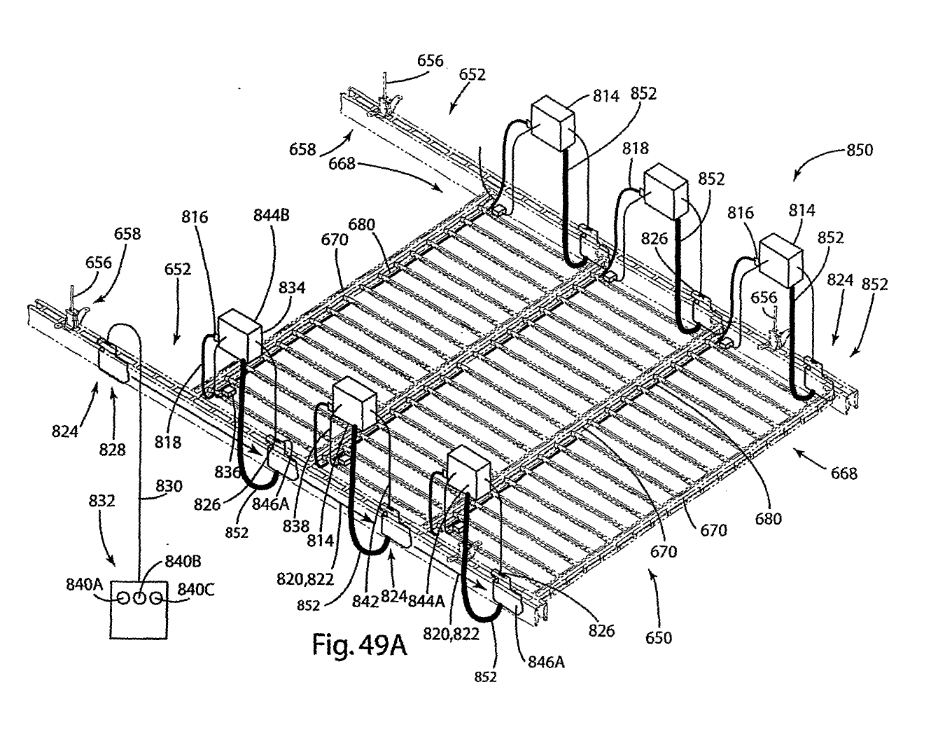

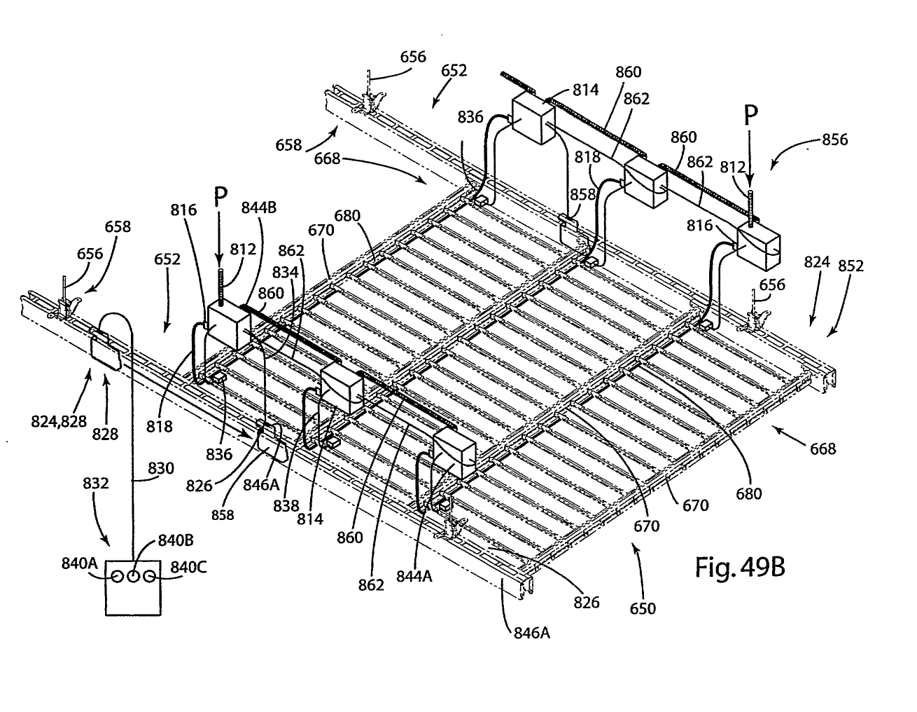

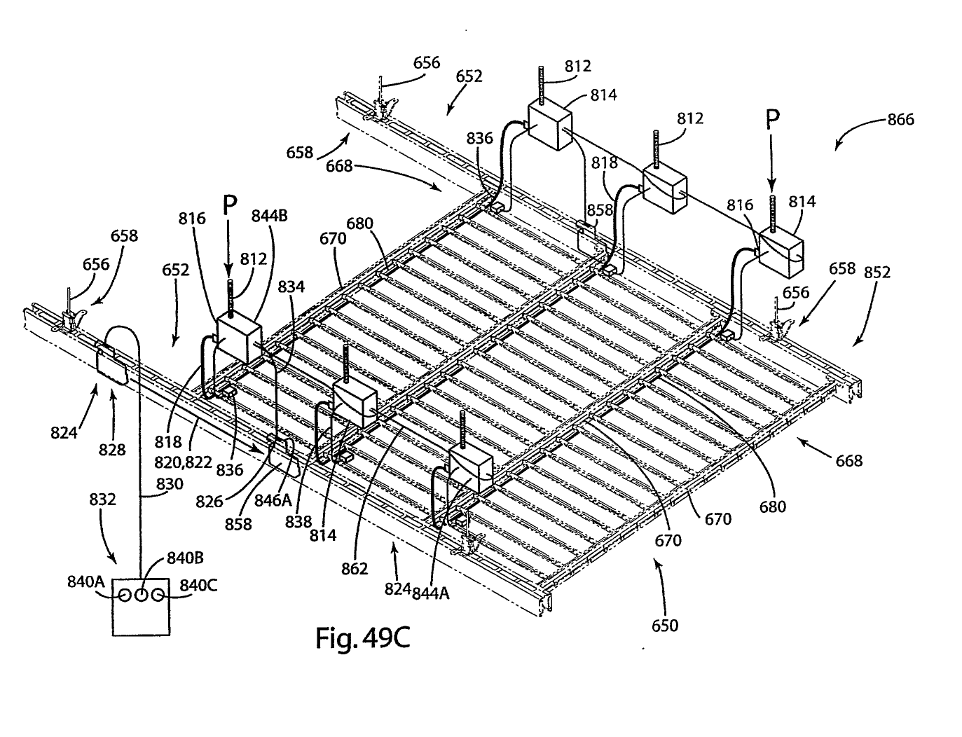

Control of lighting with respect to the visual shield configurations 100 was provided through the use of a network and a manually operated control wand 560. These concepts were previously discussed herein with respect to FIGS. 33-38. The control of the LED ladder system 650 will now be described not only with respect to control of LED lighting as previously described herein, but also with respect to a distributed power and communications network as expressly described in the channel system application. Referring to FIG. 49, the main perforated structural channel rails 652 correspond to the rails 102 described and illustrated in the channel system application. The structural channel rails 652 shown in FIG. 49 are made to carry both AC power signals and communication signals. The communication signals are carried on wires extending through modular assemblies within the rail 652. These communication signals are carried in what can be characterized as a distributed and “intelligent” network. For providing continuity of the communications network, communication signals passing through wires or other conductors within one of the structural channel rails 652 illustrated in FIG. 49 would also be typically carried within all of the other rails 652 associated with the structural network within which the LED ladder system 650 is implemented.

With the disclosure of the channel system application in mind, FIG. 49 illustrates a particular network connection configuration 810. The network connection configuration 810 comprises means for: supplying DC power to the LED ladder system 650; supplying the DC power with desired variations in voltages, so that the LED groups 784 can exhibit dimming properties; permitting a user to program desired control relationships between the LED ladder panels 668 and controlling devices; obtaining incoming AC building power from alternative means; permitting various scenarios of control/controlling relationships between sensors (in the form of switches) and the LED ladder panels 668; and providing the capability of modifying control/controlling relationships involving sensors and LED ladder panels 668, without requiring physical rewiring, structure relocation or similar functions.

Turning specifically to FIG. 49, the LED ladder system 650 is illustrated. FIG. 49 further shows a set of six LED ladder panels 668, with three pairs of panels 668 extending between adjacent ones of support rails 670. The connection configuration 810 includes a series of six transformer/dimmer electronics units 814. Each of the electronics units 814 is associated with one of the LED ladder panels 668. Each electronics unit 814, although not shown in detail, can be characterized as a “smart” connector module, in that it includes processing circuitry responsive to external communications signals for controlling DC power applied to the LED strip units 674, including when such power is applied and the amplitudes thereof. The electronics unit 814 further includes transformer circuits, for purposes of converting incoming AC power to appropriate low voltage DC power. Although not shown in the drawings, the electronics unit 814 also includes circuitry responsive to incoming or internal communications signals, and further responsive to DC power generated by the transformer, so as to apply a dimmer function to the DC power as it is applied as output power to the LED strip units 674.

More specifically, and again with respect to FIG. 49, each of the electronics units 814 is shown as having an incoming power conduit 812. Each of the incoming power conduits 812 is adapted to receive incoming AC building power, identified as Power P in FIG. 49. The actual building supply power and its interconnection to the incoming power conduits 812 are not shown in the drawings. As earlier stated, the incoming building power on conduits 812 can be applied as input AC power on the incoming side of a transformer within the electronics unit 814. With the appropriate transformer (which is commercially available), the incoming AC building power can be converted and dropped down to relatively low voltage DC power. The DC power can then be applied as input power to commercially available dimmer circuits within electronics unit 814. The dimmer circuits are responsive to the DC power and to communications signals in the form of applied control signals, so as to modify the actual levels of DC power applied as output power from the electronics unit 814. If, for example, the LED groups 784 of an LED strip unit 674 include a series of three differently colored LEDs, the electronics unit 814 will then preferably include three dimmer control circuits, one for each of the LEDs within a LED group 784. It should be mentioned that like LEDs associated with individual ones of the LED group 784 for any given modular LED strip 780 would preferably be electrically connected together. For example, if each of the LED groups 784 associated with one modular LED strip 780 included an LED generating red light, it is likely that all of the red LEDs associated with the individual LED groups 784 would be electrically coupled together. In this manner, voltage amplitude applied to any one of the given red LEDs would also be applied to the red LEDs within the remainder of the LED group 784.

For purposes of description, the DC power generated as output power from each of the electronics units 814, and as modified by the dimmer circuits, will be referred to herein as the “modified applied DC power” or “modified DC power.” This modified DC power is applied as output power from the electronics unit 814 to a DC power cable 818, through a conventional electrical connector 816. As further shown in FIG. 49, the modified DC power on DC power cable 818 may then be applied to the previously described bonded wire ribbon 680 associated with the corresponding LED ladder panel 668. Any type of suitable electrical connector may be utilized to electrically connect the DC power cable 818 to one end of the bonded wire ribbon 680. However, if desired, an appropriate connector may be coupled directly to the bonded wire ribbon 680, and the ribbon 680 directly connected to the electronics unit 814 through the connector 816. In any event, it is in this manner that modified DC power can be applied to the individual LED groups 784 associated with any given LED strip unit 674.

As earlier stated, the network connection configuration 810 is operating with the LED ladder system 650 within a distributed power and communications network, such as that described in the channel system application. Accordingly, each of the main perforated structural channel rails 652 includes structure which provides for the transmittal through the rail 652 of AC power. Such AC power can be generated on the rails 652 through other circuit means (not shown) utilized to connect incoming AC building power directly to cables running through the rails 652. Correspondingly, as earlier mentioned, the same rails 652 will carry communication signals. Preferably, the structure of the distribution network will incorporate means for coupling communications cables associated with one rail 652 to other rails 652 within the network. Means for achieving such coupling, and for applying communication signals to cables running through the rails 652 are described in the channel system application. The concept of AC power running through the rails 652 is shown by the arrows labeled 820 in FIG. 49. Correspondingly, the arrows are also labeled 822, representing the concept that communication signals are also being transmitted through separate communications cables in the rails 652.

To utilize AC power being transmitted through the rails 652 for components of a network configuration for use with the LED ladder system 650, and for use with other application devices, means are required for “tapping off” the AC power from the AC power cables running through the rails 652. Also, to provide for a viable communications network, means are required for receiving and applying programming and communication signals from and to the communications cables 822, respectively. With a distributed power and communications network as described in the channel system application, and as used with the network configuration 810, not only can electrical power be provided to devices such as LEDs, but communication signals may also be provided on the communications network and be utilized to control and reconfigure control among the various LED ladder panels 668 and controlling devices such as switches and the like. In fact, and as described in the copending International Patent Application No. PCT/JUS03/12210, entitled “SWITCHING/LIGHTING CORRELATION SYSTEM” and filed Apr. 18, 2003, control relationships between switches and lighting units may be reconfigured in a “real time” fashion. For all of these purposes, the connector modules 824 can be utilized. The connector modules can include DC power generation, processor means and associated circuitry, responsive to communication signals on the communications cables 822 and as received from controlling devices, so as to appropriately control lighting associated with the LED ladder panels 668. This control will occur in response to communication signals received from other application devices, such as controlling switches. The channel system described in the channel system application provides a means for distributing requisite power and for providing a distributed intelligence system for transmitting and receiving these communication signals in a manner which is readily useable by the network configuration 810.

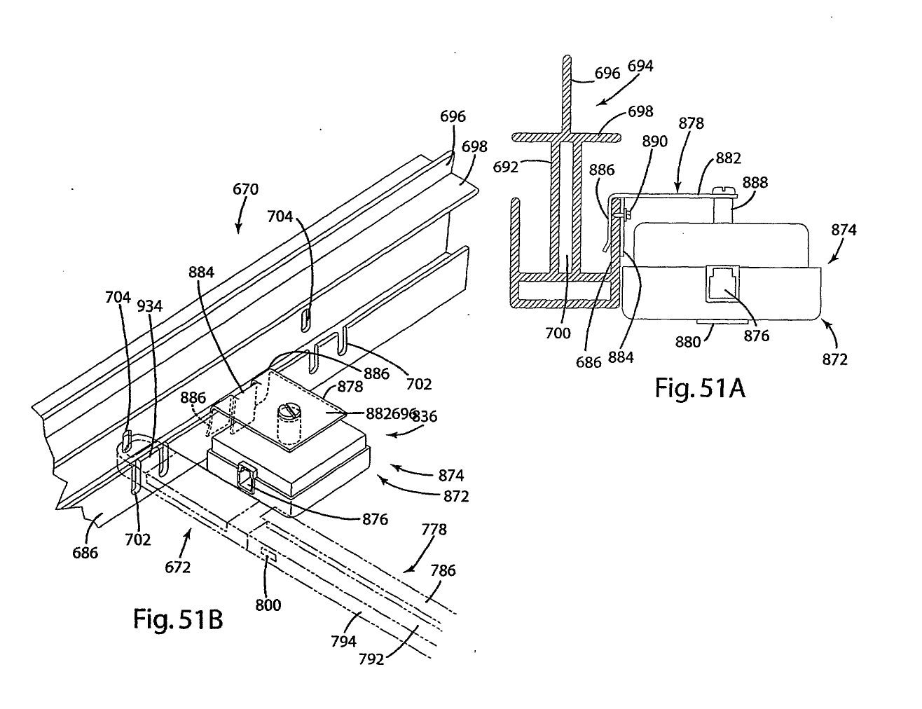

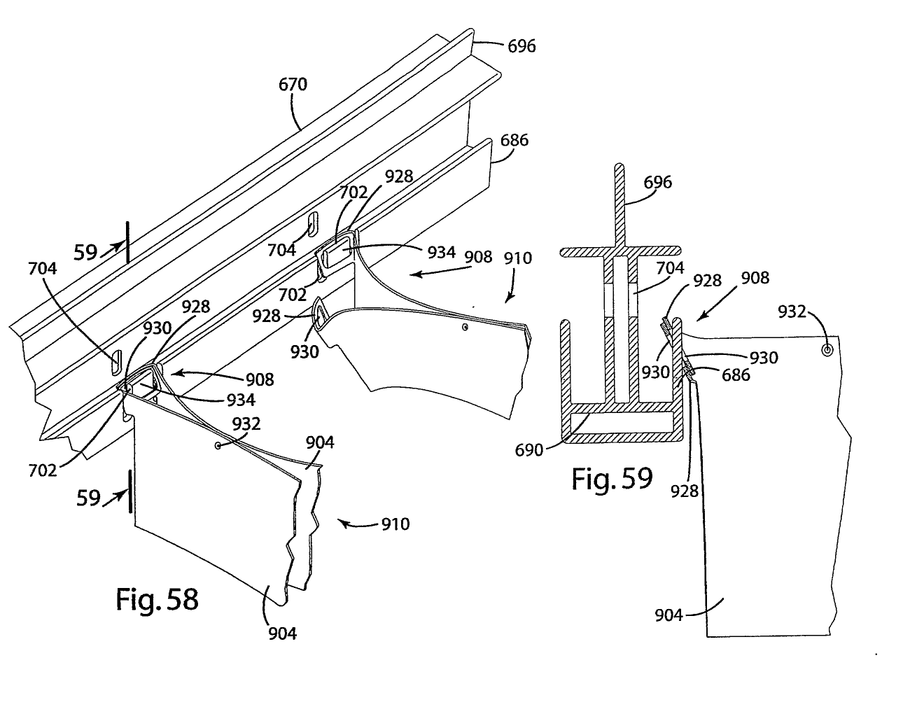

Each of the connector modules 824 may correspond to any one of a number of connector modules described in the channel system application. For example, the connector module 824 may correspond to what is referred to in the channel system application as a receptacle connector module 144. The receptacle connector module 144 is described in the channel system application with respect to FIGS. 51-58A. Each of the connector modules 824 may be coupled to electrical assemblies (not shown) secured to the structural rails 652. These electrical assemblies carry the actual AC power cables 820 and communications cables 822. Although not specifically shown in FIG. 49, each of the receptacle connector modules 824 can include a conventional 3-prong, AC receptacle on the bottom surface thereof. As described in detail in the channel system application, the AC receptacle may be electrically connected to the AC power cables 820 running through the interconnected rails 652 through an appropriate type of plug means (not shown). Such configurations are described and illustrated in the channel system application with respect to elements described therein as modular plug assemblies 130 and receptacle connector modules 144. However, rather than having a direct electrical connection between the AC power cables 820 and the AC receptacle for each receptacle connector module 824, the AC power path is directed through a relay (not shown), substantially corresponding to the receptacle relay 918 described in the channel system application with respect to FIG. 58A. The operation of the receptacle relay, so as to apply AC power from the AC power cable 820 to the electrical receptacle of the receptacle connector module 824, is determined by internal processor circuitry within the connector module 824 and is also based on communication signals received from interconnected application devices and from the communications cables 822 running through the rails 652.

FIG. 49 expressly shows the interconnection of a specific one of the connector modules 824 (identified in FIG. 49 as specific connector module 828) coupled through a patch chord 830 to what is shown as a “three-circuit” or “three-channel” dimmer switch assembly 832. In some of the paragraphs subsequently set forth herein, reference will be made to the switch assembly 832 as a “3-circuit” switch assembly. However, the use of the term “circuit” should not be construed as implying generation of electrical power. Instead, the switch assembly 832 is more in the form of a “3-channel” switch assembly. The patch cord 830 can be a conventional patch cord, connected to one of the connector ports 826 associated with the specific connector module 828. The connector ports 826 can be conventional in nature, and may correspond, for example, to an RJ45 port. Correspondingly, although not shown in FIG. 49, the three-channel dimmer switch assembly 832 may also include a connector port for interconnection of the other end of the patch cord 830 to the assembly 832. In part, the three-channel dimmer switch assembly 832 can be conventional in nature, and comprise a series of three rotary dials 840A, 840B, and 840C. Each dial can be made, through programming and communications as described in subsequent paragraphs herein, to control the level of DC voltage applied as output power from one or more of the electronics units 814, with the output power levels applied to different LEDs within LED groups 784. For example, operation of rotary dial 840A may cause all of the red light LEDs associated with one of the LED ladder panels 668 to be controlled with respect to light intensity through modifications in DC voltage application.

As described in the channel system application, the communications network is configured so as to permit the three-channel dimmer switch assembly 832 to control activities associated with the specific connector module 828. That is, the patch cord 830, in combination with its connection to a connector port 826 of the specific connector module 828, provides a means for supplying DC power to the three-channel dimmer switch assembly 832, and also for coupling the switch assembly 832 to the electrical and communications network. Although the dimmer switch assembly 832 is coupled into the network through the specific connector module 828, the switch assembly 832 may be operating so as to control any one or more of the LED ladder panels 668, independent of their location relative to the specific connector module 828. In this regard, the connector ports 826 can be characterized as providing a “network tap” for the interconnection of the switch assembly 832 to the communications and power network. In the network configuration 810, the three-channel dimmer switch assembly 832 will be programmed so as to control one or more of the electronics units 814, thereby controlling DC power applied to the LED ladder panels 668 associated with the controlled electronics units 814.

For purposes of initially “programming” a “controlling/controlled” relationship between the three-channel dimmer switch assembly 832 and one or more of the LED ladder panels 668, an IR receiver 836 is associated with each one of the electronics units 814. Each IR receiver 836 is conventional in nature and adapted to generate electrical signals in response to spatially received IR signals. The electrical signals generated by the IR receiver 836 are applied as output signals on patch cord 838. These output signals, in turn, are applied as input signals to the associated electronics units 814. These received signals will be utilized by the processor circuitry within the electronics units 814 so as to determine to which incoming communications signals the specific electronics unit 814 should be responsive, for purposes of control of modified voltages applied to the associated LED ladder panel 668. For this purpose, it is necessary that the electronics unit 814 also be coupled to the communications network and the associated communications cables 822. For this purpose, each of the electronics units 814 is connected to a connector module 824 on the communications network through a conventional patch cord 834. The patch cord 834 is connected to one of the connector ports 826 of the associated connector module 824, and to another connector port or similar connecting means (not shown) within the electronics unit 814. Signals received by the electronics unit 814 from the communications network through patch cords 842 and interconnected connector modules 824 will be utilized by the electronic unit 814 to determine when and what voltage levels should be applied to the LEDs of the LED groups 784 associated with the corresponding LED ladder panel 668. For purposes of programming, although not shown in FIG. 49, a corresponding IR receiver 836 may be coupled to the three-circuit dimmer switch assembly 832. With this IR receiver, signals can be applied to the dimmer switch assembly 832 so as to appropriately “program” the dimmer switch assembly 832 to generate communication signals indicative of which of the electronics units 814 should respond to these signals. Concepts associated with the programming of application devices is described in detail in the channel system application.

As an example of the type of programming and control which may be utilized with the network configuration 810, it can be assumed that it is a user's desire to employ the dimmer switch assembly 832 so as to control the LEDs associated with the LED groups 784 for the LED ladder panel 668 under control of the electronics unit 814 identified also as electronics unit 844A. Assume that the same control is to be applied to the LED ladder panel 668 associated with the electronics unit 814 identified further as unit 844B. In this instance, the user may apply spatial programming signals to the IR receivers 836 associated with the electronics units 844A and 844B. As earlier described, such programming signals can be generated through the use of the wand 560 previously described with respect to FIGS. 36-38. Programming signals can also be applied to the IR receiver (not shown) associated with the dimmer switch assembly 832. These signals will be utilized by the communications network so as to cause the electronics units 844A and 844B to be under the control of the dimmer switch assembly 832. This concept can be characterized as “assigning” the dimmer switch assembly 832 as a control for the electronics units 844A and 844B. It should be noted, as shown in FIG. 49, that the control signals which will be applied to these electronics units will be received through connector modules 846A and 846B, respectively, with the signals being transmitted through patch cords 834. This programming control can also be characterized as utilizing the concept that spatial signals (from the wand 560) can be transmitted to the dimmer switch assemblies 844A and 844B, and associated connector modules 846A and 846B, which essentially “announce” to the communications network that these modules are available to be controlled. The wand 560 is then utilized to transmit other spatial IR signals to the dimmer switch assembly 832 which would then be “assigned” as a control for the particular modules.

It can now be assumed that the user operates one or more of the rotary dials 840A, 840B and/or 840C of the dimmer switch assembly 832, for purposes of controlling the LEDs of the ladder panels 668 associated with the switch assemblies 844A and 844B. Signals indicating this activity by the user will be transmitted through the patch cord 830 from the dimmer switch assembly 832 to the communications network. Again, it should be noted that the signals are transmitted to the communications network from the patch cord 830 to the interconnected specific connector module 828 which, in turn, is electrically connected to communication cables running through the rails 652. The manipulation of the dimmer switch assembly 832 will then also cause communication signals, in the form of control signals, to be transmitted to the dimmer switch assemblies 844A and 844B through connector modules 846A and 846B, respectively. The communication signals will have appropriate data so that the specific dimmer switch assemblies 844A and 844B will recognize that these signals are to be utilized to appropriately control the associated LED ladder panels 668. These control signals will include sufficient data so as to indicate not only that the switch assemblies 844A and 844B should transmit voltage signals to the interconnected LED ladder panels 668 in response to the communication signals, but also the particular voltage levels which should be transmitted on the DC power cables 818. In accordance with the foregoing, the network connection configuration 810 represents one embodiment of a configuration for controlling the LED ladder panel 668 through the use of a distributed network and a controlling application device.

FIG. 49A illustrates a second embodiment of a network connection configuration, having substantial similarities to the network connection configuration 810. The network connection configuration illustrated in FIG. 49A is identified as network connection configuration 850. The network connection configuration 850 comprises a layout similar to configuration 810 and, for that reason, like reference numerals are utilized to identify comparable elements of the configurations 810 and 850. The primary distinction between these two particular configurations relates to the manner in which AC power is applied as input power to the electronics units 814.

More specifically, with reference to connection configuration 810 in FIG. 49, incoming building power is received separate and apart from the AC power cables running through the main rails 652. Instead, the power is applied directly to the electronics unit 814 from the incoming power conduits 812.

In contrast, network connection configuration 850 takes advantage of the AC power running through the main rail 652. As earlier described, the connector modules 824 illustrated in FIG. 49 may be receptacle connector modules, corresponding to receptacle connector modules 144 described in the channel system application. Accordingly, these receptacle connector modules 824 include AC receptacles (not shown) located at the lower portions or undersides of each of the connector modules 824. Communication signals received by the receptacle connector modules 824 through the communications network and communications cables running through the rails 652 can be utilized to control the receptacle relays previously described herein, so as to enable or disable the application of AC power through the AC power cables 852. These AC power cables 852 are, in turn, electrically connected to individual ones of the electronics units 814. It is in this manner that each of the electronics units 814 will receive AC power, as required for generating appropriate DC power levels for operation of the LED ladder panel 668.

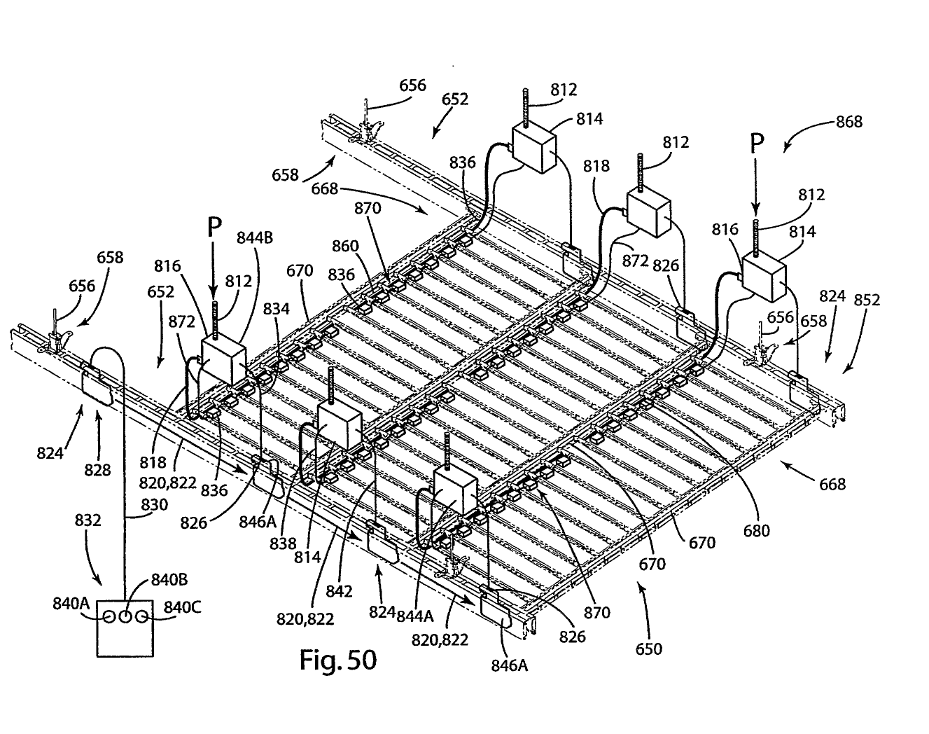

A further embodiment of a network connection configuration which may be utilized in accordance with the invention is illustrated and identified as network connection configuration 856 in FIG. 49B. Again, substantial similarity exists with respect to the configurations illustrated in FIGS. 49 and 49B. Accordingly, like reference numerals will be utilized for comparable elements. This will also be true with respect to the connection configurations illustrated in FIGS. 49C and 50, described in subsequent paragraphs herein.

Like the configuration 810 shown in FIG. 49, the connection configuration 856 applies incoming building power directly to the units 814 through incoming power conduits 812. However, as shown in FIG. 49B, this incoming building power is only applied through power conduits 812 directly into unit 814 associated with each of the structural channel rails 652. To apply incoming AC power to others of the units 814, connector AC power conduits 860 are utilized. The connector AC power conduits 860 can electrically interconnect the electronics units 814 in what can be characterized as a “daisy chain” configuration. Accordingly, with the use of the connector AC power conduits 860, incoming AC power applied through power conduit 812 from the building into one of the electronics units 814 is further applied through one or more (as desired) other electronics units 814 associated with the same structural channel rail 652. This type of daisy chaining configuration presents certain advantages in accordance with the invention, in that the number of requisite incoming power conduits 812 from the building is substantially reduced.

Still further, and also in accordance with the invention, the network connection configuration 856 uses only one connector module (identified as connector module 858) for transmission of communication signals (including programming and desired power level signals) to the electronics units 814 associated with a particular structural channel rail 652. As shown in FIG. 49B, each of the connector modules 858 is electrically connected to one unit 814 through patch cord 834. However, the communication signals transmitted through patch cord 834 can be further transmitted to other electronics units 814 (associated with the same structural channel rail 652) through the use of a series of connector patch cords 862. The connector patch cords 862 provide a means for “daisy chaining” the interconnected electronics units 814 to the communications network. This configuration is advantageous in that it requires only one connector module 858 to be directly interconnected to the electronics units 814 associated with a corresponding structural channel rail 652.

FIG. 49C illustrates a still further embodiment of a network connection configuration in accordance with the invention. This configuration is identified as network connection configuration 866. The connection configuration 866 is similar to the network configuration 856 described with respect to FIG. 49B, in that the electronics units 814 associated with a structural channel rail 652 are “daisy chained” into the communications network through the use of connector patch cords 862 and only a single connector receptacle 858. However, network connection configuration 856 also included the daisy chaining of AC power inputs directly from building power supplies. In contrast, network connection configuration 866 receives power for the individual electronics units 814 in the same manner as occurs in the network connection configuration 810 described with respect to FIG. 49. That is, each individual electronics unit 814 receives AC building power directly through incoming power conduits 812. This is in contrast to connection configuration 856 shown in FIG. 49B, where AC building power is daisy chained across electronics units 814 associated with a structural channel rail 652.

Yet another embodiment of a network connection configuration in accordance with the invention is illustrated in FIG. 50, and identified as connection configuration 868. This particular configuration 868 is substantially similar to the connection configuration 810 shown in FIG. 49. However, in the connection configuration 810, only one IR receiver 836 is associated with each of the LED ladder panels 668. In contrast, connection configuration 868 utilizes a series of what can be characterized as “remote” IR receiver linkages 870, associated with each electronics unit 814 and with each LED ladder panel 668. As further shown in FIG. 50, each remote IR receiver linkage 870 includes a series of IR receivers 836. Transmission of spatial IR signals to any one of the IR receivers 836 associated with a particular remote IR receiver linkage 870 will be communicated to the interconnected electronics unit 814 through an end patch cord 872. This concept of utilizing multiple IR receivers 836 within a remote IR receiver linkage 870 facilitates the capability of a user (at floor level) transmitting signals to an appropriate one of the LED ladder panels 668, for purposes of programming control of the panel 668.

It should be noted that each of the network connection configurations described herein appears to have advantages and disadvantages relative to the other network connection configurations. However, from the concept of a possible preferred embodiment, the configurations 856 and 866 illustrated in FIGS. 49B and 49C, respectively, may be preferred, in that they utilize only one connector module for the LED ladder panels 668 associated with a structural rail 652. Still further, network connection configuration 856 may be preferable over the connection configuration 866, in that configuration 856 only requires one input power conduit 812 from the building power supply, for a set of electronics units 814 associated with one rail 652. Also, the network connection configurations illustrated and described herein have been shown with only one 3-channel switch assembly 832. It should be emphasized that network connection configurations in accordance with the invention can be utilized with multiple switch assemblies 832, or with other types of controlling devices for purposes of providing user control to the network connection configurations and elements associated therewith. In this regard, any of the network connection configurations described herein may be used with multiple switch assemblies. Further, various switch assemblies may be “daisy-chained” into the network connection configurations. Also, switch configurations using any number or type of knobs or other control elements may be utilized.

Each of the network connection configurations illustrated in FIGS. 49, 49A, 49B, 49C and 50 utilize a number of IR receivers 836. It is advantageous to provide for a convenient means to mount the IR receivers 836 where required within the structures of the network configurations. Although not shown in detail in any of FIGS. 49-50, the IR receivers 836 (including those within the series of IR receivers of the remote IR receiver linkage 870) can be readily mounted to structural channels 670 through the use of an IR mounting assembly 872 as illustrated in FIGS. 51A and 51B. These drawings illustrate only one of the IR receivers 836. However, it is apparent that a number of IR receivers 836 may be mounted to the support rail 670 at various locations along the support rail. With reference to the drawings, the IR mounting assembly 872, including the IR receiver 836, includes an IR housing 874. The housing 874 covers various internal circuitry associated with the IR receiver 836. The circuitry is relatively well known and commercially available. The actual IR receiver is not shown in either FIG. 51A or 51B, but its position is represented by the IR lens 880 illustrated in FIG. 51A. The actual IR receiver will be located at the bottom of the IR housing 874, and will be covered by the IR lens 880. If desired, the IR receiver 836 may also include an LED or similar light (not shown) at the bottom of the housing 874 or elsewhere in a location visible to a user below the receiver 836. Such light may be utilized for indicating to a user transmitting spatial IR signals to the receiver 836 that these signals are, in fact, being received.

Extending outwardly from one side of the housing 874 is a connector port 876. The connector port 876 may be a conventional RJ45 connector port, and is adapted to receive patch cords, such as the patch cords 838 illustrated in FIG. 49. Preferably, the IR receiver 836 will include a pair of connector ports 876 (on opposing sides of the housing 874), for purposes of coupling an IR receiver 836 not only directly to an electronics unit 814, but also to adjacent IR receivers 836 when used in a remote IR receiver linkage 870 or other type of daisy chain configuration.

The IR mounting assembly 872 also includes an IR mounting bracket 878 which is located substantially above the housing 874. The IR mounting bracket 878 includes a horizontally disposed base 882. Connected to or otherwise integral with the horizontal base 882 on one side thereof is an inner flange 884 which depends downwardly from one side of the base 882. When the IR mounting assembly 872 is mounted to a support rail 670, the inner flange 884 is positioned flush against an exterior side of one of the upwardly extending legs 686 of the support rail 670. The mounting assembly 872 further includes a pair of outer flanges 886, also connected to or otherwise integral with the base 882 and depending downwardly therefrom on the same side of the base as the inner flange 884. However, the outer flanges 886 are positioned at opposing sides of the inner flange 884. For purposes of mounting the assembly 872 to the support rail 670, the outer flanges 886 are positioned on an interior side of an upwardly extending leg 686 of support rail 670. To then secure the mounting assembly 872 to the support rail 670, and reduce cantilever forces exerted on the flanges 884, 886, a cutting screw 890 or similar connecting means can connect the inner flange 884 to the upwardly extending leg 686. To then mount the housing 874 to the mounting bracket 878, a holding screw 888 can be received through an aperture extending through the base 882 and into the top of the housing 874. Although not specifically shown in the drawings, the holding screw 888 may be one which allows adjustment of the height of the housing 874, by permitting adjustment of the distance between the top of the housing 874 and the head of the holding screw 888. In accordance with the foregoing, one or more of the IR receivers 836 can be readily mounted to support rails 670. Further, with the particular mounting assembly 872 described herein, and in accordance with the invention, the IR receiver 836 can be mounted anywhere along a continuum of the elongated length of the support rail 670.

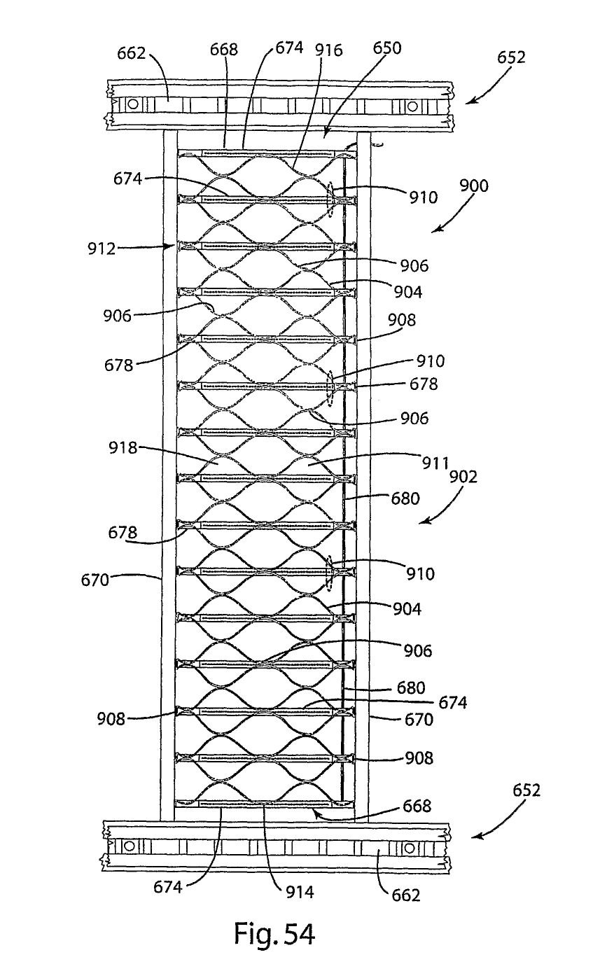

Turning to another aspect of the invention, a number of visual shield configurations were previously described herein. For example, visual shield configuration 320 was previously described with respect to FIGS. 22, 23 and 23A. Visual shield configuration 340 was previously described with respect to FIGS. 24, 25 and 25A. Another visual shield configuration which may be utilized in accordance with the invention incorporates several advantageous features, including ease of use, aesthetics and economics with respect to construction and shipping. This particular visual shield configuration is identified as visual shield configuration 900, and is described herein primarily with respect to FIGS. 54-62C. With reference first to FIGS. 54, 55A, 55B and 56, the visual shield configuration 900 includes what can be characterized as one visual shield section 912 comprising a “concertina” configuration 902. The concertina configuration 902 may also be characterized herein as a “concertina visual shield.” The concertina configuration 902 is constructed of a series of concertina segments 904. In the particular embodiment illustrated in FIGS. 54-56, each concertina segment 904 is in the form of a substantially rectangular configuration. Each concertina segment 904 may be constructed of various materials. For example, the segments 904 can be constructed, at least for prototypes, of a flexible Mylar® material. The term “Mylar®” is a registered trademark of E.I. du Pont de Nemours and Company. Mylar® material is known for having relatively superior strength, heat resistance and excellent insulating properties. Mylar® materials have been used extensively in the past, for products such as audio and videotapes, composite dielectrics, packaging and batteries. In any event, the material used should preferably be translucent and flexible. Flexibility should be sufficient so as to form various shapes, in addition to being capable of “collapsing” for purposes of shipping and storage. With the exception of end segments (identified as segments 914 and 916), each of the concertina segments 904 in this particular embodiment is connected to one of its adjacent concertina segments 904 through a pair of two segment couplings 906. Corresponding, the same concertina segment 904 is connected to its other adjacent concertina segment 904 through three pairs of segment couplings 906. For purposes of clarity, the segment couplings 906 are not shown in all of the drawings. Where two adjacent concertina segments 904 are connected together at three segment couplings 906, the two segments 904 are characterized herein as segment pairs 910.

It is apparent from the concertina configuration 902 illustrated in FIGS. 54-56 that various types of shapes may be formed, by variations in locations where segment couplings 906 are made between adjacent concertina segments 904. The particular configuration 902 illustrated in FIG. 54, for example, may be characterized as a “double wave” configuration. This description arises from the fact that each concertina segment 904 essentially forms a pair of waves 918. This double wave form results from the segment pairs 910 being coupled together with three segment couplings 906, while the other concertina segment 904 adjacent to any given concertina segment 904 of a segment pair 910 is connected at two segment couplings 906. In fact, with this particular multiple wave configuration, and assuming that “x” represents the number of waves desired, the two concertina segments 904 forming any given segment pair 910 should be connected together with “x+1” segment couplings, while the other adjacent concertina segment 904 is connected at “x” segment couplings. Of course, other shapes and various forms may be utilized for the visual shield configuration 900, without departing from the principal novel concepts of the invention.

In the particular visual shield configuration 900 illustrated in FIGS. 54-56, the configuration 900 is shown positioned below a single LED ladder panel 668, formed of sixteen LED strip units 674. The ladder panel 668 is connected between two adjacent support rails 670. The support rails 670 are shown in FIG. 54 as being coupled to a pair of main structural channel rails 652. Correspondingly, the visual shield configuration 900 is also coupled to the support rails 670. Each segment pair 910 includes an end clip 908 at each of its opposing ends. The end clips 908 are utilized to releasably secure the segment pairs 910 to the support rails 970.

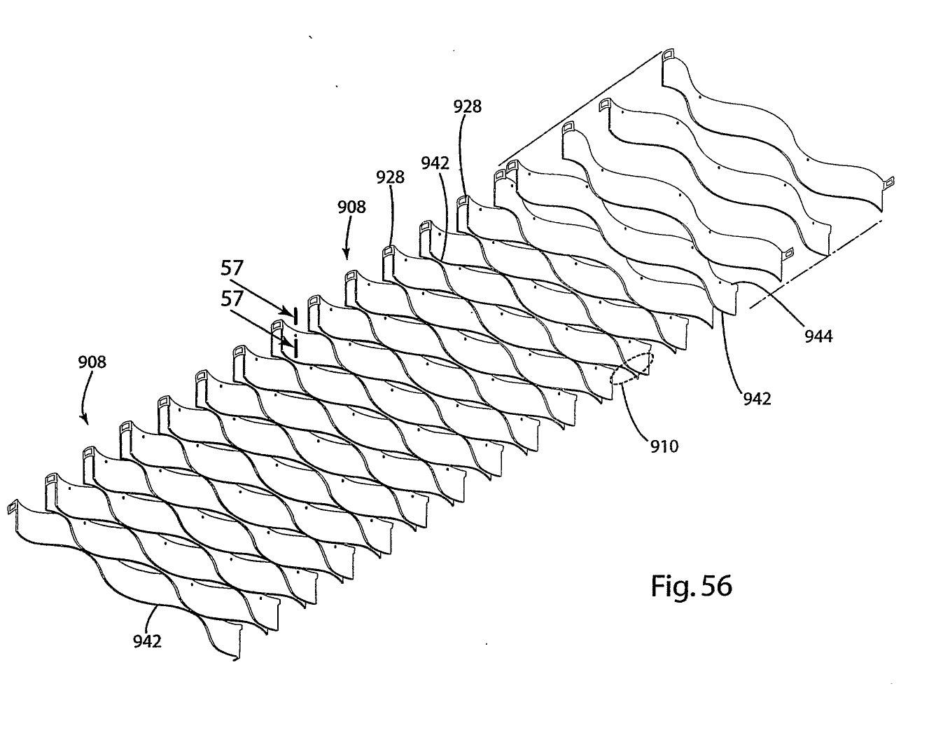

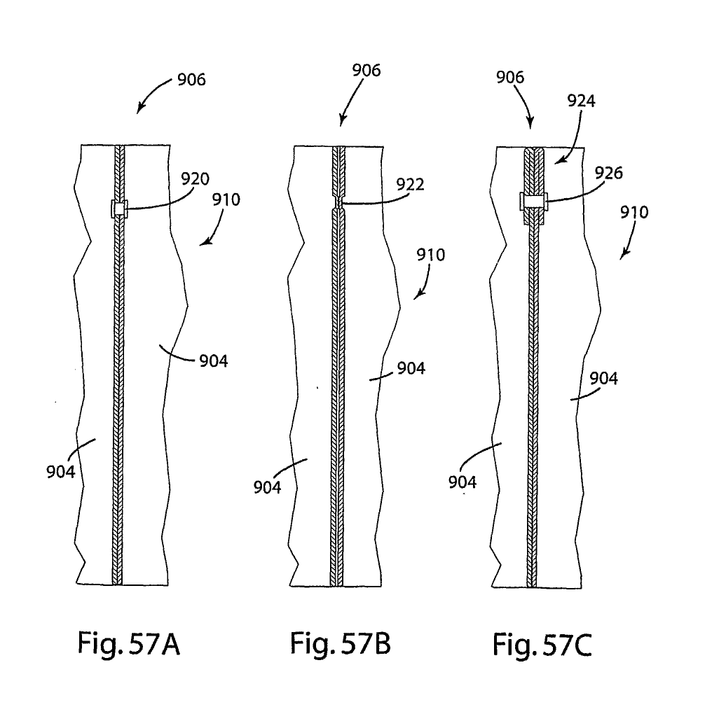

FIG. 56 illustrates the concertina configuration 902 in a “stand alone” configuration. As earlier described, concertina segments 904 forming segment pairs 910 are coupled together at segment couplings 906. For proper functioning of the concertina configuration 902, the segment couplings 906 should exhibit certain properties. For example, the couplings 906 should not substantially interfere with the flexibility of concertina segments 904, particularly with respect to flexibility between segments 904 of any given segment pair 910. Further, the couplings should not damage the material of the segments 904. Ease of use is also important. In this regard, FIGS. 57A, 57B and 57C illustrate sectional views taken at the location of a segment coupling 906, in a position as illustrated in FIG. 56. FIG. 57A illustrates a segment coupling 906 which may utilize relatively short rivets 920 for purposes of coupling together the adjacent concertina segments 904. FIG. 57B illustrates an alternative means for the segment couplings 906. Specifically, FIG. 57B illustrates the use of a heat weld or heat stake 922 so as to form the segment couplings 906 between adjacent connection segments 904. A still further configuration is illustrated in FIG. 57C. Therein, the segment coupling is utilized with the adjacent concertina segments 904 partially folded outwardly on themselves, so as to form what may be characterized as a “4-ply” configuration 924. With this configuration, a connection component such as a relatively long plastic rivet 926 may be utilized, connected through the 4-ply configuration 924. With the 4-ply configuration 924, a substantial amount of strength is provided for the particular segment coupling 906.

Although three particular means for providing the segment couplings 906 have been described herein and illustrated in FIGS. 57A, 57B and 57C, other means for coupling together adjacent connection segments 904 may be utilized, without departing from certain of the principal novel concepts of the invention.

As earlier stated, the concertina configuration 902 includes a series of end clips 908, utilized to releasably couple the segment pairs 910 to support rails 670. Details regarding the coupling of the concertina segments 904 to the support rails 670 are illustrated in FIGS. 58 and 59. As shown therein, each end clip 908 is formed at an end of a segment pair 910 by a pair of end tabs 928. An end tab 928 is formed at each opposing end of each concertina segment 904. As shown primarily in FIG. 58, the end tabs 928 may be formed at the top portions of the ends of the concertina segments 904. Each end tab 928 comprises a substantially resilient and flexible rectangular configuration having an aperture 930 positioned in the middle thereof. The apertures 930 are sized and configured so that they can be received over the tops of a visual shield connecting flange 934 formed within an upwardly extending leg 686 of the support rail 670. In fact, the visual shield connecting flange 934 actually comprises part of the upwardly extending leg 686, formed between a pair of visual shield connecting slots 702. With the end tabs 928 received over the connecting flanges 934, the segment pairs 910 of the concertina configuration 902 are properly supported. In addition, this means for connection and support facilitates removal and reconfiguration of the concertina configuration 902, relative to the support rail 670.

As primarily illustrated in FIG. 50A, the end tabs 928 of the end clips 908 are turned perpendicular to the general plane of the associated concertina segment 904. For purposes of facilitating shipment, connections and use, it may be preferable to couple the two end tabs 928 of a segment pair 910 together. This can be accomplished, for example, by heat staking the end tabs 928, or by other means of relatively permanent connection.

The foregoing described one type of connection arrangement for releasably securing the concertina configuration 902 to support rails 670 through the use of end clips 908. Although this represents a connection arrangement according to the invention, other connection arrangements may also be realized, without departing from the scope of the principal novel concepts of the invention.

The visual shield configuration 900 as described in the foregoing paragraphs was illustrated in FIG. 54 as being utilized below a LED ladder system 650 having a ladder segment 668 with fifteen separate LED strip units 674. Visual shield configurations in accordance with the invention, including configuration 900, are not limited to use with a LED ladder system. FIG. 73 illustrates the use of the particular concertina configuration 902 as positioned below a lighting configuration 936 comprising four banks of fluorescent lighting assemblies 938. Each lighting assembly 938 includes a pair of conventional fluorescent lights 940. Although not shown in FIG. 73, the lighting assemblies 938 may be supported through the use of the support rails 670 or, alternatively, by any other suitable means. Also, it is apparent that the concertina configuration 902 and other configurations in accordance with the invention may be utilized with various types of lighting configurations, in addition to use with other application devices.

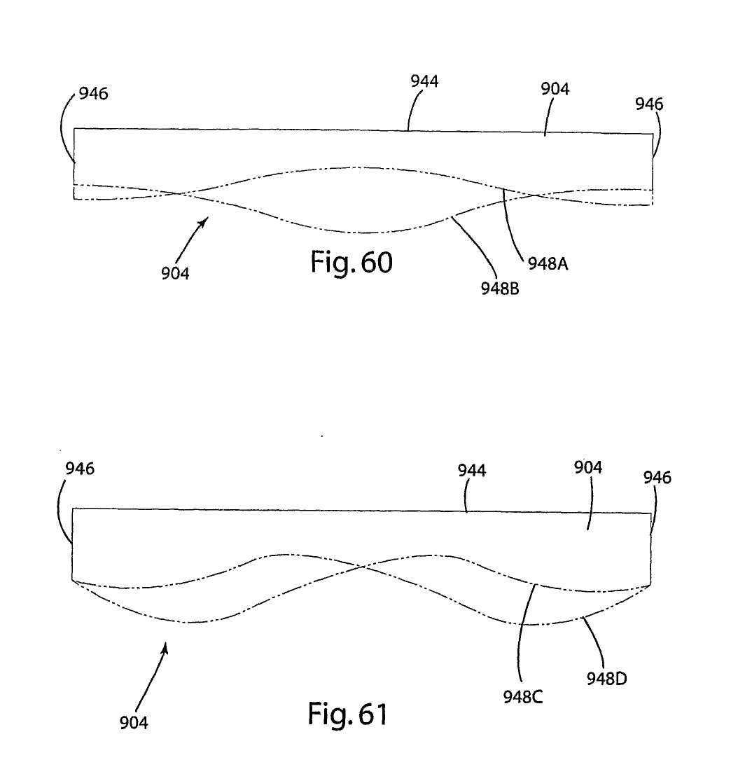

The particular concertina configuration 902 illustrated in FIGS. 54-56 shows the concertina segments 904 in one configuration. Attention is drawn to each of the concertina segments 902 and the bottom edges 942 thereof. The individual concertina segments 904 can be manufactured through a cutting process, for purposes of forming each segment 904. In FIGS. 54-56, this bottom edge 942 is shown as a “straight line” cut. This provides for a certain shape and contour for the entirety of the concertina configuration 902. However, other shapes and contours can be utilized for the concertina segments 904, without departing from the primary concepts of the invention. For example, optional contours are illustrated in FIGS. 60 and 61. In each of these drawings, a concertina segment 904 is illustrated. For purposes of clarity, end tabs 928 and segment couplings 906 are not illustrated. Each concertina segment 904 illustrated in FIGS. 60 and 61 includes a top edge 944 and sides 946. FIGS. 60 and 61 illustrate four optional “cuts” for bottom edges of the concertina segments 904. These optional cut bottom edges are identified in FIG. 60 as bottom edge cuts 948A and 948B, while the bottom edge cuts in FIG. 61 are identified as cuts 948C and 948D. Each of these bottom edge cuts 948A-948D provide for a differing optional contour for the concertina segments 904.

Various aesthetically different and unique configurations can be provided by still further edge cuts for the segments 904. For example, all of the concertina segments 904 associated with one section 912 could be identically cut on their bottom edges. Alternatively, the bottom edges of the concertina segments 904 in a section 912 could have a variety of edge cuts. Still further, contours could be provided not only for bottom edge cuts, but also for cuts in the sides of the segments 904. An advantage exists in that although a number of different aesthetically pleasing designs can be formed through various contour cuts in the concertina segments 904, the means for supporting the concertina segments 904 through the support rails 670, and means for interconnecting adjacent segments 904, can remain the same, independent of what particular contour is utilized. Still further, as described subsequently herein, an advantage of the visual shield configuration 900 is associated with the capability of the concertina segments 904 to be “collapsed” together in somewhat of an “accordion” configuration. From this description, it will be apparent to those having skill in the fabrics and placemaking design arts that cutting processes can be designed in a manner so that the processes are relatively streamlined. That is, multiple concertina segments 904 can be simultaneously cut together, to the extent the segments 904 have identical contours. It should also be mentioned that by shaping the contours of the concertina segments 904, the manner in which light is transmitted through or around the concertina segments 904 (from lighting assemblies such as the LED ladder system 650), various lighting schemes can be implemented. In particular, the concertina configuration 902 and other configurations using the concertina effect can result in a number of novel and aesthetically pleasing forms and contours. Also, multiple expressions can be provided using the structure associated with the LED ladder system 650 and the visual shield configuration 900. For example, light bags and similar types of visual shield configurations (such as those previously described herein) may be employed with the structural arrangement utilizing the main structural channel rails 652, support rails 670 and connection arrangements such as the end clips 908.

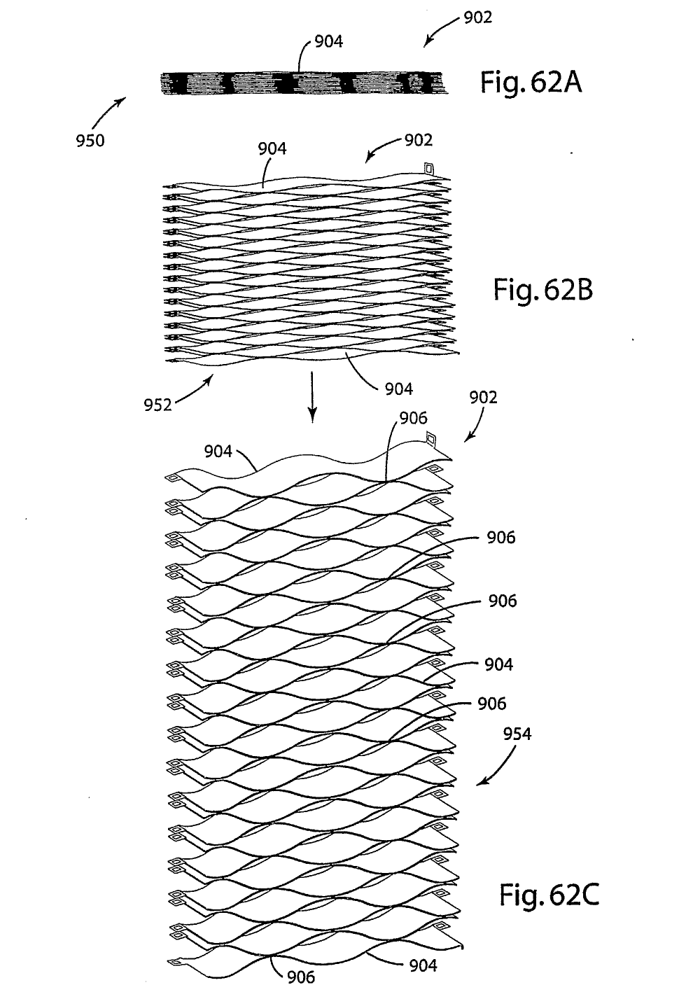

As earlier described, visual shield configurations in accordance with the invention, such as the concertina configuration 902, result in economic advantages. For example, with the type of cutting which may be utilized to provide for a variety of optional contours, the process is somewhat “dematerialized.” That is, less waste occurs in the cutting processes. Also, it was earlier mentioned that advantages exist with respect to shipping and storage economics. These advantages are illustrated in the various configurations of the concertina segments 904 illustrated in FIGS. 62A, 62B, and 62C. Referring to these configurations in reverse order of the drawings, FIG. 62C illustrates the concertina segments 904 and the concertina configuration 902 in what can be characterized as an “expanded” state 954. It is this expanded state which is shown in the implementation of the concertina configuration 902 in FIGS. 54-56. If desired, the concertina configuration 902 can be somewhat collapsed, so that it progresses from the expanded state 954 to what can be characterized as a partially expanded state 952 illustrated in FIG. 62B. In the partially expanded state 952, it is still possible to utilize the concertina configuration 902. Also, it should be noted that the concertina configuration 902 could be utilized in any of a number of states between the fully expanded state 954 and the partially expanded state 952. However, such use would be somewhat dependent upon having visual shield connecting flanges 934 appropriately positioned along the support rails 670. On the other hand, however, it may also be possible to utilize the concertina configuration 902 without necessarily connecting each of its end clips 908 to a visual shield connecting flange 934. In any event, the particular expansion state in which the concertina configuration 902 is utilized will result in various lighting schemes, assuming that an LED ladder system or similar type of lighting assembly is utilized above or adjacent the concertina configuration segment 902.

For purposes of shipping, the concertina configuration 902, when in the partially expanded state 952 as shown in FIG. 62B, can be fully collapsed into what is characterized as a collapsed state 950 shown in FIG. 62A. In this state, the concertina configuration 902 likely does not have any practical implementations. However, in accordance with the invention, this collapsed state 950 provides significant advantages with respect to both shipping and storage. That is, the concertina configuration 902 can be shipped or stored in the collapsed state, thereby requiring less bulk than other types of visual shield or ceiling systems.

The foregoing has described various concepts which may be applicable to a number of different embodiments of visual shield configurations in accordance with the invention. In particular, the use of the concertina configuration 902 has been described, particularly with respect to its use with LED ladder panels 668 and configurations for releasably coupling the concertina configuration 902 to the support rails 670. Of course, various types of visual shield configurations may be utilized in place of the specific concertina configuration 902 described herein, without departing from certain of the principal concepts of the invention.

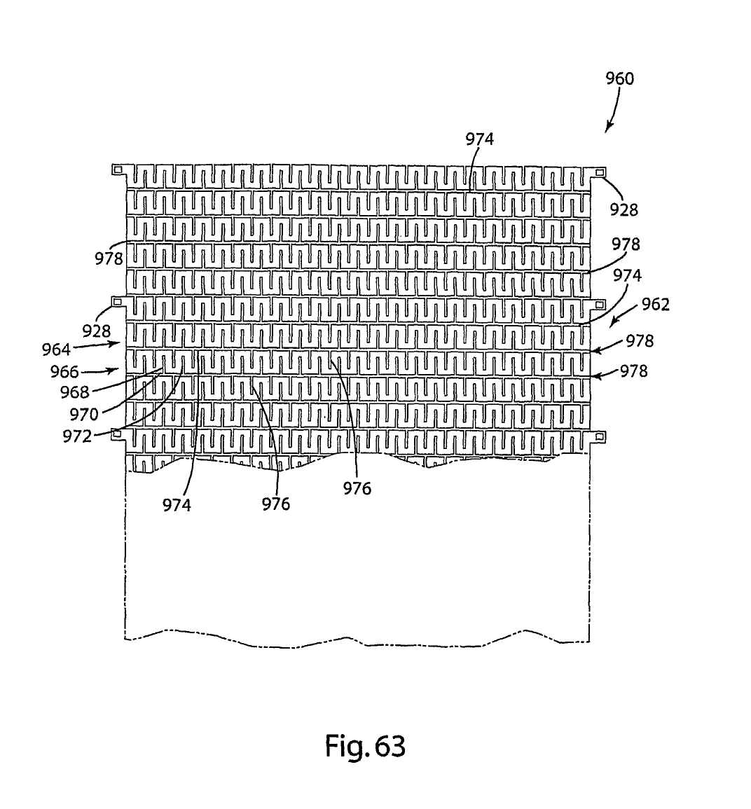

Another embodiment of a specific type of visual shield configuration which may be utilized in accordance with certain aspects of the invention is illustrated in FIGS. 63, 64 and 65, and is identified as visual shield configuration 960. The visual shield configuration 960 provides advantages with respect to manufacture and provides certain unique structural and aesthetic features. More specifically, the visual shield configuration 960 may be constructed of various materials, including a plastic “Mylar®” material. As shown in FIG. 63, the visual shield configuration 960 can first be manufactured and constructed as individual sections, such as section 962. Section 962 may originally be a rectangular sheet of Mylar® material, appropriately cut so as to have a width corresponding to the desired width between support rails 670. Advantageously, with materials such as Mylar® material, visual shield configurations such as those incorporating section 962 can be formed with laser cutting or similar methods. As shown in each of FIGS. 63, 64 and 65, the section 962 is cut and formed with a series of spaced apart end tabs 928 (preferably each being equidistant from adjacent end tabs 928) on the lateral sides of the section 960. The ends tabs 928 can be sized and configured so as to essentially conform to the end tabs 928 previously described herein with respect to the concertina configuration 902. As expressly shown in FIG. 65, the end tabs 928 can be received on the visual shield connecting flanges 934 positioned between visual shield connecting slots 702 formed in the upwardly extending legs 686 of support rail 670.

A laser cut of the section 962 can produce a series of what may be characterized as “lateral rows” of cut rectangles within the flat sheet configuration of the section 962. For example, with reference to the drawings, the cutting process can form a lateral row 964, having a lateral row 966 adjacent thereto. The lateral row 964 can be characterized as being comprised of a series of cut rectangles 968 which extend horizontally across the section 962. Each of the rectangles 968 can be characterized as having a lower edge 970 extending horizontally across the sheet (as viewed in FIG. 63). In each of the rectangles 968, a center slot 972 is cut. The center slot 972 extends upwardly from the lower edge 970. In the particular embodiment illustrated in the drawings, the center slot 972 can be characterized as extending in the range of two-thirds to three-quarters of the vertical length of each rectangle 968.

Each rectangle 968 can also be characterized as having an upper edge 974. On each lateral side of the rectangles 968, a side slot 976 extends “downwardly” (as viewed in FIG. 63) from the upper edge 974. In this particular embodiment, the length of each side slot 976 may be in the range of two-thirds to three-quarters of the vertical length of the rectangles 968. Correspondingly, the lower edge 970 of one lateral row 964, and the upper edge 974 of an adjacent lateral row 966 can be formed by essentially cutting a “channel” 978 between the adjacent rows.

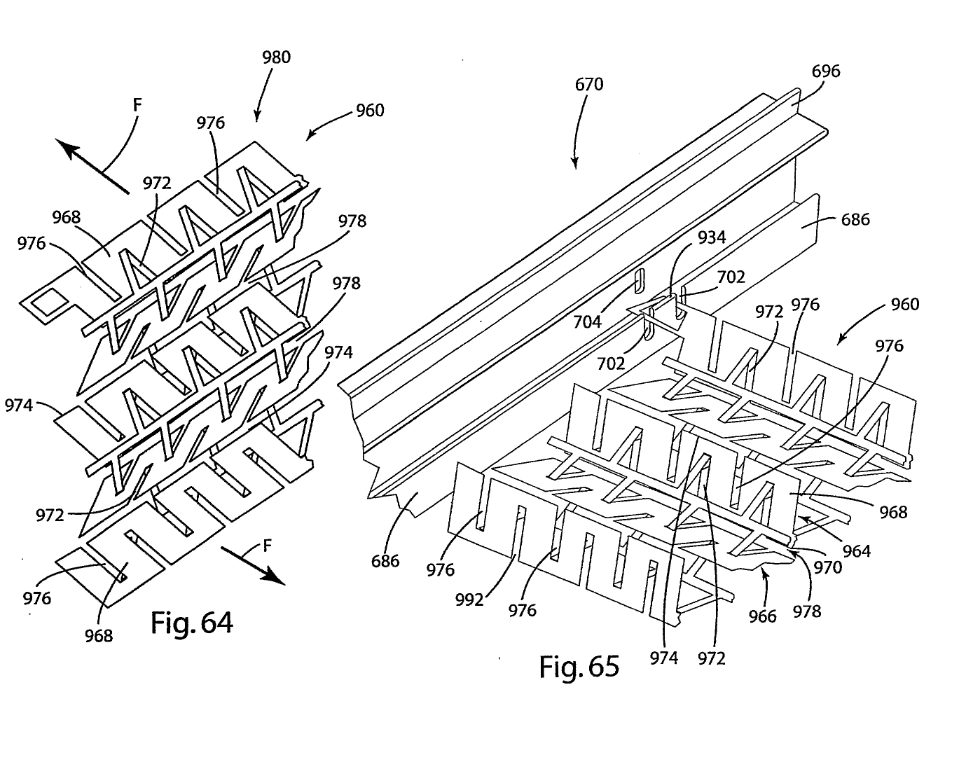

The section 962 can be laid “flat” as shown in FIG. 63. This is particularly advantageous for shipping and storage. The flat configuration illustrated in FIG. 63 may be characterized as a “normal” configuration of the section 962, absent any external forces applied to the section 962. However, the section 962 can be shaped in unique and aesthetically pleasing forms when external forces are applied to the section 962. For example, reference is made to FIGS. 64 and 65. In these drawings (which show only a small portion of the section 962), one lateral row of the cut rectangles can be identified as row 980. Correspondingly, the lateral row of rectangles on the opposing end of the partial section 962 can be characterized as row 982. If forces are applied to either or both of the rows 980, 982 in a direction opposing the location of the other row (with the directional forces indicated by arrows F in FIG. 64), the section 962 will essentially transform itself into shapes and configurations as shown in FIGS. 64 and 65. These configurations are particularly aesthetically pleasing. In addition, these various forms of configurations can produce some unique lighting effects when employed in combination with lighting assemblies such as the LED ladder system 650. It should be noted that the particular forms and configurations of the section 962 will depend on various parameters, including the amount of external forces applied to the section 962, the widths and heights of the rectangles 968, and the relative lengths of the center slots 972 and side slots 976. In addition, the widths of the channels 978 will also have relevance as to the particular configurations.

The visual shield configuration 960 illustrated in FIGS. 63, 64 and 65 represents only one type of visual shield configuration which may be manufactured and used in accordance with certain concepts of the invention. Various other configurations using certain of the same concepts associated with cutting processes and specific cut configurations can be envisioned without departing from the principal concepts of the invention. It should be noted, again, that the configuration materials can be laser cut via computer diagrams. These diagrams may, for example, be designed by architects. The diagrams typically are executed within CNC laser cutters, resulting in rapid customizing processes.

Various concepts associated with LED ladder systems, network connection embodiments, visual shields having concertina effects and unique “cut” visual shields have been described in the foregoing paragraphs. With respect to the LED ladder systems, it has been shown that they are advantageous in ease of use. The systems can likely be installed by laypersons, without requiring assemblers having substantial electrical or other expertise. The ladder systems in accordance with the invention can also be relatively light weight and facilitate replacement. Still further, the ladder systems can provide a substantial amount of lighting, while still permitting substantial access to fixtures above the plane of the LED ladder systems. Also, because the elements of the ladder systems do not take up a substantial area of the ceiling plane, it is relatively easy to selectively place and, for example, relocate fixtures.

The LED ladder systems also provide for operation at low voltages, thereby enhancing their safety features. Light colors can be readily modified, as well as intensity, textures and hues. The ladder systems described herein also can provide for a substantially continuous plane of light, thereby providing better space lighting, absence of shadows and the like. As also described, the LED ladder systems are assembled such as to facilitate modifications in color pixilation intensity. These systems also facilitate the use of wayfinding features, providing capability of rapidly modifying light colors and lighting positions. Such wayfinding features or functions fall within the scope of “directions functions” or “space identification.”

The LED ladder systems in accordance with the invention also lend themselves to placemaking functions. That is, the systems can be enabled so as to readily influence the tone of commercial interiors, through colors and light intensity. In the same regard, for example, lighting enablement can be modified at different locations based on the detection of motion. Accordingly, spatial areas can be enabled for light only as needed. Still further, the LED ladder systems in accordance with the invention can readily respond to various sensor elements, such as those responsive to sunlight intensity and the like. In response to sensed properties, the lighting can be utilized to adjust environmental conditions.

Still further, the LED ladder systems in accordance with the invention are advantageous economical. With the use of LEDs and the minimal number of structural elements associated with the ladder systems, they provide for low energy consumption and longer life spans. Also, because of the reduction in AC power consumption, the ladder systems generate relatively little heat.

With respect to the network connections described herein, the specific embodiments show the capability of control of lighting in space from a broad sense (e.g. controlling all of the LED strip units 674 simultaneously as they exist within one LED ladder panel 668) to more specific or narrow control (such as individual control of LED strip units 674). With the control of the LED ladder systems through the network connections, relatively broad color spectrums are available, since the controls involve not only enablement, but also light intensity, color selection and the capability of varying other properties. Still further, the network connections described herein represent relatively “simple” electronic interconnections. Accordingly, reconfiguration of control/controlling relationships is relatively less complex, and does not require any rewiring or other structural modifications. Further, although the network connections have been described with respect to LED ladder systems, it is clear that concepts associated with the network connections may be utilized for other applications. For example, the network connection configurations shown herein, and other connection configurations in accordance with the invention, may control sound equipment, motion sensing devices, projection screens, skylight manipulations and various other devices.

With respect to the concept of utilizing visual shield configurations having concertina effects, and as disclosed herein, such configurations are relatively light weight. Also, they can be constructed so as to utilize a relatively small percentage of the spatial area of the ceiling plane. In this regard, they can be characterized as being relatively porous, and permit ceiling entry for utilities such as fire sprinklers, HVAC equipment and others. Also, with the particular embodiments described herein, the concertina configurations are compatible with structure as described in the channel system application. Still further, with the concertina configurations, and the relatively small percentage of spatial area used by the configurations, they present flexibility in activities which may involve access to structure and electronic components positioned above the plane of the concertina configurations. Such activities may involve, for example, replacement of lights, modifications for HVAC equipment and other activities. Further, as with the LED ladder systems, the concertina configurations described herein are essentially constructed as a “continuum.” Such construction facilitates installation.

As also described herein, the concertina configurations present some unique and aesthetically pleasing forms and expressions. For example, the concertina configurations may be utilized in combination with light bags. Also, as previously disclosed herein, various optional contours may be utilized, while still retaining the concertina effects. Still further, the concertina configurations present economical advantages. As described, the concertina configurations are capable of being collapsed. This facilitates shipment and storage. Also, in terms of manufacture and assembly, very little material is wasted. Also, the concertina configurations are not particular difficult to manufacture or otherwise modify.

It will be apparent to those skilled in the pertinent arts that other embodiments in accordance with the invention may be designed. That is, the principles of the invention are not limited to the specific embodiments described herein. Accordingly, it will be apparent to those skilled in the art that modifications and other variations of the above-described illustrative embodiments of the invention may be effected without departing from the spirit and scope of the novel concepts of the invention.

1. A lighting system for use within a building infrastructure in a supporting physical structure, said supporting physical structure forming an overhead frame, and said lighting system comprising:
a plurality of lighting elements;
a plurality of strip units, each of said strip units carrying a set of said lighting elements;
frame connection means for connecting each of said strip units to said overhead frame;
power transmission means connected to said lighting elements for applying electrical power to said lighting elements; and
when said lighting elements and said strip units are assembled, light intensity can be varied by modifying the spatial density of said strip units.

2. A lighting system in accordance with claim 1, characterized in that when said lighting elements and said strip units are assembled, lighting intensity can be varied by modifying the number of individual lighting elements carried by each of said strip units.

3. A lighting system in accordance with claim 1, characterized in that:
when said strip units are connected to said overhead frame through said frame connection means, said strip units form a lighting plane; and
said strip units are connected to said frame connection means with a spatial density so as to provide light intensity when said lighting elements are activated, and so as to permit passage of fixtures through said lighting plane from above and below said lighting plane.

4. A lighting system in accordance with claim 1, characterized in that said lighting system further comprises control means connected to said power transmission means and operable by a user so as to selectively control said electrical power applied to said lighting elements.

5. A lighting system in accordance with claim 1, characterized in that said lighting system further comprises control means connected to said power transmission means and operable by a user so as to selectively control and modify a plurality of lighting properties associated with said lighting elements.

6. A lighting system in accordance with claim 1, characterized in that:
said plurality of lighting elements are allocated into lighting element groups, with each of said lighting element groups comprising multiple lighting elements; and
individual lighting elements of a given one of said lighting element groups are controlled so as to generate colors and/or hues different from other lighting elements within said given lighting element group.

7. A lighting system in accordance with claim 1, characterized in that said plurality of lighting elements comprise LED lights.

8. A lighting system in accordance with claim 1, characterized in that said electrical power applied to said lighting elements consists of low voltage power.

9. A lighting system in accordance with claim 1, characterized in that said electrical power applied to said lighting elements is in the form of DC power.

10. A lighting system in accordance with claim 1, characterized in that said:
when said strip units are connected to said overhead frame, said strip units form a lighting plane; and
the percentage of total planar area taken up by said strip units within said lighting plane is less than or equal to 70%.

11. A lighting system in accordance with claim 1, characterized in that:
said lighting system further comprises control means connected to said power transmission means so as to selectively control application of said electrical power to said lighting elements; and
said control means is responsive to one or more of a group of environmental sensing devices, for purposes of selectively applying said electrical power to said lighting elements.

12. A lighting system in accordance with claim 11, characterized in that said group of environmental sensing devices consists of one or more of the following: device for sensing sunlight intensity; device for sensing motion; device for sensing temperature; device for sensing atmospheric conditions; device for sensing the presence of smoke; and device for sensing time of day.

13. A lighting system in accordance with claim 11, characterized in that said control means comprises means responsive to said environmental sensing device group so as to enable certain of said lighting elements only within selected spatial areas of said lighting system.

14. A lighting system in accordance with claim 13, characterized in that said environmental sensing device group comprises one or more motion sensing devices.

15. A lighting system in accordance with claim 1, characterized in that:
said lighting system further comprises control means connected to said power transmission means so as to selectively control said electrical power applied to said lighting elements; and
said control means comprises means for selectively applying said electrical power in a manner so as to form predetermined spatial lighting configurations with said lighting elements, for providing visually differentiated arrangements of light intensity and color to provide directions and other forms of space identification.

16. A lighting system in accordance with claim 15, characterized in that:
said plurality of lighting elements comprise lighting elements of differing colors; and
when said control means is controlling said spatial lighting configurations for purposes of directions functions, said directions functions utilize enablement of said lighting configurations with differing color configurations.

17. A lighting system in accordance with claim 15, characterized in that said control means further comprise means for selectively applying said electrical power in a manner so as to sequentially enable said lighting elements so that said spatial lighting configurations form patterns visually indicating one or more safe exit paths in emergency situations.

18. A lighting system in accordance with claim 1, characterized in that:
said lighting system further comprises control means connected to said power transmission means so as to selectively control said electrical power applied to said lighting elements; and
said lighting elements comprise lighting elements responsive to said electrical power so that said elements generate light of differing colors.

19. A lighting system in accordance with claim 18, characterized in that said lighting elements are responsive to changes in applications of said electrical power by correspondingly changing, in degrees, one or more of the following powered properties: translucence; light intensity; texture; and diffusion.

20. A lighting system in accordance with claim 1, characterized in that:
said plurality of lighting elements and said plurality of strip units form an overhead lighting plane;
said plurality of lighting elements comprise lighting elements which generate variations in light intensity in response to variations in said applied electrical power, and further comprise lighting elements which generate differing colors; and
when said lighting elements and said strip units are assembled as said lighting plane, said lighting elements and said strip units are of a sufficient spatial density so that changes in lighting properties can be varied through variations in said lighting colors and light intensities by a user to affect the specific ambient light environment of the occupants, provide a place making function, and the tone of a spatial interior formed under said lighting plane can be varied through variations in said lighting colors and said light intensities.

21. A lighting system in accordance with claim 1, characterized in that:
said plurality of lighting elements and said plurality of strip units form an overhead lighting plane;
said lighting system further comprises means for supporting said lighting elements and said strip units in a manner so as to vary the spatial density of said lighting elements and said strip units within said overhead lighting plane;
said spatial density is configured so that said strip units comprise a spatial area of said overhead lighting plane which is a relatively small percentage of the entire spatial area of said overhead lighting plane; and
said lighting elements and said strip units are spaced so as to further provide for a relatively continuous ceiling plane of light more broadly distributing light than conventional light fixtures, thereby reducing shadow effects.

22. A lighting system in accordance with claim 1, characterized in that:
said plurality of lighting elements and said plurality of strip units form an overhead lighting plane;
said system further comprises means for applying said electrical power so as to generate variations in lighting properties across said overhead lighting plane; and
said variations in lighting properties provide means for generating image projections through the use of said lighting elements.

23. A lighting system in accordance with claim 1, characterized in that:
said plurality of lighting elements comprise lighting elements which generate variations in light intensity in response to variations in said applied electrical power, and further comprise lighting elements which generate differing colors; and
said system further comprises means for generating visual configurations of said lighting elements which vary with respect to color pixilation intensity.

24. A lighting system in accordance with claim 1, characterized in that said system further comprises network connection means connected to said power transmission means for controlling said application of electrical power to said lighting elements.

25. A lighting system in accordance with claim 24, characterized in that said network connection means comprises means for lighting control of a set of said strip units as an entire group.

26. A lighting system in accordance with claim 24, characterized in that said network connection means comprise means for lighting control of sets of said lighting elements on the basis of selective control of individual strip units.

27. A lighting system in accordance with claim 24, characterized in that said network connection means comprises means for selective lighting control of individual ones of said lighting elements.

28. A lighting system in accordance with claim 24, characterized in that:
said system further comprises user control means connected to said network connection means for providing a user with selective control of the application of said electrical power to said lighting elements; and
said user control means is locatable at any of a number of desired locations, with said desired locations being nearby or otherwise adjacent to said lighting system.

29. A lighting system in accordance with claim 24, characterized in that:
said system further comprises user control means connected to said network connection means for providing a user with selective control of said electrical power to said lighting elements; and
said network connection means comprise means for reconfiguration of controlled and controlling relationships between said user control means and said lighting elements, in the absence of any physical rewiring or other structural modifications of said lighting system.

30. A lighting system for use within a building infrastructure and a supporting physical structure, said supporting physical structure forming an overhead frame, and said lighting system comprising:
at least one light panel, said light panel adapted to be supported by said overhead frame, and said light panel comprising a series of spaced apart lights positioned at various locations on said light panel; and
said light panel being interconnected at opposing ends to a pair of spaced apart support rails, said support rails forming a part of said overhead frame.

31. A lighting system in accordance with claim 30, characterized in that each of said support rails is interconnected at its opposing ends to a pair of structural channel rails.

32. A lighting system in accordance with claim 30, characterized in that each of said lights comprises an LED.

33. A lighting system in accordance with claim 30, characterized in that:
said light panel comprises a light ladder panel comprising a series of spaced apart LED strip units; and
each of said strip units comprises a series of said lights positioned on an elongated length of each of said strip units.

34. A lighting system in accordance with claim 30, characterized in that:
said light panel comprises at least one LED ladder panel, said LED ladder panel comprising a series of spaced apart LED strip units;
each of said LED strip units comprises a series of said lights, and each of said lights comprises an LED light positioned on an elongated length of one of said strip units;
each of said LED strip units being interconnected at opposing ends to a pair of said spaced apart support rails, said support rails forming a part of said overhead frame;
said lighting system further comprises a series of LED strip connectors, for connecting each of said LED strip units to said pair of support rails; and
each of said support rails is interconnected at each of its opposing ends to one of a pair of structural channel rails through a series of support rail mounting brackets.

35. A lighting system in accordance with claim 34, characterized in that:
said overhead frame comprises a series of spaced apart structural channel rails; and
said structural channel rails are adapted to carry power and communication signals for purposes of applying power to said lights, and for providing the capability of programming and controlling said light elements.

36. A lighting system in accordance with claim 34, characterized in that said system comprises conductive means for transmitting appropriate levels of DC power to said LED lights associated with individual ones of said strip units.

37. A lighting system in accordance with claim 36, characterized in that said conductive means comprises at least one bonded wire ribbon conductively connected to said strip units through LED strip connectors.

38. A lighting system in accordance with claim 34, characterized in that said system further comprises means for a user to vary the density of said lights by varying the number of said strip units associated with said LED ladder panel, and also varying lateral distances between adjacent ones of said strip units.

39. A lighting system for use with a building infrastructure and a supporting physical structure, said supporting physical structure forming an overhead frame, and said lighting system comprising:
a plurality of lighting elements;
a plurality of strip units, each of said strip units carrying a set of said lighting elements;
frame connection means for connecting each of said strip units to said overhead frame;
power transmission means connected to said lighting elements for applying electrical power to said lighting elements; and
when said lighting elements and said strip units are assembled, lighting intensity can be varied by modifying the number of individual lighting elements carried by each of said strip units.

40. A lighting system for use with a building infrastructure and a supporting physical structure, said supporting physical structure forming an overhead frame, and said lighting system comprising:
a plurality of lighting elements;
a plurality of strip units, each of said strip units carrying a set of said lighting elements;
frame connection means for connecting each of said strip units to said overhead frame, so that when said strip units are connected to said overhead frame, said strip units form a lighting plane;
power transmission means connected to said lighting elements for applying electrical power to said lighting elements; and
said strip units are connected to said frame connection means with a spatial density so as to provide light intensity when said lighting elements are activated, and so as to also permit passage of fixtures through said lighting plane from above and below said lighting plane.

41. A lighting system for use with a building infrastructure and a supporting physical structure, said supporting physical structure forming an overhead frame, and said lighting system comprising:
a plurality of lighting elements;
a plurality of elongated mounting units, each of said mounting units carrying a set of said lighting elements;
frame connection means for connecting each of said mounting units to said overhead frame;
power transmission means connected to said lighting elements for applying electrical power to said lighting elements; and
control means connected to said power transmission means and operable by a user so as to selectively control said electrical power applied to said lighting elements.

42. A lighting system for use with a building infrastructure and a supporting physical structure, said supporting physical structure forming an overhead frame, and said lighting system comprising:
a plurality of lighting elements;
a plurality of mounting units, each of said mounting units carrying a set of said lighting elements;
frame connection means for connecting each of said mounting units to said overhead frame;
power transmission means connected to said lighting elements for applying electrical power to said lighting elements; and
control means connected to said power transmission means and operable by a user so as to selectively control and modify a plurality of lighting properties associated with said lighting elements.

43. A lighting system for use within a building infrastructure and a supporting physical structure, said lighting system comprising:
a plurality of lighting elements;
a plurality of mounting units, each of said mounting units carrying one or more of said lighting elements;
connection means for connecting said mounting units to said physical structure;
power transmission means connected to said lighting elements for selectively applying electrical power to said lighting elements; and
at least one electronics unit connected to said power transmission means, said electronics unit having means responsive to communication signals for selectively controlling said application of electrical power to said lighting elements.

44. A lighting system in accordance with claim 43, characterized in that said electronics unit comprises processing means responsive to said communication signals for controlling application of said electrical power to said lighting elements.

45. A lighting system in accordance with claim 43, characterized in that said means responsive to said communication signals for controlling application of said electrical power to said lighting elements comprise means for controlling when said electrical power is applied to said lighting elements and amplitudes of said electrical power applied to said lighting elements.

46. A lighting system in accordance with claim 43, characterized in that said electronics unit comprises transformer means for converting an incoming portion of said electrical power to low voltage power prior to power being applied to said lighting elements.

47. A lighting system in accordance with claim 46, characterized in that said electronics unit comprises means for varying amplitudes of said low voltage power selectively applied to said lighting elements so as to provide a dimmer function for said lighting elements.

48. A lighting system in accordance with claim 43, characterized in that:
said system further comprises a plurality of electronics units;
said plurality of lighting elements and said plurality of mounting units are assembled so as to form a plurality of ladder panels, with each panel having a set of said plurality of mounting units and connected to said physical structure; and
each of said electronics units operates so as to control application of said electrical power to lighting elements associated with corresponding ones of said ladder panels.

49. A lighting system in accordance with claim 43, characterized in that said electronics unit comprises;
an incoming power conduit adapted to receive incoming AC power, said incoming AC power being applied to an incoming side of a transformer located within said electronics unit;
said transformer converts said incoming AC power to low voltage power;
dimmer circuit means, with said low voltage power being applied as input power to said dimmer circuit means, and with said dimmer circuit means being responsive to said low voltage power and to control signals so as to selectively modify actual levels of low voltage power applied as output power from said electronics unit.

50. A lighting system in accordance with claim 43, characterized in that said electronics unit further comprises means for control of lighting elements on at least one set of said mounting units as an entire group.

51. A lighting system in accordance with claim 43, characterized in that said electronics unit comprises means for lighting control of sets of said lighting elements on the basis of selective control of lighting elements on individual ones of said mounting units.

52. A lighting system in accordance with claim 43, characterized in that said electronics unit comprises means for selective lighting control of individual ones of said lighting elements.

53. A lighting system in accordance with claim 43, characterized in that:
said system further comprises user control means connected to said electronics unit for providing a user with selective control of said electrical power to said lighting elements; and
said system comprises means for reconfiguration of controlled and controlling relationships between said user control means and said lighting elements, in the absence of any physical rewiring or other structural modifications of said lighting system.

54. A lighting system for use within a building infrastructure and a supporting physical structure, said supporting physical structure forming an overhead frame, said frame comprising a plurality of structural channel rails and a plurality of support rails, with certain of said support rails being interconnected to pairs of certain ones of said structural channel rails, and said lighting system comprising:
a plurality of ladder panels, with said ladder panels extending between certain pairs of said support rails, each of said ladder panels comprising a plurality of lighting elements and a plurality of mounting units, with each of said mounting units carrying one or more of said lighting elements;
power transmission means for selectively applying electrical power to said lighting elements; and
a plurality of electronics units, each of said electronics units comprising processing circuitry responsive to communication signals for controlling application of power to said lighting elements.

55. A lighting system in accordance with claim 54, characterized in that each of said electronics units comprises transformer means for converting incoming AC power to low voltage DC power.

56. A lighting system in accordance with claim 55, characterized in that each of said electronics units comprises circuitry responsive to said communication signals, and further responsive to DC power generated by said transformer means, so as to apply a dimmer function to said DC power as it is applied as output power to said lighting elements.

57. A lighting system in accordance with claim 54, characterized in that each of said electronics units separately receives electrical power from an interconnected incoming power conduit, adapted to receive incoming AC power.

58. A lighting system in accordance with claim 54, characterized in that:
said lighting elements are allocated among groups on said mounting units, with each of said groups having a plurality of differently colored LED's; and
each of said electronics units comprises a number of dimmer control circuits, with said number of dimmer control circuits corresponding in number to the number of different colors associated with said differently colored LED's.

59. A lighting system in accordance with claim 54, characterized in that each of said lighting elements associated with a given one of said mounting units is electrically connected with all other ones of said lighting elements mounted on said given mounting unit.

60. A lighting system in accordance with claim 54, characterized in that each of said electronics units applies low voltage output power to one of a series of bonded wire ribbons, with each of said bonded wire ribbons being associated with a corresponding ladder panel.

61. A lighting system in accordance with claim 54, characterized in that said system further comprises a plurality of connector modules, said connector modules being adapted to electrically connect to user control means for controlling application of electrical power to said lighting elements, and for connecting said communication signals to said electronics units.

62. A lighting system in accordance with claim 61, characterized in that said connector modules comprise connector means for distributing AC power carried along said structural channel rails to said electronics units.

63. A lighting system in accordance with claim 54, characterized in that said system further comprises user control means connected to said lighting elements through said electronics units for providing a user with selective control of enablement and disablement of said lighting elements.

64. A lighting system in accordance with claim 63, characterized in that said user control means comprises a multiple-channel dimmer switch assembly.

65. A lighting system in accordance with claim 54, characterized in that:
each of said electronics units is connected to and controls an associated one of said ladder panels; and
incoming AC electrical power is directly applied to each of said electronics units.

66. A lighting system in accordance with claim 54, characterized in that:
said lighting system further comprises a plurality of connector modules coupled to said structural channel rails, with each of said connector modules having means for distributing AC electrical power;
each of said electronics units is connected to and controls an associated one of said ladder panels; and
each of said electronics units receives incoming AC electrical power from said means for distributing electrical power from said connector modules.

67. A lighting system in accordance with claim 54, characterized in that:
at least one of said electronics units directly receives incoming AC power; and
said at least one electronics unit receiving said incoming AC power comprises means for distributing said incoming AC power directly to another of said electronics units.

68. A lighting system in accordance with claim 67, characterized in that at least one of said electronics units receiving incoming AC power from said at least one electronics unit directly receiving said incoming AC power comprises means for further distributing said incoming AC power to another of said electronics units.

69. A lighting system in accordance with claim 54, characterized in that AC power conduits are utilized to electrically connect at least one set of said electronics units in a daisy chain configuration.

70. A lighting system in accordance with claim 54, characterized in that said lighting system further comprises a plurality of IR receivers, with each of said IR receivers being associated with a given one of said electronics units.

71. A lighting system in accordance with claim 54, characterized in that:
said system further comprises at least one connector module for transmitting communication signals to an interconnected one of said electronics units; and
said electronics unit receiving said communication signals from said connector module comprises means for directly transmitting said communication signals to one or more of others of said electronics units.

72. A lighting system in accordance with claim 54, characterized in that said system further comprises a plurality of IR receivers, each of said IR receivers being associated with a corresponding one of said mounting units.

73. A network connection system for use within a building infrastructure for selectively distributing power among a plurality of application devices, and/or selectively controlling enablement and disablement of said application devices, said connection system comprising:
communication signals having information relating to control of said application devices by said network connection system;
processor means responsive to certain of said communication signals for generating application signals, said application signals comprising power and/or control signals;
means for applying said application signals as input signals to said application devices;
receiver means responsive to programming signals for generating further programming signals and applying said further programming signals to said processor means; and
said processor means are responsive to said further programming signals so as to determine which of said communication signals comprise said certain of said communication signals for generating said application signals.

74. A network connection system in accordance with claim 73, characterized in that said system comprises user control means capable of manual use for generating said communication signals.

75. A network connection system in accordance with claim 73, characterized in that said application devices comprise one or more of the following group: LED lights; sound equipment; motion sensing devices; projection screens; skylights; television monitors and cameras.

76. A network connection system in accordance with claim 73, characterized in that said connection system comprises a plurality of separate electronics units, each of said electronics units comprising:
means for receiving said communication signals;
a portion of said processor means; and
means for receiving power.

77. A network connection system in accordance with claim 76, characterized in that each of said electronics units comprises transformer means for converting incoming power to low voltage power.

78. A network connection system in accordance with claim 76, characterized in that each of said electronics units comprises means for receiving AC electrical power, and transformer means for converting said AC power to low voltage DC power.

79. A network connection system in accordance with claim 76, characterized in that each of said electronics units is connected to and controls an associated one of said application devices.

80. A network connection system in accordance with claim 76, characterized in that incoming AC electrical power is directly applied to each of said electronics units.

81. A network connection system in accordance with claim 76, characterized in that:
said system further comprises a plurality of connector modules, with each of said connector modules having means for distributing AC electrical power; and
each of said electronics units receives said incoming AC electrical power from said means for distributing AC electrical power from said connector modules.

82. A network connection system in accordance with claim 76, characterized in that:
at least one of said electronics units directly receives incoming AC electrical power; and
said at least one electronics unit receiving said incoming AC electrical power comprises means for distributing said incoming AC electrical power directly to another of said electronics units.

83. A network connection system in accordance with claim 82, characterized in that at least one of said electronics units receiving incoming AC electrical power from said at least one electronics unit directly receiving said incoming AC electrical power comprises means for further distributing said incoming AC electrical power to another of said electronics units.

84. A network connection system in accordance with claim 76, characterized in that AC power conduits are utilized to electrically connect at least one set of said electronics units in a daisy chain configuration.

85. A network connection system in accordance with claim 76, characterized in that said receiver means comprises a plurality of IR receivers, with each of said IR receivers being associated with a given one of said electronics units.

86. A network connection system in accordance with claim 76, characterized in that:
said system further comprises at least one connector module for transmitting said communication signals to an interconnected one of said electronics units; and
said electronics unit receiving said communication signals from said connector module comprises means for directly transmitting said communication signals to one or more of others of said electronics units.

87. A visual shield configuration for use within a building infrastructure, and for use with a physical supporting structure, said visual shield configuration comprising:
support means for supporting said visual shield configuration from said supporting structure;
a plurality of segments, each of said segments having flexible properties; and
said plurality of segments are arranged and interconnected so as to form a visual shield having a concertina-like configuration.

88. A visual shield configuration in accordance with claim 87, characterized in that each of said segments is constructed of a flexible Mylar® material, polyester film, or other flexible translucent material.

89. A visual shield configuration in accordance with claim 87, characterized in that each of said segments is substantially translucent.

90. A visual shield configuration in accordance with claim 87, characterized in that said flexible properties of said segments are sufficient so as to permit manual manipulation of said visual shield into various shapes.

91. A visual shield configuration in accordance with claim 87, characterized in that said flexible properties of said segments are sufficient so as to permit manual manipulation of said visual shield into a collapsed state.

92. A visual shield configuration in accordance with claim 87, characterized in that at least a subset of said plurality of segments are arranged into segment pairs.

93. A visual shield configuration in accordance with claim 87, characterized in that:
said plurality of segments comprises at least a subset of said plurality of segments; and
each of said segments within said subset is connected to at least one adjacent segment through at least one segment coupling.

94. A visual shield configuration in accordance with claim 93, characterized in that:
each of said segments within said subset is connected to a first one of adjacent segments through a pair of segment couplings; and
each of said segments of said subset is connected to a second one of adjacent segments through three segment couplings.

95. A visual shield configuration in accordance with claim 93, characterized in that said segments within said subset are interconnected so that various shapes of said visual shield configuration may be formed by varying locations where said segment couplings are made between adjacent segments within said subset.

96. A visual shield configuration in accordance with claim 95, characterized in that said segment couplings made between adjacent segments of said subset are located so that said visual shield configuration forms a double wave configuration.

97. A visual shield configuration in accordance with claim 93, characterized in that:
said segments of said subset are formed in a multiple wave configuration, with “x” representative of the number of waves formed within each of said segments of said subset;
each of said segments within said subset is interconnected with a first adjacent segment through “x+1” segment couplings; and
each segment of said subset is interconnected with a second adjacent segment through “x” segment couplings.

98. A visual shield configuration in accordance with claim 93, characterized in that said segment couplings are formed through the use of rivets.

99. A visual shield configuration in accordance with claim 93, characterized in that said segment couplings are formed through the use of heat stakes.

100. A visual shield configuration in accordance with claim 93, characterized in that said segment couplings are formed between adjacent ones of said segments with said adjacent segments being partially folded outwardly on themselves, so as to form 4-ply segment couplings.

101. A visual shield configuration in accordance with claim 87, characterized in that:
said physical supporting structure comprises at least one support rail; and
said support means for supporting said visual shield configuration from said supporting structure comprises means for releasably coupling at least a subset of said plurality of segments to said at least one support rail.

102. A visual shield configuration in accordance with claim 87, characterized in that:
said physical supporting structure comprises at least one pair of spaced apart support rails;
said plurality of segments comprises at least a subset of said segments, where segments within said subset are interconnected so as to form a plurality of segment pairs, with each segment pair comprising two of said segments of said subset; and
said support means comprises means for releasably coupling said segment pairs to both of said support rails.

103. A visual shield configuration in accordance with claim 87, characterized in that:
said physical structure comprises at least a pair of spaced apart support rails;
said plurality of segments comprises at least a subset of said segments, where said subset is formed into segment pairs, each of said segment pairs comprising two adjacent ones of said segments within said subset; and
said support means comprises a plurality of end clips for releasably coupling said segment pairs to both of said support rails.

104. A visual shield configuration in accordance with claim 103, characterized in that:
said end clips are each formed by a pair of end tabs, each of said end tabs being formed at an opposing end of each of said segments of said segment pairs; and
each of said end tabs comprises a substantially resilient and flexible configuration having an aperture positioned therein, each of said apertures being sized and configured so as to be received on one of said support rails.

105. A visual shield configuration in accordance with claim 104, characterized in that:
said end tabs are formed so as to be turned perpendicular to a general plane of an associated one of said segments of said segment pairs; and
said end clips further comprise means for permanently coupling together the two of said end tabs located on each end of said segments of each segment pair.

106. A visual shield configuration in accordance with claim 87, characterized in that said visual shield configuration is positioned below the plane of a lighting configuration so as to affect the angle, intensity and/or color transmission of the light projected from said lighting configuration below the plane of said visual shield.

107. A visual shield configuration in accordance with claim 87, characterized in that said segments are formed into a partially expanded state.

108. A visual shield configuration in accordance with claim 87, characterized in that:
each of said segments comprises a top edge, a pair of sides and a bottom edge; and
said bottom edges of at least a subset of said plurality of segments are cut in non-straight line cut configurations, with certain of said subset of said plurality of said segments having a cut configuration differing from a cut configuration of others of said subset of said plurality of segments.

109. A visual shield configuration for use within a building infrastructure, and for use with a physical supporting structure, said visual shield configuration comprising:
support means for supporting said visual shield configuration from said supporting structure;
a plurality of segments, each of said segments having flexible properties;
said plurality of segments are constructed of a substantially flexible material, and arranged and interconnected so as to form a visual shield configuration having substantially open areas from below said visual shield configuration to above said visual shield configuration; and
said plurality of segments are interconnected and of a sufficiently flexible material so as to be collapsible for purposes of shipment and storage when disconnected from said physical supporting structure.

110. A visual shield configuration for use within a building infrastructure, and for use with a physical supporting structure, said visual shield configuration comprising:
a sheet of flexible material, said sheet being appropriately cut so as to have a width corresponding to a desired width between supporting elements of said physical supporting structure;
said sheet comprises a plurality of lateral rows of a series of cut first shapes, with said lateral rows comprising a series of said cut first shapes extending horizontally across said first sheet; and
when external forces are applied to a first lateral row of said cut first shapes in a direction opposing the location of an adjacent row of said cut first shapes, said sheet will form itself into non-planar configurations, where planes of adjacent lateral rows are non-parallel.

111. A visual shield configuration in accordance with claim 110, characterized in that:
said sheet is first formed as a planar sheet;
said sheet is cut into a configuration comprising lateral rows of cut rectangles, said lateral rows comprising a first lateral row and a second lateral row, said first lateral row being adjacent to said second lateral row, and each of said lateral rows comprising a series of said cut rectangles extending horizontally across said sheet; and
each of said cut rectangles comprises a lower edge extending horizontally across said sheet, with a center slot cut within each of said rectangles and extending upwardly from a corresponding one of said lower edges, said center slot extending upwardly in the range of one-quarter to three quarters of a vertical length of an associated one of said rectangles.

112. A visual shield configuration in accordance with claim 111, characterized in that:
each of said rectangles comprises an upper edge;
each of said rectangles further comprises opposing lateral sides, with a side slot extending downwardly from said upper edge on each of said lateral sides of said rectangles, said length of each of said side slots being in the range of one-quarter to three quarters of a vertical length of said rectangles; and
said lower edge of said first lateral row and said upper edge of said adjacent second lateral row are formed by cutting a channel between said first and said second adjacent rows.

113. A visual shield configuration in accordance with claim 112, characterized in that when external forces are applied in an appropriate direction to said first row or said second row, said sheet will be caused to transform from a substantially planar configuration into a configuration where planes of said first row and said second row are non-parallel to each other.

114. A lighting system for use within a building infrastructure, and for use with a supporting physical structure, said lighting system comprising a LED ladder system having a plurality of LED strip connectors for mounting LED lights thereon, each of said LED strip connectors having an elongated configuration and comprising an LED clip bus assembly having one end mechanically and electrically coupled to a corresponding LED strip unit, and another outwardly extending end of said clip bus assembly terminating in a resilient rail connector.

115. A lighting system in accordance with claim 114, characterized in that said each of said LED strip connectors further comprises:
a centrally positioned bus channel having an area for electrically connecting one end of a set of buses to a bonded wire ribbon, and with said area further providing for electrically connecting other ends of said buses within a connector block for applying power to LED's associated with a corresponding one of said LED strip units;
a connector bus group comprising a plurality of connector buses secured within said bus channel, in a manner so that said buses are isolated from one another;
means for securing said connector buses within said bus channel; and
when said connector buses are positioned within said bus channel, bus ends are positioned within a ribbon interconnection cavity positioned outwardly from said bus channel.

116. A lighting system in accordance with claim 115, characterized in that each of said LED strip connectors further comprises:
ribbon connector forks formed at said bus ends and turned upwardly, and longitudinally staggered within said cavity as a result of individual ones of said connector buses having differing lengths; and
when said connector buses are secured within said bus channel and said ribbon interconnection cavity, said bonded wire ribbon can be electrically secured to said connector buses.
